(19) United States
(12) Patent Application Publication
(10) Pub. No.: US 2024/0359840 A1
(43) Pub. Date: Oct. 31, 2024

(54) SYSTEMS AND METHODS FOR WRAPPING PALLETS AND THE LIKE WITH EXPANDABLE PAPER

(71) Applicant: David Paul Goodrich, Sedona, AZ (US)

(72) Inventor: David Paul Goodrich, Sedona, AZ (US)

(21) Appl. No.: 18/615,179

(22) Filed: Mar. 25, 2024

Related U.S. Application Data
(63) Continuation-in-part of application No. 17/802,012, filed on Aug. 24, 2022.
(60) Provisional application No. 63/569,187, filed on Mar. 24, 2024.
(60) Provisional application No. 63/166,233, filed on Mar. 25, 2021.
(60) Provisional application No. 63/190,025, filed on May 18, 2021.

(51) Int. Cl. B65B 11/58; B31D 3/04; B65D 71/00

(52) U.S. Cl. CPC B65B 11/585; B31D 3/04; B65D 71/0088

(57) ABSTRACT

According to illustrative embodiments, a novel pallet wrap is provided. In some preferred embodiments, the pallet wrap includes: an expandable slit sheet paper having a slit pattern including a plurality of slits extending in a cross direction that forms a plurality of open cells upon expansion in a machine direction, and a non-slit paper support wrap, wherein said expandable slit sheet paper is configured to be wrapped around a pallet assembly and said paper support wrap is configured to surround at least a portion of said expandable slit sheet paper wrapped around said pallet assembly.

### INTRODUCTION

The present application a) is a non-provisional of U.S. Application Ser. No. 63/569,187, filed Mar. 24, 2024, to David Paul Goodrich and b) is a continuation in part of U.S. application Ser. No. 17/802,012, filed Aug. 24, 2022, which is a U.S. national stage of PCT/US2022/022059, filed Mar. 25, 2022, which claims priority to i) U.S. Provisional Application Ser. No. 63/166,233, filed Mar. 25, 2021, to David Paul Goodrich, and ii) U.S. Provisional Application Ser. No. 63/190,025, filed May 18, 2021, to David Paul Goodrich, the entire disclosures of which prior applications are all incorporated herein by reference.

### FIELD

This invention relates to the use of wrapping materials for wrapping pallets and the like.

### Illustrative Pallet Wrapping Technology

Illustrative pallet wrapping systems and methods are set forth in the following patent publication documents, the entire disclosures of which are all incorporated herein by reference as though recited herein in full.
DE19622620A1, entitled Foil Winding Machine to Wrap Loaded Pallets;
EP0533520B1, entitled Method of Packaging a Palletisable Load;
U.S. Pat. No. 4,590,746, entitled Constant Tension Stretch Wrapping Machine;
U.S. Pat. No. 4,807,427, entitled Stretch Wrapping Roping Apparatus;
U.S. Pat. No. 8,046,975, entitled Pallet Roping and Wrapping Apparatus;
U.S. Pat. No. 8,276,346, entitled Wrapping Apparatus and Method Including Metered Pre-Stretch Film Delivery Assembly;
U.S. Pat. No. 8,549,819, entitled Pallet Roping and Wrapping Apparatus and Method;
U.S. Pat. No. 9,688,428, entitled Stretch Wrapping Machine Structure;
U.S. Patent Publication No. 2004/0088954A1, entitled Wrap Machine;
U.S. Patent Publication No. 2015/0151861A1, entitled Pallet Wrapping Machinery.

### Expanded Slit Sheet Paper Related Art Incorporated by Reference

In some preferred embodiments described herein, expandable slit sheet paper which can be used in embodiments of the present invention, including illustrative slit patterns and the expansion processes related thereto, etc., as found in U.S. patents a) U.S. Pat. No. 5,538,778, b) U.S. Pat. No. 5,667,871, c) U.S. Pat. No. 5,688,578, d) U.S. Pat. No. 5,782,735, e) U.S. Pat. No. 3,908,071, f) U.S. Pat. No. 3,104,197, g) U.S. Pat. No. 3,220,116, h) U.S. Pat. No. 3,269,393, i) U.S. Pat. No. 3,908,071, j) U.S. Pat. No. 6,024,832, k) U.S. Pat. No. 6,458,447, and l) U.S. Pat. No. 6,712,930, and in PCT application No. WO1984002936A1, and in U.S. Published Patent Application Nos. US 2002/0060034 and US 2007/0240841, the disclosures of which U.S. patents, PCT application, and U.S. Published applications are all incorporated by reference herein in their entireties, as though recited in full herein.

In the preferred embodiments, the terminology “expandable” as applied to paper sheets, means a paper having a slit pattern that enables expansion of the paper, such as, e.g., as disclosed in U.S. patent. Nos. (a) U.S. Pat. No. 5,538,778, (b) U.S. Pat. No. 5,667,871, (c) U.S. Pat. No. 5,688,578, (d) U.S. Pat. No. 5,782,735 and (e) U.S. Pat. No. 10,226,907, and in PCT Application No. PCT/US2014/054615, the entire disclosures of which patents and PCT application are all incorporated by reference herein as though recited in full. In the preferred embodiments, a slit pattern is configured to enable the paper to be expanded lengthwise, with a related decrease in width. In some embodiments, the slit pattern produces a paper that increases in length due to the slit pattern when processed in an expander, such as, e.g., an expander of the type described in any of the following U.S. and PCT applications (a) 2017/0203866, (b) 2018/022266, (c) 2018/0127197, and (d) PCT/US2014/054615, incorporated herein by reference in their entireties.

U.S. Pat. Nos. 5,667,871 and 5,688,578, slit Sheet Packing Material, teach the use of a plurality of individual slits forming parallel spaced rows forming a hexagonal expanded sheet with and without a separator sheet. It requires machinery to stretch the paper into its three-dimensional shape at the customer's location such as disclosed in U.S. Pat. No. 5,538,778 which teaches the method and apparatus for producing the expansion of the slit sheet material performed at the packing site's location. U.S. Pat. No. 5,782,735 discloses an expander for expanding the slit sheet material of U.S. Pat. Nos. 5,667,871 and 5,688,578.

For reference, FIGS. 1(A) and 1(B) correspond to FIGS. 1 and 3 of U.S. Pat. No. 5,667,871 (the '871 patent). These figures describe existing “slit sheet” expandable paper structure. As explained in the '871 patent:

“The slit paper, indicated generally as 10, is illustrated in FIG. [1(A)] as it would come off the slitting machine. The sheets can be formed on a flat-bed slitter and produced directly as rectangular sheets, as well as on a rotary slitter and cut into individual sheets or stored directly as a continuous sheet in roll form. The flexible sheet 10 is preferably manufactured from exclusively recycled paper with the grain of the paper running in the direction of arrow A. The flexible sheet 10 is provided with slits 14 and slits 16 are parallel to the edges 22 and 24 of the flexible sheet 12 and perpendicular to the paper grain. The slits 14 and slits 16 are placed in rows and separated from one another by land 20 and legs 21 [shown in FIG. 1(B)]. The land 20 is a consistent size and provides the support required to prevent the paper from tearing into strips when opened. The cushioning effect is produced by the flexing of the lands and legs under a load. It is therefore necessary that the land 20 be of sufficient size to provide cushioning. The spacing between the rows of slits 14 and slits 16 must also be of sufficient size to prevent the paper from tearing. The offset positioning of the rows of slits 14 and slits 16 gives the paper resiliency when opened and is discussed in detail further hereinafter. The existence of partial slits 14 and 16 at the ends 25 and 18 of the flexible sheet 10 do not hinder the efficiency of the slit paper 10. The flexible sheet 10 when flat; lies in a first plane.”

“When expanded, the expanded sheet, indicated generally as 12, is formed of hexagonal cells 26, legs 21 and land 20 areas, as illustrated in FIG. [1(B)]. Preferably, at least a majority of the land 20 areas lie in a plurality of parallel planes. The planes of the land 20 areas form an angle of at least about 45 degrees with the plane of the sheet in flat form.”

“The slitting operation in which the slits are cut into the sheet material can take several forms. In one embodiment, rectangular sheets are provide with its total number of slits in one action. The term rectangular should be understood to include rectangles in which all four sides are equal, that is, square. Where the sheet material is subjected to rotary cutting or slitting, the pressure required for the cutting action is significantly lower that which is required for the flat bed cut, since essentially only a single row or a few rows of slits are cut simultaneously. Unlike prior art structures and systems, expansion contemporaneous with slitting is not desirable. Therefore a critical balance must be struck between resistance to opening of the cells during the rewind step and ease of opening of cells during the expansion step. By achieving this critical balance and producing a flat, unexpanded sheet, the sheet material has an effective thickness which is as much as one twentieth of the thickness of a sheet of expanded material. The compact configuration provides for the optimization of shipping and storage.”

In the preferred embodiments, the term “slit sheet” means an expandable paper sheet having a slit pattern. The following are direct quotes of U.S. Pat. No. 5,667,871 (the '871 patent).

First, column 10, lines 13-48, of the '871 patent explains:

“The length of the slit and the ratio of the land intervals between slit affects the dimensions of the polygons which are formed during the expansion step. The higher the ratio of slit length to interval length the greater is the maximum angle which can be formed between the plane of the sheet and the planes of the land areas. The greater the uniformity of the shape and size of the formed polygonal shaped open areas and the angle to which the land areas incline relative to the flat sheet, the greater is the degree to which interlocking of land areas can be achieved. Interlocking of land areas, that is, the nesting of layers of sheets, reduces the effective thickness of the sheets. However, the net effect is still a dramatic increase in effective sheet thickness. For example, 0.008 inch thick paper having a silt pattern of a ½″ slit, 3/16″ slit spacing, and ⅛″ row spacing, produces a ¼″ by 3/16″ land which can expand to under about one quarter of an inch thickness and will have a net effective thickness for two layers, when nested, of about 0.375 inches. It is noted that the land width is double the width of the legs. The net effect is a useful thickness expansion of roughly 20 times the unexpanded thickness of the paper.”

“The longer the slit relative to the rigidity of the sheet material, the weaker is the interlocking effect and the cushioning effect due to the weakness of the expanded structure. If the slits are too small, expansion can be severely limited and cushioning can be excessively limited. This does not mean that the dimensions are narrowly critical, but rather that the dimension must be selected relative to the characteristics of the paper, as for example the degree of rigidity, and the cushioning or energy absorbing effects which are required. The resistance to expansion increases relative to the increase in the size of the land areas. It should be understood that some resistance to opening is desired. The object rests on, or contacts the edge of the sheet formed by the incline of the land areas which turns the perimeter of the openings into upper and lower edges.”

Second, column 10, lines 58-67 and column 11, lines 1-6, of the '871 patent further explains:

“As heretofore mentioned, the slit dimensions can be varied to ease the process of opening. A ⅝″ slit, 3/16″ land by 3/16 row opens very easily since the number of hexagons is reduced. When the size of the hexagons are increased and the numbers decreased; the stretched thickness was increased, producing a very viable wrap material. This sizing increases the yield of the paper and provides almost the same protection as the ½″ slit. This sizing provides a less expensive product utilizing a larger content of post consumer waste while maintaining the integrity of the wrap product. The ½″ slit, 3/16″ land by ⅛″ row pattern produces a more protective wrap due to the greater number of wraps that can be made within the same volume. Thus, a 21/2 pound vase dropped from a thirty inch height, with only ½″ of cumulative sheet thickness around the vase, can be protected with the ½″ slit, ¼ by 3/16 inch land pattern.”

The present inventor's prior U.S. Pat. No. 10,226,907 (the '907 patent) shows a background “Expandable Slit Sheet Packaging Material That Interlocks When Layered and Expanded.” In the '907 patent, the product includes a plurality of layers, with each layer having a different slit pattern for the purposes of “interlocking” between the plural layers. As explained at column 2 of the '907 patent, “the differing slit patterns produce when expanded, inclined land area that have the same number of rows per inch, but different angles of inclination of the land areas, such that adjacent layers can interlock.” While the '907 patent describes an example in which a slit length of 0.4 inches is included for one of the layers, it is notable that 1) this 0.4 inch slit length is only used in conjunction with an adjacent layer having a larger slit length of 0.5 inches, 2) this reduced slit length is not used along with a reduced distance between rows (i.e., the distance between rows is required to be the same as that of the adjacent layer with the 0.5 inch slit length). Thus, the '907 patent does not teach the improved slit sheet cushioning products of the present invention, nor the advantages therefrom.

The preferred embodiments of the present invention improve upon and overcome various problems and limitations of the related art.

### SUMMARY

The preferred embodiments overcome and improve upon the foregoing and/or other related art.

The present application sets forth a variety of exemplary embodiments, including exemplary embodiments numbered as 1-145, below, and other embodiments described herein.

### Illustrative Embodiments 1-145

1. A pallet wrap, comprising:
an expandable slit sheet paper having a slit pattern including a plurality of slits extending in a cross direction that forms a plurality of open cells upon expansion in a machine direction.

2. In combination:
a) the pallet wrap of embodiment 1; and
b) a pallet assembly, with said pallet wrap being wrapped around said pallet assembly with said expandable slit sheet paper wrapped around the periphery of the pallet assembly.

3. A pallet wrap, comprising:
an expandable slit sheet paper having a slit pattern including a plurality of slits extending in a cross direction that forms a plurality of open cells upon expansion in a machine direction, and
a support wrap,
wherein said expandable slit sheet paper is configured to be wrapped around a pallet assembly and said support wrap is configured to surround at least a portion of said expandable slit sheet paper wrapped around said pallet assembly.

4. The pallet wrap of embodiment 3, wherein said support wrap has a narrower width than a width of said expandable slit sheet paper.

5. In combination:
a) the pallet wrap of embodiments 3 or 4; and
b) a pallet assembly, with said pallet wrap being wrapped around said pallet assembly with said expandable slit sheet paper wrapped around the periphery of the pallet assembly and the support wrap surrounding at least a portion of said expandable slit sheet paper wrapped around said pallet assembly.

6. In combination:
a) a pallet assembly having a plurality of stacked items, boxes or containers;
b) a pallet wrap including an expandable slit sheet paper having a slit pattern including a plurality of slits extending in a cross direction that forms a plurality of open cells upon expansion in a machine direction, said expandable slit sheet paper being wrapped around said pallet assembly.

7. The combination of embodiment 6, wherein:
said pallet wrap further includes a support wrap surrounding at least a portion of said expandable slit sheet paper wrapped around said pallet assembly.

8. A method of wrapping a pallet, comprising:
a) providing a pallet wrap having:
an expandable slit sheet paper having a slit pattern including a plurality of slits extending in a cross direction that forms a plurality of open cells upon expansion in a machine direction, and
b) wrapping said pallet wrap around a pallet assembly with said expandable slit sheet paper wrapped around the pallet assembly.

9. A method of wrapping a pallet, comprising:
a) providing a pallet wrap having:
an expandable slit sheet paper having a slit pattern including a plurality of slits extending in a cross direction that forms a plurality of open cells upon expansion in a machine direction, and
a support wrap;
b) wrapping said pallet wrap around a pallet assembly with said expandable slit sheet paper wrapped around the pallet assembly and said support wrap surrounding said expandable slit sheet paper wrapped around said pallet assembly.

10. The method of embodiment 9, wherein said support wrap is provided with a narrower width than a width of said expandable slit sheet paper.

11. The method of embodiments 8 or 9, wherein said wrapping said pallet wrap around the pallet assembly includes relatively moving a roll of said expandable slit sheet paper with respect to a periphery of said pallet assembly.

12. The method of embodiment 11, wherein said relatively moving includes rotating said pallet assembly.

13. The method of embodiment 11, wherein said relatively moving includes moving said roll of said expandable slit sheet paper around the periphery of said pallet assembly.

14. The method of embodiment 11, wherein said relatively moving includes manually relatively moving said roll of said expandable slit sheet paper with respect to the periphery of said pallet assembly.

15. The method of embodiment 11, wherein said relatively moving includes automatedly relatively moving said roll of said expandable slit sheet paper with respect to the periphery of said pallet assembly.

16. A method of making a pallet wrap system, comprising:
providing a pallet wrap dispenser;
mounting a roll of expandable slit sheet paper on said pallet wrap dispenser.

17. The method of embodiment 16, wherein said step of providing a pallet wrap dispenser includes providing a pallet wrap dispenser that is configured to dispense a roll of plastic, polymeric or elastomeric material, and retrofitting said pallet wrap dispenser to dispense said roll of expandable slit sheet paper.

18. A method of retrofitting a pallet wrap dispenser that dispenses plastic, polymeric or elastomeric sheet material, comprising:
providing a pallet wrap dispenser that is configured to dispense plastic, polymeric or elastomeric sheet material from a roll of plastic, polymeric or elastomeric material,
mounting a roll of expandable slit sheet paper on said pallet wrap dispenser.

19. The method of embodiment 16, 17 or 18, wherein said pallet wrap dispenser is a manually operated hand-held dispenser.

20. The method of embodiment 16, 17 or 18, wherein said pallet wrap dispenser is an automated dispenser.

21. Any of the preceding embodiments, wherein the expandable slit sheet paper is wrapped around said pallet assembly in an expanded state and supports a maximum tensile load in a machine direction of at least 0.8 pounds per inch across the width of the expandable slit sheet paper.

22. Any of the preceding embodiments, wherein the expandable slit sheet paper is wrapped around said pallet assembly in an expanded state and supports a maximum tensile load in a machine direction of at least 0.9 pounds per inch across the width of the expandable slit sheet paper.

23. Any of the preceding embodiments, wherein the expandable slit sheet paper is wrapped around said pallet assembly in an expanded state and supports a maximum tensile load in a machine direction of at least 1.0 pounds per inch across the width of the expandable slit sheet paper.

24. Any of the preceding embodiments, wherein the expandable slit sheet paper is wrapped around said pallet assembly in an expanded state and supports a maximum tensile load in a machine direction of at least 1.1 pounds per inch across the width of the expandable slit sheet paper.

25. Any of the preceding embodiments, wherein said expandable slit sheet paper is wrapped around said pallet assembly in an expanded state and supports a maximum tensile load in a machine direction of at least 1.2 pounds per inch across the width of the expandable slit sheet paper.

26. Any of the preceding embodiments, wherein said expandable slit sheet paper is wrapped around said pallet assembly in an expanded state and supports a maximum tensile load in a machine direction of at least 1.3 pounds per inch across the width of the expandable slit sheet paper.

27. Any of the preceding embodiments, wherein said expandable slit sheet paper is wrapped around said pallet assembly in an expanded state and supports a maximum tensile load in a machine direction of at least 1.4 pounds per inch across the width of the expandable slit sheet paper.

28. Any of the preceding embodiments, wherein said expandable slit sheet paper is wrapped around said pallet assembly in an expanded state and supports a maximum tensile load in a machine direction of at least 1.5 pounds per inch across the width of the expandable slit sheet paper.

29. Any of the preceding embodiments, wherein said expandable slit sheet paper is wrapped around said pallet assembly in an expanded state and supports a maximum tensile load in a machine direction of at least 1.6 pounds per inch across the width of the expandable slit sheet paper.

30. Any of the preceding embodiments, wherein said expandable slit sheet paper is an extensible paper that provides tensile strength supporting tensile loads of greater than 0.8 pounds per inch across a width of the expandable slit sheet paper.

31. Any of the preceding embodiments, wherein said expandable slit sheet paper is an extensible paper that provides tensile strength supporting tensile loads of greater than 0.9 pounds per inch across a width of the expandable slit sheet paper.

32. Any of the preceding embodiments, wherein said expandable slit sheet paper is an extensible paper that provides tensile strength supporting tensile loads of greater than 1.0 pounds per inch across a width of the expandable slit sheet paper.

33. Any of the preceding embodiments, wherein said expandable slit sheet paper is an extensible paper that provides tensile strength supporting tensile loads of greater than 1.1 pounds per inch across a width of the expandable slit sheet paper.

34. Any of the preceding embodiments, wherein said expandable slit sheet paper is an extensible paper that provides tensile strength supporting tensile loads of greater than 1.2 pounds per inch across a width of the expandable slit sheet paper.

35. Any of the preceding embodiments, wherein said expandable slit sheet paper is an extensible paper that provides tensile strength supporting tensile loads of greater than 1.3 pounds per inch across a width of the expandable slit sheet paper.

36. Any of the preceding embodiments, wherein said expandable slit sheet paper is an extensible paper that provides tensile strength supporting tensile loads of greater than 1.4 pounds per inch across a width of the expandable slit sheet paper.

37. Any of the preceding embodiments, wherein said expandable slit sheet paper is an extensible paper that provides tensile strength supporting tensile loads of greater than 1.5 pounds per inch across a width of the expandable slit sheet paper.

38. Any of the preceding embodiments, wherein said expandable slit sheet paper is an extensible paper that provides tensile strength supporting tensile loads of greater than 1.6 pounds per inch across a width of the expandable slit sheet paper.

39. Any of the preceding embodiments, wherein said expandable slit sheet paper flexibly contours around corners of boxes or containers within said pallet assembly by expansion of said open cells and/or lateral twisting enabled by said open cells.

40. Any of the preceding embodiments, wherein said support wrap is configured to add tensile strength to the pallet wrap beyond the tensile strength of the expandable slit sheet paper.

41. Any of the preceding embodiments, wherein said support wrap includes one or more of the following:
a) reinforcing fibers or filaments;
b) nylon filaments;
c) polymer filaments;
d) glass filaments; and/or
e) natural filaments, such as, e.g., plant filaments, cotton filaments, bamboo filaments, etc.

42. Any of the preceding embodiments, wherein said support wrap includes: reinforcing fibers or filaments extending within a lengthwise direction.

43. Any of the preceding embodiments, wherein said support wrap includes: reinforcing fibers or filaments in combination reinforcing a tape or paper material.

44. Any of the preceding embodiments, wherein said support wrap includes: reinforcing fibers extending within a lengthwise direction, wherein the reinforcing fibers include synthetic fibers.

45. Any of the preceding embodiments, wherein said support wrap includes: reinforcing fibers extending within a lengthwise direction, wherein the reinforcing fibers include glass fibers or plastic fibers.

46. Any of the preceding embodiments, wherein said support wrap includes a non-slit paper.

47. Any of the preceding embodiments, wherein said support wrap includes a heavy weight non-slit paper.

48. Any of the preceding embodiments, wherein said support wrap includes: reinforcing fibers extending within a lengthwise direction, wherein the reinforcing fibers include natural fibers, such as, e.g., plant fibers, cotton fibers, or the like.

49. Any of the preceding embodiments, wherein said expandable slit sheet paper is a paper having a weight of at least 30#.

50. Any of the preceding embodiments, wherein said expandable slit sheet paper is a paper having a weight of at least 35#.

51. Any of the preceding embodiments, wherein said expandable slit sheet paper is a paper having a weight of at least 40#.

52. Any of the preceding embodiments, wherein said expandable slit sheet paper is a paper having a weight of greater than 45#.

53. Any of the preceding embodiments, wherein said expandable slit sheet paper is a paper having a weight of greater than 50#.

54. Any of the preceding embodiments, wherein said expandable slit sheet paper is a paper having a weight of greater than 55#.

55. Any of the preceding embodiments, wherein said expandable slit sheet paper is a paper having a weight of greater than 60#.

56. Any of the preceding embodiments, wherein said expandable slit sheet paper is a paper having a weight of between 30# to 70#.

57. Any of the preceding embodiments, wherein said expandable slit sheet paper is a paper having a weight of between 40# to 70#.

58. Any of the preceding embodiments, wherein said expandable slit sheet paper is a paper having a weight of between 45# to 70#.

59. Any of the preceding embodiments, wherein said expandable slit sheet paper is a paper having a weight of between 40# to 60#.

60. Any of the preceding embodiments, wherein said expandable slit sheet paper is a paper having a weight of between 45# to 60#.

61. Any of the preceding embodiments, wherein:
said expandable slit sheet paper is made with an extensible paper.

62. Any of the preceding embodiments, wherein:
said expandable slit sheet paper has slits with a slit length of between 0.15 inches to 0.45 inches.

63. Any of the preceding embodiments, wherein:
said expandable slit sheet paper has a slit length of 0.25 inches plus or minus 33%, a slit spacing of 0.09375 inches plus or minus 33% and a row spacing of 0.0625 inches plus or minus 33%.

64. Any of the preceding embodiments, wherein:
said expandable slit sheet paper has a slit length of less than 0.45 inches.

65. Any of the preceding embodiments, wherein:
said expandable slit sheet paper has a slit length of less than 0.40 inches.

66. Any of the preceding embodiments, wherein:
said expandable slit sheet paper has a slit length of less than 0.35 inches.

67. Any of the preceding embodiments, wherein:
said expandable slit sheet paper has a slit length of less than 0.30 inches.

68. Any of the preceding embodiments, wherein:
said expandable slit sheet paper has a slit length of less than 0.25 inches.

69. Any of the preceding embodiments, wherein:
said expandable slit sheet paper has a slit length of less than 0.20 inches.

70. Any of the preceding embodiments, wherein:
said expandable slit sheet paper has a slit length of between 0.15 to 0.35 inches.

71. Any of the preceding embodiments, wherein:
said expandable slit sheet paper has a slit length of between 0.20 to 0.30 inches.

72. Any of the preceding embodiments, wherein:
said expandable slit sheet paper has a slit length of about 0.225 to 0.275 inches.

73. Any of the preceding embodiments, wherein:
said expandable slit sheet paper has a slit length of about 0.25 inches.

74. Any of the preceding embodiments, wherein:
said expandable slit sheet paper has a slit pattern of slits extending in a widthwise direction, wherein a slit spacing (SS) relates to slit length (SL) based on the formula SL=K×SS, where K is a value between 2.4 to 3.3, or, more preferably, where K is a value between 2.5 to 3.0, or, more preferably, where K is a value between 2.6 and 2.8, or, more preferably, where K is about 2.6667.

75. Any of the preceding embodiments, wherein:
said expandable slit sheet paper has a slit pattern of slits extending in a widthwise direction, wherein dimensions of the slit pattern of the expandable slit sheet paper are proportionally reduced from an expandable slit sheet paper having a 0.5″ slit length (SL), a ⅛″ (0.125 inch) spacing between rows (RS), and a spacing between slits within the same row (i.e., land length) of 3/16″ (0.1875 inch) (SS).

76. Any of the preceding embodiments, wherein:
said expandable slit sheet paper has a pattern of slits having slit lengths (SL) of between 0.175 to 0.325 inches, spaces between rows (RS) of between 0.043 to 0.082 inches, and spaces between slits (SS) of between 0.065 to 0.122 inches, or, more preferably, having slit lengths (SL) of between 0.2 to 0.3 inches, spaces between rows (RS) of between 0.05 to 0.075 inches, and spaces between slits (SS) of between 0.075 to 0.1125 inches.

77. Any of the preceding embodiments, wherein:
said expandable slit sheet paper has a pattern of slits having slit lengths (SL) of between 0.175 to 0.325 inches and spaces between rows (RS) of between 0.043 to 0.082 inches, or, more preferably, having slit lengths (SL) of between 0.2 to 0.3 inches and spaces between rows (RS) of between 0.05 to 0.075 inches.

78. Any of the preceding embodiments, wherein:
said expandable slit sheet paper has a pattern of slits having slit lengths (SL) of between 0.175 to 0.325 inches and spaces between slits (SS) of between 0.065 to 0.122 inches, or, more preferably, having slit lengths (SL) of between 0.2 to 0.3 inches and spaces between slits (SS) of between 0.075 to 0.1125 inches.

79. Any of the preceding embodiments, wherein:
when said slit sheet paper is in an expanded state, said plurality of open cells form an alternating row expansion pattern.

80. Any of the preceding embodiments, wherein:
said expandable slit sheet paper is made with an extensible paper.

81. Any of the preceding embodiments, wherein:
said expandable slit sheet paper is formed from an extensible paper that is extensible in the machine direction and the cross direction, said extensible paper having an extensibility within a range of 3 to 20% in the machine direction.

82. Any of the preceding embodiments, wherein:
said expandable slit sheet paper is formed from an extensible paper that is extensible in the machine direction and the cross direction without said slit pattern, said extensible paper having an extensibility within a range of 3 to 9% in the machine direction.

83. Any of the preceding embodiments, wherein:
said expandable slit sheet paper is formed from an extensible paper having an extensibility of greater than 3% in the machine direction.

84. Any of the preceding embodiments, wherein:
said expandable slit sheet paper is formed from an extensible paper having an extensibility of greater than 4% in the machine direction.

85. Any of the preceding embodiments, wherein:
said expandable slit sheet paper is formed from an extensible paper having an extensibility of greater than 5% in the machine direction.

86. Any of the preceding embodiments, wherein:
said expandable slit sheet paper is formed from an extensible paper having an extensibility of greater than 6% in the machine direction.

87. Any of the preceding embodiments, wherein:
said expandable slit sheet paper is formed from an extensible paper having an extensibility of greater than 7% in the machine direction.

88. Any of the preceding embodiments, wherein:
said expandable slit sheet paper is formed from an extensible paper having an extensibility of greater than 8% in the machine direction.

89. Any of the preceding embodiments, wherein:
said expandable slit sheet paper is formed from an extensible paper having an extensibility of greater than 9% in the machine direction.

90. Any of the preceding embodiments, wherein:
said expandable slit sheet paper is formed from an extensible paper having an extensibility of greater than 10% in the machine direction.

91. Any of the preceding embodiments, wherein:
said expandable slit sheet paper is formed from an extensible paper having an extensibility of greater than 5% in both the machine direction and the cross direction.

92. Any of the preceding embodiments, wherein:
said expandable slit sheet paper is formed from an extensible paper having an extensibility of greater than 6% in both the machine direction and the cross direction.

93. Any of the preceding embodiments, wherein:
said expandable slit sheet paper is formed from an extensible paper having an extensibility of greater than 7% in both the machine direction and the cross direction.

94. Any of the preceding embodiments, wherein:
said expandable slit sheet paper is formed from an extensible paper having an extensibility of greater than 8% in both the machine direction and the cross direction.

95. Any of the preceding embodiments, wherein:
said expandable slit sheet paper is formed from an extensible paper having an extensibility of greater than 9% in both the machine direction and the cross direction.

96. Any of the preceding embodiments, wherein said expandable slit sheet paper is made with an extensible paper that is extensible in a cross direction in a range of at least 3%.

97. Any of the preceding embodiments, wherein said expandable slit sheet paper is made with an extensible paper that is extensible in a cross direction in a range of at least 4%.

98. Any of the preceding embodiments, wherein said expandable slit sheet paper is made with an extensible paper that is extensible in a cross direction in a range of at least 5%.

99. Any of the preceding embodiments, wherein said expandable slit sheet paper is made with an extensible paper that is extensible in a cross direction in a range of at least 6%.

100. Any of the preceding embodiments, wherein said expandable slit sheet paper is made with an extensible paper that is extensible in a cross direction in a range of at least 7%.

101. Any of the preceding embodiments, wherein said expandable slit sheet paper is made with an extensible paper that is extensible in a cross direction in a range of at least 8%.

102. Any of the preceding embodiments, wherein said expandable slit sheet paper is made with an extensible paper that is extensible in a cross direction in a range of at least 9%.

103. Any of the preceding embodiments, wherein said expandable slit sheet paper is made with an extensible paper that is extensible in a cross direction in a range of at least 10%.

104. Any of the preceding embodiments, wherein said expandable slit sheet paper is made with an extensible paper that is extensible in a machine direction in a range of between 5% to 15% and in a cross direction in a range of between 5% to 15%.

105. Any of the preceding embodiments, wherein said expandable slit sheet paper made with an extensible paper that is extensible in a machine direction in a range of between 7% to 15% and in a cross direction in a range of between 7% to 15%.

106. Any of the preceding embodiments, wherein:
said expandable slit sheet paper is configured to be wrapped concurrently with said support wrap.

107. Any of the preceding embodiments, wherein:
said expandable slit sheet paper is configured to be wrapped concurrently with said support wrap, with said support wrap overlapping said expandable slit sheet paper.

108. Any of the preceding embodiments, wherein:
said expandable slit sheet paper is configured to be wrapped independently with respect to said support wrap.

109. Any of the preceding embodiments, wherein:
said expandable slit sheet paper is configured to be wrapped independently with respect to said support wrap, including at least one of:
a) said expandable slit sheet paper being supplied from a supply unit that independently raises and lowers said expandable slit sheet material from a support and that independently raises and lowers said support wrap with respect to said pallet assembly;
b) said expandable slit sheet paper being supplied from a supply unit that supplies said expandable slit sheet paper and said support wrap concurrently around said pallet assembly but at different vertical positions along the pallet assembly; and/or
c) said expandable slit sheet paper being supplied from a supply unit that supplies said expandable slit sheet paper and said support wrap at at least some different wrapping time sequences from one another.

110. Any of the preceding embodiments, wherein:
said expandable slit sheet paper requires a tensile load or force in a machine direction of greater than 5 lbs to expand the cells into any open state.

111. Any of the preceding embodiments, wherein:
said expandable slit sheet paper requires a tensile load or force in a machine direction of greater than 6 lbs to expand the cells into any open state.

112. Any of the preceding embodiments, wherein:
said expandable slit sheet paper requires a tensile load or force in a machine direction of greater than 8 lbs to expand the cells into any open state.

113. Any of the preceding embodiments, wherein:
said expandable slit sheet paper requires a tensile load or force in a machine direction of greater than 10 lbs to expand the cells into any open state.

114. Any of the preceding embodiments, wherein:
said expandable slit sheet paper requires a tensile load or force in a machine direction of greater than 12 lbs to expand the cells into any open state.

115. Any of the preceding embodiments, wherein:
said expandable slit sheet paper requires a tensile load or force in a machine direction of greater than 12 lbs to tear the expandable slit sheet paper.

116. Any of the preceding embodiments, wherein:
said expandable slit sheet paper requires a tensile load or force in a machine direction of greater than 14 lbs to tear the expandable slit sheet paper.

117. Any of the preceding embodiments, wherein:
said expandable slit sheet paper requires a tensile load or force in a machine direction of greater than 16 lbs to tear the expandable slit sheet paper.

118. Any of the preceding embodiments, wherein:
said expandable slit sheet paper requires a tensile load or force in a machine direction of greater than 18 lbs to tear the expandable slit sheet paper.

119. Any of the preceding embodiments, wherein:
said expandable slit sheet paper requires a tensile load or force in a machine direction of greater than 20 lbs to tear the expandable slit sheet paper.

120. Any of the preceding embodiments, wherein:
said expandable slit sheet paper requires a tensile load or force in a machine direction of greater than 22 lbs to tear the expandable slit sheet paper.

121. Any of the preceding embodiments, wherein:
said pallet assembly has a pallet with a supporting surface area of at least 3 feet by 3 feet (i.e., 36 inches by 36 inches).

122. Any of the preceding embodiments, wherein:
said pallet assembly includes stacked items, boxes or containers extending to a height of at least 3 feet (i.e., 36 inches).

123. Any of the preceding embodiments, wherein:
said expandable slit sheet paper is hyper expandable greater in length than a common expandable slit sheet paper.

124. Any of the preceding embodiments, wherein:
said expandable slit sheet paper is hyper expandable beyond 67% expansion.

125. Any of the preceding embodiments, wherein:
said expandable slit sheet paper is hyper expandable at least 10% more than 67% expansion.

126. Any of the preceding embodiments, wherein:
said expandable slit sheet paper is hyper expandable at least 15% more than 67% expansion.

127. Any of the preceding embodiments, wherein:
said expandable slit sheet paper is hyper expandable at least 20% more than 67% expansion.

128. Any of the preceding embodiments, wherein:
said expandable slit sheet paper is hyper expandable at least 25% more than 67% expansion.

129. Any of the preceding embodiments, wherein:
said expandable slit sheet paper is configured to not retract from a fully expanded state.

130. Any of the preceding embodiments, wherein:
said expandable slit sheet paper is configured to not retract or to minimally retract from a fully expanded state.

131. Any of the preceding embodiments, wherein:
said expandable slit sheet paper is configured to retract from a fully expanded state less than 20%, or, preferably, less than 15%, or, preferably, less than 12.5%, or, preferably, less than 10%, or, preferably, less than 7.5%, or, preferably, less than 5%, or, preferably, less than 2.5%.

132. Any of the preceding embodiments, wherein:
said expandable slit sheet paper is providing in a roll of expandable slit sheet paper in an unexpanded state.

133. Any of the preceding embodiments, wherein:
said expandable slit sheet paper is providing in a roll of expandable slit sheet paper in an unexpanded state having a width in an unexpanded state of greater than 7.5 inches.

134. Any of the preceding embodiments, wherein:
said expandable slit sheet paper is providing in a roll of expandable slit sheet paper in an unexpanded state having a width in an unexpanded state of greater than 10 inches.

135. Any of the preceding embodiments, wherein:
said expandable slit sheet paper is providing in a roll of expandable slit sheet paper in an unexpanded state having a width in an unexpanded state of greater than 12.5 inches.

136. Any of the preceding embodiments, wherein:
said expandable slit sheet paper is providing in a roll of expandable slit sheet paper in an unexpanded state having a width in an unexpanded state of greater than 15 inches.

137. Any of the preceding embodiments, wherein:
said expandable slit sheet paper is providing in a roll of expandable slit sheet paper in an unexpanded state having a width in an unexpanded state of greater than 17.5 inches.

138. Any of the preceding embodiments, wherein:
said expandable slit sheet paper is providing in a roll of expandable slit sheet paper in an unexpanded state having a width in an unexpanded state of greater than 20 inches.

139. Any of the preceding embodiments, wherein:
said expandable slit sheet paper is providing in a roll of expandable slit sheet paper in an unexpanded state having a width in an unexpanded state of between about 7.5 inches and 30 inches, or, preferably, between about 10 inches and 25 inches, or, preferably, between about 12.5 inches and 22.5 inches.

140. A pallet wrap, comprising:
an extensible paper sheet having an extensibility in at least a machine direction of greater than 3%.

141. The pallet wrap of embodiment 140, wherein said extensible paper sheet is an expandable slit sheet having an array of slits.

142. The pallet wrap of embodiments 140 or 141, further including a support wrap for supporting said extensible paper sheet.

143. In combination:
a) the pallet wrap of any of embodiments 140, 141 or 142; and
b) a pallet assembly, with said pallet wrap being wrapped around said pallet assembly with said extensible paper sheet wrapped around the periphery of the pallet assembly.

144. The combination of embodiment 143, wherein:
said pallet wrap further includes a support wrap surrounding at least a portion of said expandable slit sheet paper wrapped around said pallet assembly.

145. A pallet wrap, comprising:
an extensible paper sheet having an extensibility in at least a machine direction of greater than 4%, or, preferably, greater than 5%, or, preferably, greater than 6%, or, preferably, greater than 7%, or, preferably, greater than 8%, or, preferably, greater than 9%, or, preferably, greater than 10%, or, preferably, greater than 11%, or, preferably, greater than 12%.

The above and/or other embodiments, aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

This patent or application file contains at least one drawing executed in color. Copies of this patent or patent application publication with color drawing(s) will be provided by the Office upon request and payment of the necessary fee. The preferred embodiments of the present invention are shown by a way of example, and not limitation, in the accompanying figures, in which:

FIG. 1(A) is a plan view of an illustrative slit sheet paper according to the background art in an unexpanded state, specifically corresponding to FIG. 1 of U.S. Pat. No. 5,667,871, and FIG. 1(B) is a plan view of an illustrative slit sheet paper according to the background art in an expanded state, specifically corresponding to FIG. 3 of U.S. Pat. No. 5,667,871;

FIG. 2(A) shows a top plan view of a sample expanded slit sheet paper employing Kraft paper, which opens in a manner substantially similar to that shown in FIG. 1(B);

FIG. 2(B) shows a top view of the same expanded slit sheet paper shown in FIG. 2(A) taken at an angle to the plane of the expanded paper, such as to look directly into the expanded cells of the paper;

FIG. 2(C) shows a top view of the same expanded slit sheet paper shown in FIGS. 2(A) and 2(B), but taken an angle to the plane of the expanded paper opposite to that of the angle shown in FIG. 2(B);

FIG. 2(D), shows a top view of the same expanded slit sheet paper shown in FIGS. 2(A)-2(C), but taken from an angle to the plane of the expanded paper from a position lower to the plane of the paper proximate the lower end of FIG. 2(D);

FIG. 3(A) shows a top plan view of an alternating row expansion pattern of an expanded slit sheet paper according to some preferred embodiments of the present invention;

FIG. 3(B) shows a top view of the expanded slit sheet paper shown in FIG. 3(A) taken at an angle to the plane of the paper, such as to look at the expanded slit sheet paper from a top right side of the view in FIG. 3(A);

FIGS. 4(A) to 4(C) show the formation of the alternating row expansion pattern employed in some embodiments of the invention, wherein FIG. 4(A) shows an illustrative slit pattern formed within a sheet of paper, FIG. 4(B) shows the slit pattern of FIG. 4(A) with regions of the paper prior to expansion highlighted for reference, and FIG. 4(C) is a photograph of an illustrative expanded slit sheet paper having a slit pattern similar to that shown in FIG. 4(B) in an expanded state;

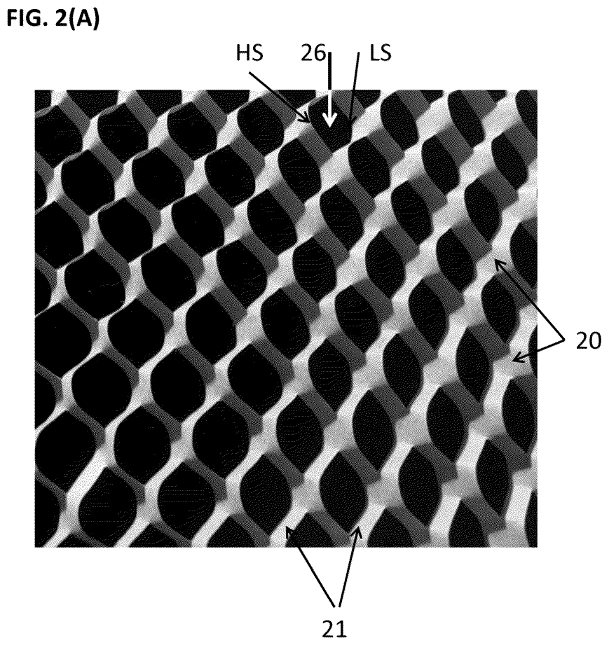

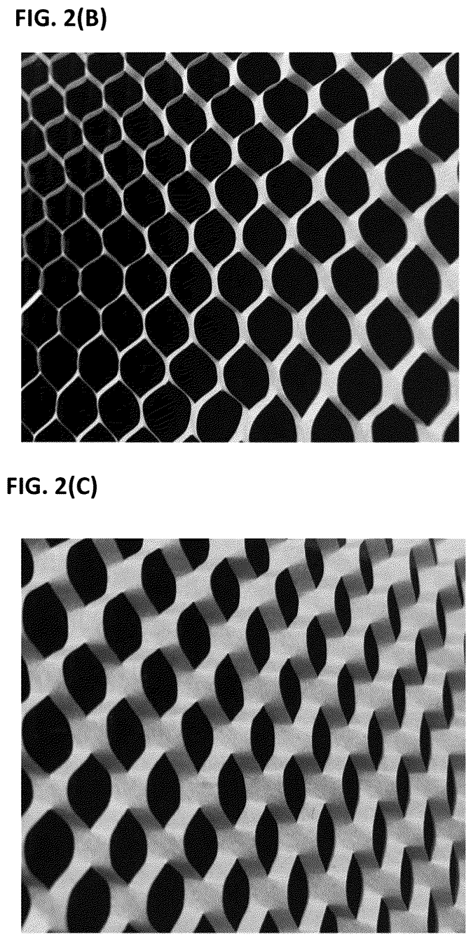

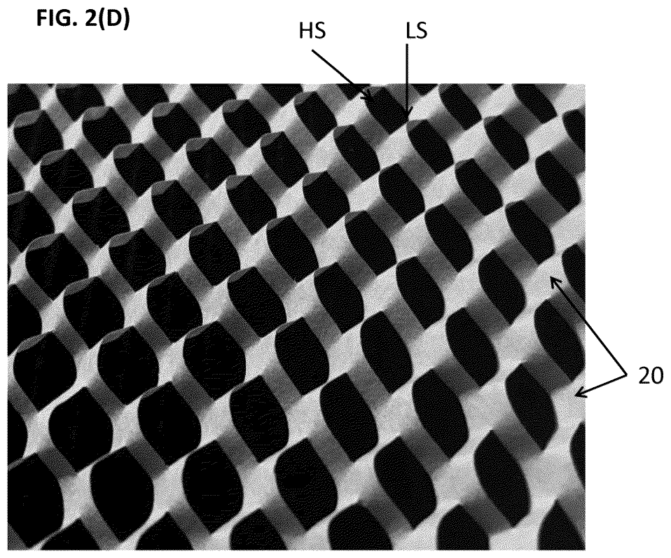

In the attached drawings, FIGS. 2(A)-2(D), 3(A)-3(B) and 4(C) are photographs of actual products. Accordingly, these photographs show illustrative examples, to scale, such that these figures show illustrative examples to scale and angles and relative dimensions shown in these figures are as shown in these figures in such illustrative examples. Thus, e.g., angles of lands, legs, and other portions of the expanded slit sheet paper can be, in some embodiments, as shown in such figures. Moreover, in some alternative embodiments, such shown angles and relative dimensions can be varied slightly, such as, e.g., plus or minus 15% in some examples, or plus or minus 10% in some other examples.

FIG. 5 is a schematic perspective view showing a pallet wrapping system and method according to a first embodiment of the invention;

FIG. 6 is a schematic perspective view showing a pallet wrapping system and method according to a second embodiment of the invention;

FIGS. 7(A) and 7(B) are schematic top views of an illustrative pallet assembly demonstrating conveyance relationships between expandable slit sheet paper and support wrap in some illustrative embodiments;

FIG. 8 is a schematic diagram showing components of a controller or control unit in some illustrative embodiments;

FIG. 9 is a plan view of an illustrative pallet wrap that can be employed in some illustrative embodiments of the invention;

FIG. 10 is a perspective view of an illustrative pallet assembly with a banner wrapped therearound in accordance with some illustrative embodiments of the invention;

FIG. 11 is a schematic perspective view showing a pallet wrapping system and method according to a third embodiment of the invention;

FIGS. 12(A) and 12(B) are perspective views showing illustrative pallet assemblies (e.g., illustrative boxes and/or containers stacked as pallet assemblies upon a pallet) according to some illustrative examples;

FIG. 13 is a schematic plan view (i.e., top view) illustrating rotation of a pallet assembly in relation to a packaging wrap according to some illustrative embodiments;

FIG. 14 is a schematic perspective view showing an illustrative manual pallet wrapping system and method according to another embodiment of the invention; and

FIG. 15 is a schematic perspective view showing an illustrative embodiment of retrofitting an existing pallet wrap machine that does not dispense expandable slit sheet paper to become a pallet wrap machine that dispenses expandable slit sheet paper according to an embodiment of the present invention.

### DETAILED DESCRIPTION OF THE PREFERRED EMBODIMENTS

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

### Introduction to the Preferred Embodiments

1. According to some preferred embodiments of the present invention, a novel and highly beneficial pallet wrap is provided that is made with recyclable materials.

2. According to some preferred embodiments of the present invention, a novel and highly beneficial pallet wrap is provided that is made with recyclable paper.

3. According to some preferred embodiments of the present invention, a novel and highly beneficial pallet wrap is provided that is made with an expandable slit sheet paper material.

4. According to some preferred embodiments of the invention, a novel and highly beneficial pallet wrap is provided that is made with an extensible paper material.

5. According to some preferred embodiments of the invention, a novel and highly beneficial pallet wrap is provided that is a) made with an expandable slit sheet paper material and b) made with an extensible paper material.

### Unexpected Results and Advantages of the Preferred Embodiments

For many years, plastic wraps have persisted as the means for wrapping of pallets within the art, such as, e.g., seen in patents and publications incorporated herein by reference.

Due to, e.g., forces imparted on pallet wraps and the deficiencies of paper materials, paper materials have historically been entirely unsuitable for use in pallet wraps and non-recyclable plastics materials have been understood as the only viable pallet wrapping materials.

However, the present inventor discovered that, unexpectedly, a highly viable pallet wrap can be created by employing highly unique and advantageous paper materials in accordance with features of the preferred embodiments of the invention as described herein.

According to a first embodiment discovered by the present inventor to achieve the unexpected result of enabling the provision of paper materials as pallet wrap materials, and, highly advantageously, enabling the provision of recyclable pallet wrap materials, the present inventor discovered that a suitable pallet wrap can be created by providing a novel and unique combination of: a) an extensible paper material having a particular range of extensibility; b) the extensible paper material being formed with an array of slits such as to form an expandable extensible slit sheet material; and c) an supporting wrap provided to support the expandable extensible slit sheet material.

In this present document, it should be understood that extensibility of paper is a quality of the paper, and that %'s of extensibility described in this document pertain to extensibility as measured with respect to the paper in an unslit condition (i.e., the % of extensibility being due to the quality of the paper rather than to the mechanics of expanding slit paper).

The present inventor discovered that such a novel first embodiment can provide a highly viable pallet wrap that is made with paper materials, and, very advantageously, in which the pallet wrap is recyclable.

Additionally, as described in detail below, the present inventor also discovered various additional embodiments achieving, e.g., the unexpected result of enabling the provision of paper and the like materials as pallet wrap materials, including, for example, various embodiments employing various novel and advantageous pallet wraps made of, e.g., recyclable materials (e.g., recyclable paper) that can be implemented without the use of an additional support wrap or other supporting elements to further support the pallet wrap.

Among other things, prior to the present inventor's discovery of embodiments of the present invention, paper wrapping materials were not previously known that were able to provide the structural features unexpectedly enabled by the various embodiments of the present invention of the present inventor.

Accordingly, the preferred embodiments of the present invention unexpectedly and highly advantageously provided novel and advantageous alternatives to the plastics used to wrap around pallets as well as to the existing plastic shrink wraps used to support pallets in the existing art.

### Further Discussion of Illustrative Embodiments

FIG. 5 shows an illustrative embodiment of the present invention. In this illustrative embodiment, a pallet wrap 500 is employed that is made with recyclable paper materials. In the preferred embodiments, the pallet wrap 500 includes a first material 510 that includes an expandable slit sheet material supplied from a roll of expandable slit sheet material 210, and includes a supporting wrap 520 that is supplied from at least one roll of supporting wrap material 220. In the illustrated embodiments, two rolls of supporting wrap material 220 are depicted. However, alternative embodiments can include a single roll 220, or three rolls 220, or four rolls 220 or more.

In the illustrated embodiment, the pallet wrap 500 is supplied from a pallet wrap supply unit 200. In the preferred embodiments, the pallet wrap supply unit 200 includes at least one support 200C that rotatably supports the roll of expandable slit sheet material 210 and at least one support 200C that rotatably supports the at least one roll of supporting wrap material 220.

In some embodiments, such as, e.g., shown in FIG. 5, the roll of expandable slit sheet material 210 and the at least one roll of supporting wrap material 220 are supported by the same support 200C. However, in other embodiments, separate supports can be provided supporting the roll of expandable slit sheet material 210 and the at least one roll of supporting wrap material 220.

In the preferred embodiments, the pallet wrap supply unit 200 is configured to enable the supply rolls 210 and 220 to be controllably raised and/or lowered in order to adjust the supply height of the expandable slit sheet material 510 and the supporting wrap 520. In some embodiments, as shown in the example of FIG. 5, the support 200C can include a cabinet or holder structure that is configured to be controllably raised and/or lowered upon a support shaft 200S that is mounted to extend upright alongside the pallet 10 and is supported upon a support member or base 200B. As depicted by the double-sided arrow 200R in FIG. 5, in the preferred embodiment the support 200C is configured to be both controllably raised and controllably lowered during operation.

In some preferred embodiments, mechanisms to raise or lower the support 200C can be like that of mechanisms in the patents and publications incorporated herein by reference. Similarly, in other embodiments, a supply unit 200 can be configured like that of the background supply devices of plastic wraps, etc., of the patents and publications incorporated herein by reference.

In some embodiments, a mechanism to raise and lower the support 200C can include any mechanical/electrical reciprocation mechanism that can reciprocate the support 200C, such as, by way of example: a timing belt; a conveyor belt; a pulley system; an hydraulic piston; a solenoid mechanism; an electronic motor; a threaded engagement between the shaft 200S and the support 200C, such that rotation of the shaft 200S causes reciprocal movement of the support 200C; and/or other suitable mechanical/electrical reciprocation mechanism(s).

As shown in FIG. 5, in the preferred embodiments, the pallet wrap 500 that is supplied from the pallet wrap supply unit 200 is preferably initially held alongside a side of a pallet assembly 10 (e.g., an assembly of items such as, e.g., a plurality of boxes) that is supported upon a pallet 110 (e.g., a horizontal support member such as, e.g., a wooden support frame or other support member). In the preferred embodiments, the pallet 110 and the pallet assembly 10 thereon are supported by the pallet support unit 100. In the preferred embodiments, the pallet support unit 100 includes a rotatable support floor member 120 upon which the pallet 110 rests, and which is controllably rotatable around a center axis 100A so as to rotate in at least a direction 100R to cause the pallet wrap 500 to unroll from the rolls 210 and 220 and surround the pallet assembly 10 as shown in FIG. 5. Although the embodiment shown in FIG. 5 wraps the pallet assembly by rotation in the direction of arrow 100R, it should be appreciated that other embodiments can impart wrapping by rotation in an opposite direction and/or by rotation in either the direction of arrow 100R or an opposite direction thereto.

In the preferred embodiments, the pallet 110 is a horizontal support member that includes a frame structure configured to enable the pallet to be lifted and manipulated via pallet-moving machinery, such as, by way of example, a forklift device. In the preferred embodiments, the pallet is provided to support a stack of boxes or containers thereon as shown in, e.g., FIG. 5. In some preferred embodiments, the boxes or containers contain items of merchandise and/or other items which are stored within the boxes or containers for transportation and/or movement and/or storage of items of merchandise and/or other items. In some embodiments, such pallets can be employed in warehouses, storage facilities, transportation systems, such as, e.g., boats, trains, planes, trucks and/or other vehicles for transportation of items of merchandise and/or other items. In some embodiments, a pallet can support a plurality of like items that are stacked thereon. For example, in the embodiment shown in FIG. 12(A), like items are stacked on a pallet (pallet not shown). In other embodiments, a pallet can support a plurality of varied items, having different shapes and/or dimensions. For example, in the embodiment shown in FIG. 12(B), a plurality of varied items are shown stacked on a pallet (pallet not shown). Accordingly, as shown in FIGS. 12(A) and 12(B), depending on the items stored upon the pallet, the pallet assembly thereon may have different contours and, thus, may present different surface features that a pallet wrap must deal with. Additionally, in some instances, narrower boxes or packages may have higher degrees of instability. Additionally, in some instances, the weight of particular items within boxes or containers can also affect requirements. Accordingly, it should be appreciated that different pallet assemblies can present different requirements on a pallet wrap that supports the particular pallet assembly on the pallet.

As also described herein, the present invention provides a highly novel and advantageous pallet wrap 500 that includes, e.g., a highly novel and advantageous expandable slit sheet paper 510. Notably, the configuration of the expandable slit sheet paper according to the preferred embodiments of the present invention provides a) increased tensile strength over prior expandable slit sheet paper (i.e., thus, enabling the use in wrapping of pallets) and b) substantial flexibility (e.g., provided by expansion in a machine direction), along with increased ability to contour to corners of boxes and the like on the pallet assembly (such as, e.g., even in varied embodiments similar to that shown in FIG. 12(B)). For example, an expandable slit sheet paper can be expanded and wrapped around a pallet assembly, and the nature of the expandable slit sheet paper will facilitate bending, twisting and/or contouring of the expandable slit sheet paper as it is wrapped around irregular contours of the pallet assembly, altering direction of tensile stretching around the pallet assembly, bending around a non-planar surface and/or otherwise altering direction, contour, etc., as it is wrapped around the pallet assembly.

As shown in FIG. 5, in some preferred embodiments, the rotatable support floor member 120 is caused to be rotated via a motor 100M, whereby the pallet assembly 10 can be readily and controllably rotated by rotation of the support floor member 120 which in turn rotates the pallet 110 and in turn the pallet assembly 10.

In some alternatively embodiments, the support floor member 120 can be manually rotated, such as, e.g., by a user grasping one or more handle to impart rotation and/or the side of the pallet or pallet assembly. However, in preferred embodiments, a motor 100M is preferably employed.

In the preferred embodiments, the motor 100M is controlled to effect rotation by a controller 300 or control unit as shown in FIG. 5. In some embodiments, the controller 300 can include a simple on/off switch to start or stop rotation of the support floor member 120. In other embodiments, the controller can be computer controlled such as to more precisely control rotation of the support floor member 120. In some embodiments, the controller 300 also controls a reciprocal movement of the support 200C, such that the rotational movement of the support floor member 120 is controlled along with the reciprocal movement of the support 200C.

In some preferred embodiments, the controller 300 is employed to control the vertical movement of the support 200C commensurately with the rotation of the support floor member 120. In some embodiments, a user can set the relative movements, based on factors, such as, e.g., the size of the pallet assembly 10, the width of the expandable slit sheet material 510, etc., and/or other circumstances. For example, in some contexts a user may desire more overlapping of layers of the expandable slit sheet material 510 for greater support whereby the relative vertical speed of the support 200C may be moved at a slower rate with respect to the rotation of the support floor member 120.

FIG. 8 shows illustrative controller or control unit components according to some illustrative embodiments. In some embodiments, a controller or control unit can be provided that employs a computer or like control unit that is used to implement computerized process steps, to be carried out by devices, such as, e.g., to control operation of motors for rotating the pallet support, to control other aspects of control according to other embodiments (such as, by way of example, raising/lowering of expandable paper and/or the like) according to some embodiments. In some embodiments, the computer or control unit includes a central processing unit (CPU) 322, which can communicate with a set of input/output (I/O) device(s) 324 over a bus 326. The I/O devices 324 can include, for example, a keyboard, monitor or display, and/or other devices. The CPU 322 can communicate with a computer readable medium (e.g., conventional volatile or non-volatile data storage devices) 328 (hereafter “memory 328”) over the bus 326. The interaction between a CPU 322, I/O devices 324, a bus 326, and a memory 328 can be like that known in the art. Memory 328 can include, e.g., data 330. The memory 328 can also store software 338. The software 338 can include a number of modules 340 for implementing the steps of processes. Conventional programming techniques may be used to implement these modules. Memory 328 can also store the above and/or other data file(s). In some embodiments, the various methods described herein may be implemented via a computer program product for use with a computer system. This implementation may, for example, include a series of computer instructions fixed on a computer readable medium (e.g., a diskette, a CD-ROM, ROM or the like) or transmittable to a computer system via and interface device, such as a modem or the like. A communication medium may be substantially tangible (e.g., communication lines) and/or substantially intangible (e.g., wireless media using microwave, light, infrared, etc.). The computer instructions can be written in various programming languages and/or can be stored in memory device(s), such as semiconductor devices (e.g., chips or circuits), magnetic devices, optical devices and/or other memory devices. In the various embodiments, the transmission may use any appropriate communications technology.

FIG. 6 shows another embodiment that is similar to the embodiment shown in FIG. 5. In the embodiment shown in FIG. 6, elements that are similar to that of the embodiment shown in FIG. 5 are shown with similar reference numbers, along with the identifier “a” designating the embodiment shown in FIG. 6. However, in contrast to the embodiment shown in FIG. 5, in the embodiment shown in FIG. 6, separate supports are provided supporting the roll of expandable slit sheet material 210a and the at least one roll of supporting wrap material 220a. For example, in the embodiment shown in FIG. 6, the roll 210a is schematically depicted as being reciprocatable upward and downward along the support shaft 200aS1, and the roll 220a is schematically depicted as being reciprocatable upward and downward along the support shaft 200aS2.

In the embodiment shown in FIG. 6, support structures of the roll 210a and of the roll 220a are, thus, configured to provide independent upward and downward movement of the rolls 210a and 220a. In this illustrative schematic embodiment, the support structures of the roll 210a and 220a include a common base support 200aC. As with the embodiment shown in FIG. 5, the vertical (i.e., up and down) movement of the rolls 210a and 220a can be imparted employing any mechanical/electrical reciprocation mechanism that can reciprocate the support 200aC, such as, by way of example: a timing belt; a conveyor belt; a pulley system; an hydraulic piston; a solenoid mechanism; an electronic motor; a threaded engagement between the shaft(s) 200aS1 and 200aS2 and the support 200aC, such that rotation of the shaft(s) cause reciprocal movement of the respective rolls; and/or other suitable mechanical/electrical reciprocation mechanism(s).

In the embodiment shown in FIG. 5, the support wrap 520 is consistently dispensed alongside the expandable slit sheet material 510, whereby the pallet wrap 500 is consistently supplied as a two-layered structure with the support wrap 520 consistently located relative to the expandable slit sheet material 510. However, in the embodiment shown in FIG. 6, independent movement of the expandable slit sheet material 510 with respect to the support wrap 520 enables other forms of control in various embodiments. For example, with the independent movement afforded by the embodiment of FIG. 6, the vertical positions of the expandable slit sheet material 510 and the support wrap 520 can differ from one another. Additionally, with the independent movement afforded by the embodiment of FIG. 6, the structure can also be more readily employed to apply the respective expandable slit sheet material 510 and the support wrap 520 independently at different times. For example, in some embodiments, the expandable slit sheet paper 510 can be initially applied around a portion or all of the pallet assembly 10a prior to wrapping of the support wrap 520. As another example, in some embodiments, the expandable slit sheet paper 510 can be raised and/or lowered at a different rate than that of the support wrap 520.

### The Novel/Advantageous Pallet Wrap and Other Aspects

As described herein-above, the present invention provides a novel and highly advantageous pallet wrap (e.g., 500, 500a) having substantial advantages and achieving unexpected results.

In some preferred embodiments, an expandable slit sheet paper layer 510, 510a is applied as a first layer that makes contact with the pallet assembly 10, and the support wrap 520, 520a is applied as a second layer that is wrapped over the expandable slit sheet paper layer.

In some preferred embodiments, the expandable slit sheet paper is provided from a unique and novel expandable slit sheet paper having unusually high tensile properties, while providing expansion in a lengthwise or machine direction and cushioning in a widthwise direction of the expandable slit sheet paper. These qualities and characteristics are highly advantageous in the wrapping of pallets due to, for example, the shifting of items within the pallet assembly on the pallet during transport and handling, vibration and/or the like. In some preferred embodiments, the expandable slit sheet paper can be made with very unique paper and characteristics as described herein.

In some preferred embodiments, the support wrap is utilized along with the expandable slit sheet paper in order to provide further support of the expandable slit sheet paper. Although some embodiments can omit the support wrap and can employ only an expandable slit sheet paper as a pallet wrap according to some embodiments, in some of the preferred embodiments, a support wrap is further provided as described herein.

In some preferred embodiments, the support wrap is made of a material that does not elongate in the machine direction or lengthwise in the same manner as the expandable slit sheet material. Therefore, the support wrap is preferably employed as a reinforcing layer to help more rigidly maintain the wrapped state of the pallet assembly.

In some preferred embodiments, the support wrap is made with a narrow width material. Moreover, in some preferred embodiments, while the expandable slit sheet material would surround a substantial portion of or all of the periphery of the pallet assembly 10, the support wrap would not surround a substantial portion or all of the periphery of the pallet assembly. Accordingly, in some preferred embodiments, the expandable slit sheet paper would be visible and not covered by the support wrap in a significant percentage of the outer periphery of the pallet assembly.

In some preferred embodiments, the support wrap includes one or more of the following:
a) reinforced paper (such as, in some examples, fiber or filament reinforced paper);
b) reinforced tape (such as, in some examples, fiber or filament reinforced tape);
c) fiber strands or filaments (extending lengthwise within the support wrap for lengthwise reinforcement);
d) a plurality of filaments or fibers (extending lengthwise);
e) fiberglass;
f) fiberglass filaments (extending lengthwise);
g) tape (e.g., such as to resist stretching or extension); and/or
h) paper tape (e.g., heavier paper and/or treated such as to resist stretching or extension).

In some embodiments, the support wrap can include any existing fiber-reinforced tapes and/or fiber reinforced papers. In some illustrative embodiments, the support wrap can include fiber-reinforced papers, tapes and/or other materials as described within any of the below-listed patents and publications, the entire disclosures of which are incorporated herein by reference as if recited herein in full. Moreover, in some embodiments, the support wrap can be a plurality of filaments or fibers independent of a paper or tape supporting the plurality of filaments or fibers, such as, in some examples, a plurality of filaments or fibers of the types set forth in any of the below-listed patents and publications, the entire disclosures of which are incorporated herein by reference as if recited herein in full:
1. U.S. Patent Publication No. 2005/0263234A1, entitled Reinforced Paper Product and Method for Making the Same;
2. U.S. Pat. No. 5,494,748, entitled Reinforcement Fibers and/or Process Fibers Based on Plant Fibers;
3. U.S. Pat. No. 5,806,387, entitled Method for Dispensing Resinated Reinforcement Fibers;
4. U.S. Pat. No. 7,241,407, entitled Method and Apparatus for Making Plate-Like Fiber-Reinforced Products;
5. PCT application WO 2016/142786, entitled Method for making Unidirectional Fiber-Reinforced Tapes;
6. PCT application WO 2005/068721, entitled Reinforced Recyclable Paper;
7. U.S. Pat. No. 2,895,865, entitled Filament Reinforced Gummed Tear-Tape;
8. U.S. Pat. No. 2,604,424, entitled Glass Fiber Reinforced Crepe Paper;
9. U.S. Pat. No. 5,401,557, entitled Thread-Reinforced Paper Sheet and Thread-Reinforced Gummed Tape;
10. PCT application WO 2014/058513, entitled Multidirectional Fiber-Reinforced Tape/Film Articles and the Method of Making the Same;
11. U.S. Pat. No. 2,321,512, entitled Method and Apparatus for Forming Reinforced Tape;
12. U.S. Pat. No. 7,056,844, entitled Transparent Reinforced Tape;
13. U.S. Pat. No. 4,539,248, entitled Reinforced Filament Tape.

In some embodiments, the support wrap can include a narrow or minimal amount of plastic webbing or plastic strands or plastic ropes or plastic filaments. In some embodiments, for example, roping of the type shown in U.S. Pat. No. 8,549,819, entitled Pallet Roping and Wrapping Apparatus and Method, can be employed, the entire disclosure of which patent is incorporated herein by reference as though recited herein in full. However, as most preferred embodiments of the present invention provide a recyclable pallet wrap, the more preferred embodiments would not include amounts of plastics that would preclude or limit recyclability.

In some embodiments, the support wrap employed can comprise filaments found in reinforced tapes. In some embodiments, the filaments include elongated strands or string-like members that can be wound around a roll in a similar manner to that shown in the figures related to, e.g., the rolls 220, 220a. In some embodiments, the expandable slit sheet paper can be wrapped around the pallet assembly (e.g., 10, 10a) and the filaments can be wound around an outer surface of the expandable slit sheet paper (such as, e.g., in a similar manner to any of the embodiments described above, such as, e.g., in either of the embodiments shown in FIGS. 5 and 6).

In some embodiments, the support wrap can employ filaments that are either a) supported by or integrated with a tape, paper or other material or b) independently provided as the support wrap. In some preferred embodiments, filaments can include any fibrous product that would add strength (e.g., tensile strength) to the wrapping process. In some illustrative embodiments, filaments can include one or more of the following:
a) nylon filaments;
b) polymer filaments;
c) glass filaments; and/or
d) natural filaments, such as, e.g., plant filaments, cotton filaments, bamboo filaments, etc.

Additionally, in some embodiments, the filaments can comprise a plurality of entwined filaments, a plurality of parallel filaments and/or a plurality of filaments otherwise fixed or bound together.

Although some of the preferred embodiments provide a support wrap (e.g., 520, 520a) that includes a reinforced tape or paper, such as, e.g., reinforced with filaments or the like, or reinforcing filaments or the like without such tape or paper, in some embodiments, the support wrap can comprise a heavy weight paper having sufficient strength to provide a sufficient support wrap under certain circumstances (i.e., a non-slit heavy paper can be employed in some embodiments). For example, in some embodiments, a support wrap (e.g., 520, 520a) can be provided by a paper having a weight of 40# or larger. For example, in some embodiments, a support wrap (e.g., 520, 520a) can be provided by a paper having a weight of 45# or larger. For example, in some embodiments, a support wrap (e.g., 520, 520a) can be provided by a paper having a weight of 50# or larger. For example, in some embodiments, a support wrap (e.g., 520, 520a) can be provided by a paper having a weight of 55# or larger. For example, in some embodiments, a support wrap (e.g., 520, 520a) can be provided by a paper having a weight of 60# or larger. For example, in some embodiments, a support wrap (e.g., 520, 520a) can be provided by a paper having a weight of 65# or larger.

In some preferred embodiments, when such a heavy unslit paper is employed as the support wrap, the support wrap has a width that is substantially narrower than the width of the expandable slit sheet paper. In some embodiments, the width of such a heavy unslit paper type support wrap can be similar to that of any of the embodiments of support wrap widths described herein-above (i.e., excluding embodiments related to support wraps without paper, tape or the like, such as, e.g., some filament-only embodiments).

In some embodiments, rather than having a support wrap (e.g., 520, 520a) independently rolled on a separate roll (e.g., 220, 220a) from a roll of expandable slit sheet paper (e.g., 210, 210a), a support wrap can be wrapped alongside within the roll of expandable slit sheet material such as to be co-rolled as a single roll and co-dispensed from the single roll.

In some embodiments, such as, e.g., in some co-rolled embodiments, the support wrap can be glued or adhered to the expandable slit sheet paper in a manner that upon expansion of the expandable slit sheet paper, the glue or adhesion will give way or accommodate the expansion and will not interfere with such expansion. For example, the glue can be lightly adhesive to facilitate co-dispensing without interference with expansion. However, in such embodiments, as the support wrap is designed specifically to provide reinforcement (e.g., tensile reinforcement) and preferably does not expand in a similar manner to the expandable slit sheet material, if the support wrap is co-rolled or adhered to the expandable slit sheet paper, the support wrap is preferably adapted to accommodate such elongation. For example, as shown in FIG. 9, in some embodiments, a support wrap 520c, comprising a plurality of elongated filaments 520c is adapted such that the filaments are not arranged in a straight line, but arranged in a wavy formation, or an undulating formation, which waves or undulations are preferably sized such that the filaments reach a straight relationship upon full or near full expansion of the expandable slit sheet paper.

By way of example, in some embodiments, a support wrap can include four filaments provided alongside the expandable slit sheet paper, such as, e.g., shown in the example in FIG. 9. In other embodiments, a single filament can be provided. In other embodiments, two filaments can be provided. In other embodiments, three filaments can be provided. In other embodiments, five filaments can be provided. In other embodiments, six or more filaments can be provided.

In some embodiments, in which filaments are applied as the support wrap, rather than having the filaments co-rolled with the expandable slit sheet paper, the filaments can be co-rolled on a filament roll such that a plurality of filaments are co-unrolled from a single roll (e.g., similar to unrolling from a roll 220, 220a). Alternatively, in some embodiments in which filaments are applied as the support wrap, but not co-rolled with the expandable slit sheet paper, each individual filament can be separately dispensed or supplied, such as, e.g., each individual filament being supplied by a separate and individual filament roll. In some embodiments, when multiple filament rolls are provided, each filament roll can be mounted on a separate reciprocating mechanism (e.g., similarly to the embodiment shown in FIG. 6 in which rolls 210a and 220a are separately reciprocatable), whereby the filaments can be applied at different locations and in different patterns around the periphery of the pallet assembly.

Similarly, although the illustrated embodiments show a single roll of expandable slit sheet material (e.g., 210, 210a) supplied to wrap the pallet assembly, in various other embodiments, two or more such rolls can be provided, which can be either co-reciprocated in some embodiments or individually reciprocated in other embodiments. Moreover, in various embodiments in which multiple rolls of expandable slit sheet material and/or of support wrap (e.g., filaments or otherwise) are provided, such rolls can be distributed around the periphery of the pallet assembly in a variety of manners. However, co-locating such rolls proximate one side of the pallet assembly can facilitate use (e.g., facilitating placement of the pallet assembly and pallet upon the support surface of the pallet support or the like).

In some embodiments, to initially attach or support the expandable slit sheet paper (e.g., 510, 510a) with respect to the pallet assembly to enable wrapping of the pallet assembly, a distal end of the support wrap (such as, e.g., filaments or tape) can be tied, or otherwise connected, to the pallet (e.g., 110, 110a) or to a portion of the pallet assembly.

In some embodiments, to initially attach or support the expandable slit sheet paper (e.g., 510, 510a) with respect to the pallet assembly to enable wrapping of the pallet assembly, a distal end of the support wrap (such as, e.g., filaments or tape) can be fixed to the pallet (e.g., 110, 110a) or to a portion of the pallet assembly by tape, adhesive, clamps, and/or other fixing elements.

In some embodiments, the distal end of the expandable slit sheet material is held with respect to the pallet assembly to enable wrapping of the pallet assembly by being located beneath the support wrap such that the support wrap holds the distal end of the expandable slit sheet material against the pallet assembly and/or pallet.

In some embodiments, to initially attach or support the expandable slit sheet paper (e.g., 510, 510a) with respect to the pallet assembly to enable wrapping of the pallet assembly, a distal end of the expandable slit sheet paper can similarly be fixed to the pallet (e.g., 110, 110a) or to a portion of the pallet assembly by tape, adhesive, clamps, and/or other fixing elements.

In some embodiments, to initially attach or support the expandable slit sheet paper (e.g., 510, 510a) with respect to the pallet assembly to enable wrapping of the pallet assembly, a distal end of the expandable slit sheet paper can similarly be tied, or otherwise connected, to the pallet (e.g., 110, 110a) or to a portion of the pallet assembly.

In some embodiments, to initially attach or support the expandable slit sheet paper (e.g., 510, 510a) with respect to the pallet assembly to enable wrapping of the pallet assembly, rather than tying or fixing a distal end of the expandable slit sheet paper to the pallet (e.g., 110, 110a) or to a portion of the pallet assembly, a movable pin, rod, lever or clamp member can be provided proximate the pallet (e.g., 110, 110a) or proximate a lower portion of the pallet assembly (e.g., 10, 10b) that can be moved against the outer surface of the pallet and/or the pallet assembly such as to press and hold the distal end of the expandable slit sheet paper against the pallet and/or pallet assembly. For example, a pin, rod, lever or clamp member can be mounted to the support surface 120, 120a so as to be pivotally movable against the side of the pallet or pallet assembly and locked in a pressing state thereagainst. In this manner, to initiate wrapping, a user can place an end of the expandable slit sheet paper against the pallet or lower end of the pallet assembly, can press the pin, rod, lever or clamp member thereagainst and can start the rotation of the pallet assembly to initiate wrapping. Once the pallet assembly has made a sufficient amount of rotation (such as, e.g., one or two or more rotations, in some embodiments, the expandable slit sheet paper's open cells between adjacent layers can provide sufficient support to retain the expandable slit sheet paper around the pallet assembly without the provision of the pin, rod, lever or clamp member and the pin, rod, lever or clamp member can be moved to a disengaged position and no longer apply retaining pressure, while the expandable slit sheet paper can remain on the pallet assembly due to engagement between layers of open cells. Moreover, in some embodiments, additional tape or the like can be added if needed or desired to facilitate maintaining of the expanded slit sheet paper around the pallet assembly.

In some embodiments, the expandable slit sheet paper (e.g., 510, 510a) has a width, in an unexpanded state, in a cross-direction (e.g., a direction parallel to an axis of the roll (e.g., 210, 210a)) that is between about 4 to 36 inches, and, in some preferred embodiments, that is between about 8 to 24 inches, and, in some other preferred embodiments, that is between about 12 to 19 inches, and, in some other preferred embodiments, that is between about 14.5 to 16.5 inches, and, in some illustrative embodiments, that is about 15.25 inches. However, in other embodiments, other widths can be employed, such as, e.g., widths of larger than 36 inches in an unexpanded state. Moreover, in some embodiments, the support wrap (e.g., 520, 520a) has a width in a cross-direction (e.g., transverse to a length of the support wrap) that is substantially narrower than that of the expandable slit sheet paper. For example, in embodiments in which a narrow paper or tape is provided, the width is preferably less than about 4 inches in some preferred embodiments. In some more preferred embodiments, the width of the support wrap is less than about 3.5 inches. In some more preferred embodiments, the width of the support wrap is less than about 3.0 inches. In some preferred embodiments, the width of the support wrap is less than about 2.5 inches. In some preferred embodiments, the width of the support wrap is less than about 2.0 inches. In some preferred embodiments, the width of the support wrap is less than about 1.5 inches. In some preferred embodiments, the width of the support wrap is less than about 1.0 inches. In some preferred embodiments, the width of the support wrap is less than about 0.75 inches. In some preferred embodiments, the width of the support wrap is less than about 0.5 inches. In some preferred embodiments, the width of the support wrap is less than about 0.25 inches. In some preferred embodiments, such as, e.g., with some embodiments employing filaments as support wraps, the width is substantially less than 0.25 inches, and, in some embodiments preferably, even less than 0.1 inches, and, in some embodiments, preferably, even less than 0.05 inches and, in some embodiments, as narrow as various filaments described in the background patents and publications incorporated by reference herein.

In some embodiments, a modified support wrap can be provided that includes filaments supported on or laminated to a light-weight paper sheet, such as, e.g., a light-weight Kraft sheet. In some embodiments, the light-weight Kraft sheet can have a width of greater than 4 inches, and in some embodiments a width that is the same or similar to that of the expandable slit sheet paper in an expanded state or even in an unexpanded state, or even larger. In some embodiments, use of such an external lightweight Kraft sheet can be provided to provide a protective layer to the underlying expanded slit sheet paper, such as to, e.g., protect the expanded slit sheet paper from abrasion or the like during handling, transport and/or shipment. In some examples, such a light-weight Kraft sheet can involve, e.g., a paper having a weight of less than 40#, or, in some embodiments, less than 35#, or, in some embodiments, less than 30#, or, in some embodiments, less than 25#, or, in some embodiments, less than 20#.

In the preferred embodiments, the expandable slit sheet paper layer advantageously tightens everything up and provides a cushioned barrier for the outer support wrap (e.g., paper tape or the like) to hold everything together without bursting the support wrap (e.g., paper tape). In particular, in some implementations, the support wrap (e.g., tape) would burst if there wasn't the flexibility underneath it provided by the expandable slit sheet material to accommodate vibrations and/or slight load shifts of the pallet assembly.

In some preferred embodiments, a plurality of support wraps are provided across the widthwise direction of the expandable slit sheet. For example, in some preferred embodiments, as shown in, e.g., FIG. 5, two support wraps are provided across the widthwise direction of the expandable slit sheet. In some other embodiments, three or more support wraps can be provided within the widthwise direction of the expandable sheet. Alternatively, in some embodiments, a single support wrap can be provided across the widthwise direction of the expandable sheet. Moreover, in some embodiments, on average, less than one support wrap can be applied per across the widthwise direction of the expandable sheet (such as, e.g., in some variations of the embodiment in FIG. 6 in which the support wrap can be spread out more widely around the periphery of the pallet assembly).

Although FIG. 5 depicts an illustrative pallet wrap supply unit 200 in which the expandable slit sheet paper 510 is fed at an angle with respect to the support wrap 520, other embodiments can include systems that feed the expandable slit sheet paper 510 and support wrap 520 at either greater respective angles and/or at smaller respective angles. For example, as shown in FIG. 7(A), in some embodiments, the relative angle α between the sheets 510 and 520 can be between about 15-45 degrees, in some examples, and as shown in FIG. 7(B), the relative angle α can be between about 0-10 degrees, in some examples.

As discussed above, in some preferred embodiments, the expandable slit sheet paper is provided from a unique and novel expandable slit sheet paper having unusually high tensile properties, while providing expansion in a lengthwise or machine direction and cushioning in a widthwise direction of the expandable slit sheet paper. These qualities and characteristics are highly advantageous in the wrapping of pallets due to, for example, the shifting of items within the pallet assembly on the pallet during transport and handling, vibration and/or the like. In some preferred embodiments, the expandable slit sheet paper can be made with very unique paper and characteristics as described herein.

In some embodiments, the expandable slit sheet paper is provided by an extensible sheet of paper having a weight of greater than 30#. In some embodiments, the expandable slit sheet paper is provided by an extensible sheet of paper having a weight of greater than 35#. In some embodiments, the expandable slit sheet paper is provided by an extensible sheet of paper having a weight of greater than 40#. In some embodiments, the expandable slit sheet paper is provided by an extensible sheet of paper having a weight of greater than 45#. In some embodiments, the expandable slit sheet paper is provided by an extensible sheet of paper having a weight of greater than 50#. In some embodiments, the expandable slit sheet paper is provided by an extensible sheet of paper having a weight of greater than 55#. In some embodiments, the expandable slit sheet paper is provided by an extensible sheet of paper having a weight of greater than 60#. In some embodiments, the expandable slit sheet paper is provided by an extensible sheet of paper having a weight of greater than 65#. In some embodiments, the expandable slit sheet paper is provided by an extensible sheet of paper having a weight of between about 45 to 70#. In some embodiments, the expandable slit sheet paper is provided by an extensible sheet of paper having a weight of between about 50 to 65#.

In some embodiments, the expandable slit sheet paper used to wrap a pallet assembly (e.g., 10, 10a) faces different functional and structural requirements than a expandable slit sheet paper used to wrap a product that is stored within a package, box or container during shipping. For example, in wrapping such a product that is stored within a package, etc., the main function of the expandable slit sheet paper is cushioning that is applied across the width or thickness of the expanded sheet. On the other hand, in wrapping such a product that is stored within a package, etc., the tensile quality of the expandable slit sheet paper not of significance. Notably, such wrapping of a product that is stored within a package, etc., is often performed by hand, and often involves varied application of tensile stresses, such that at at least some locations, the tensile load applied to the expandable slit sheet paper is considerably lower than that required for maximum expansion or near maximum expansion of the expandable slit sheet paper. Accordingly, in use of expandable slit sheet paper to wrap a product that is stored in a package, etc., the expandable slit sheet paper is frequently not expanded to or near to the full expansion of the expandable slit sheet paper. Moreover, the tensile forces sustained or even capable of being sustained by such prior expandable slit sheet papers were substantially less than that afforded by the preferred embodiments of the present invention. First, some most preferred embodiments of the present invention employ a novel and highly advantages expandable slit sheet paper that includes the present inventor's novel application of extensible paper, which leads to expandable slit sheet paper with high levels of tensile strength. Second, in some preferred embodiments, the present invention employs an extensible paper having a substantially higher weight than the weight of expandable slit sheet papers employed in prior expandable slit sheet papers used in the context of wrapping and protecting products stored in packages, etc.

By way of example, in some embodiments, an expandable slit sheet paper (e.g., 510, 510c) can be employed that is an extensible paper made with paper having a weight of at least about 45# and preferably an extensible paper made with a Kraft paper having such a weight. In some other embodiments, an expandable slit sheet paper (e.g., 510, 510c) can be employed that is an extensible paper made with paper having a weight of at least about 50# and preferably an extensible paper made with a Kraft paper having such a weight. In some other embodiments, an expandable slit sheet paper (e.g., 510, 510c) can be employed that is an extensible paper made with paper having a weight of at least about 55# and preferably an extensible paper made with a Kraft paper having such a weight. In some other embodiments, an expandable slit sheet paper (e.g., 510, 510c) can be employed that is an extensible paper made with paper having a weight of at least about 60# and preferably an extensible paper made with a Kraft paper having such a weight. In some other embodiments, an expandable slit sheet paper (e.g., 510, 510c) can be employed that is an extensible paper made with paper having a weight of at least about 65# and preferably an extensible paper made with a Kraft paper having such a weight. In some other embodiments, an expandable slit sheet paper (e.g., 510, 510c) can be employed that is an extensible paper made with paper having a weight of at least about 70# and preferably an extensible paper made with a Kraft paper having such a weight. In some other embodiments, an expandable slit sheet paper (e.g., 510, 510c) can be employed that is an extensible paper made with paper having a weight of between about 50# to 70# and preferably an extensible paper made with a Kraft paper having such a weight. In some other embodiments, an expandable slit sheet paper (e.g., 510, 510c) can be employed that is an extensible paper made with paper having a weight of between about 55# to 70# and preferably an extensible paper made with a Kraft paper having such a weight.

In some embodiments, an expandable slit sheet paper can be employed that includes slit arrangements according to any of the embodiments of slit sheet paper described herein. Furthermore, in some preferred embodiments, the rows between adjacent slits can be of a reduced size compared to rows employed in wrapping of products placed in packaging, etc., because for wrapping of a pallet, the cushioning quality isn't as significant as tensile strength and stretch quality of the expandable slit sheet paper. That is, the tensile strength and stretching (i.e., due to the expansion of the cells) are of higher importance in the context of wrapping of a pallet assembly. Notably, the row spacing between slits relates to the thickness in the thickness direction of the sheet upon expansion, which, thus, correlates to cushioning provided in the thickness direction.

In some embodiments, the expandable slit sheet paper is wrapped around a pallet assembly (e.g., 10, 10a) while the expandable slit sheet paper is applied at or at close to full expansion throughout the entire wrapping process. In some preferred embodiments, the expandable slit sheet paper is at or close to full expansion at least within about 50% or more of the length of expandable slit sheet material that is wrapped around the pallet assembly. In addition, in some more preferred embodiments, the expandable slit sheet paper is at or close to full expansion at least within about 55% or more of the length of expandable slit sheet material that is wrapped around the pallet assembly. In addition, in some more preferred embodiments, the expandable slit sheet paper is at or close to full expansion at least within about 60% or more of the length of expandable slit sheet material that is wrapped around the pallet assembly. In addition, in some more preferred embodiments, the expandable slit sheet paper is at or close to full expansion at least within about 65% or more of the length of expandable slit sheet material that is wrapped around the pallet assembly. In addition, in some more preferred embodiments, the expandable slit sheet paper is at or close to full expansion at least within about 70% or more of the length of expandable slit sheet material that is wrapped around the pallet assembly. In addition, in some more preferred embodiments, the expandable slit sheet paper is at or close to full expansion at least within about 75% or more of the length of expandable slit sheet material that is wrapped around the pallet assembly. In addition, in some more preferred embodiments, the expandable slit sheet paper is at or close to full expansion at least within about 80% or more of the length of expandable slit sheet material that is wrapped around the pallet assembly. In addition, in some more preferred embodiments, the expandable slit sheet paper is at or close to full expansion at least within about 85% or more of the length of expandable slit sheet material that is wrapped around the pallet assembly. In addition, in some more preferred embodiments, the expandable slit sheet paper is at or close to full expansion at least within about 90% or more of the length of expandable slit sheet material that is wrapped around the pallet assembly. In addition, in some more preferred embodiments, the expandable slit sheet paper is at or close to full expansion at least within about 95% or more of the length of expandable slit sheet material that is wrapped around the pallet assembly.

In some preferred embodiments, the expandable slit sheet material is configured to withstand a maximum load in the machine direction of at least 1.0 pounds per linear inch of the expandable slit sheet paper in a fully expanded state. Towards that end, it is noted that an expandable slit sheet paper is narrowed when expanded from a non-expanded state to a fully expanded state due to the formation of the expanded cells. By way of example, in some preferred embodiments, employing ½ inch long slits and a expandable slit sheet paper having a width in an unexpanded state of about 15.25 inches, upon full expansion, the width of the fully expanded slit sheet paper is reduced to about 11.5 inches. Accordingly, in some preferred embodiments, this 11.5 inches is preferably configured to withstand a maximum load in the machine direction of at least 11.5 pounds (i.e., 1.0 pounds/inch×11.5 inches). In some more preferred embodiments, the expandable slit sheet material is configured to withstand a maximum load in the machine direction of at least 1.1 pounds per linear inch of the expandable slit sheet paper in a fully expanded state. In some more preferred embodiments, the expandable slit sheet material is configured to withstand a maximum load in the machine direction of at least 1.2 pounds per linear inch of the expandable slit sheet paper in a fully expanded state. In some more preferred embodiments, the expandable slit sheet material is configured to withstand a maximum load in the machine direction of at least 1.3 pounds per linear inch of the expandable slit sheet paper in a fully expanded state. In some more preferred embodiments, the expandable slit sheet material is configured to withstand a maximum load in the machine direction of at least 1.4 pounds per linear inch of the expandable slit sheet paper in a fully expanded state. In some more preferred embodiments, the expandable slit sheet material is configured to withstand a maximum load in the machine direction of at least 1.5 pounds per linear inch of the expandable slit sheet paper in a fully expanded state. In some more preferred embodiments, the expandable slit sheet material is configured to withstand a maximum load in the machine direction of at least 1.6 pounds per linear inch of the expandable slit sheet paper in a fully expanded state. In some more preferred embodiments, the expandable slit sheet material is configured to withstand a maximum load in the machine direction of at least 1.7 pounds per linear inch of the expandable slit sheet paper in a fully expanded state. In some more preferred embodiments, the expandable slit sheet material is configured to withstand a maximum load in the machine direction of at least 1.8 pounds per linear inch of the expandable slit sheet paper in a fully expanded state. In some more preferred embodiments, the expandable slit sheet material is configured to withstand a maximum load in the machine direction of at least 1.9 pounds per linear inch of the expandable slit sheet paper in a fully expanded state. In some more preferred embodiments, the expandable slit sheet material is configured to withstand a maximum load in the machine direction of at least 2.0 pounds per linear inch of the expandable slit sheet paper in a fully expanded state. In some more preferred embodiments, the expandable slit sheet material is configured to withstand a maximum load in the machine direction of at least 2.1 pounds per linear inch of the expandable slit sheet paper in a fully expanded state. In some more preferred embodiments, the expandable slit sheet material is configured to withstand a maximum load in the machine direction of at least 2.2 pounds per linear inch of the expandable slit sheet paper in a fully expanded state. In some more preferred embodiments, the expandable slit sheet material is configured to withstand a maximum load in the machine direction of at least 2.3 pounds per linear inch of the expandable slit sheet paper in a fully expanded state. In some more preferred embodiments, the expandable slit sheet material is configured to withstand a maximum load in the machine direction of at least 2.4 pounds per linear inch of the expandable slit sheet paper in a fully expanded state. In some more preferred embodiments, the expandable slit sheet material is configured to withstand a maximum load in the machine direction of at least 2.5 pounds per linear inch of the expandable slit sheet paper in a fully expanded state. In some preferred embodiments, the expandable slit sheet material is configured to withstand a maximum load in the machine direction of between about 1.0 to 2.5 pounds per linear inch of the expandable slit sheet paper in a fully expanded state. In some preferred embodiments, the expandable slit sheet material is configured to withstand a maximum load in the machine direction of between about 1.1 to 2 pounds per linear inch of the expandable slit sheet paper in a fully expanded state. In some preferred embodiments, the expandable slit sheet material is configured to withstand a maximum load in the machine direction of between about 1.2 to 1.75 pounds per linear inch of the expandable slit sheet paper in a fully expanded state.

In some preferred embodiments, the expandable slit sheet material is configured to withstand a maximum load in the machine direction of at least 3.0 pounds per linear inch of the expandable slit sheet paper in a fully expanded state, and, in some further preferred embodiments, the expandable slit sheet material is configured to withstand a maximum load in the machine direction of at least 3.5 pounds per linear inch of the expandable slit sheet paper in a fully expanded state, and, in some further preferred embodiments, the expandable slit sheet material is configured to withstand a maximum load in the machine direction of at least 4.0 pounds per linear inch of the expandable slit sheet paper in a fully expanded state, and, in some further preferred embodiments, the expandable slit sheet material is configured to withstand a maximum load in the machine direction of at least 4.5 pounds per linear inch of the expandable slit sheet paper in a fully expanded state.

In one illustrative example, an expandable slit sheet paper can be provided having a roll in an unexpanded state that is about 15.25 inches wide (i.e., about 11.5 inches wide in an expanded state), made with 50# basis weight white wrap (i.e., wherein white is less strong due to its bleaching process), which has a tensile strength enabling the supporting of about a 15 to 18 pound load (i.e., 15-18 lbs.), or, in some examples, about a 16 pound load.

As discussed above, in some of the more preferred embodiments, a support wrap is used which substantially enhances the tensile load that can be sustained by the pallet wrap of the present invention. Notably, once a layer of expanded slit sheet paper is applied around the pallet assembly, the cushioning provided by the expanded slit sheet paper will provide a cushioning barrier that enables a higher tension to be applied. Notably, a pallet assembly often has irregularities in shape (such as, e.g., related to variations in box sizes and shapes within the pallet assembly on the pallet) and configuration that can lead to tearing of the pallet wrap. However, the expandable slit sheet paper can advantageously provide a barrier cushion that enables the pallet wrap to sustain a greater tensile load without breakage.

In some embodiments, with, for example, a pallet assembly having higher degrees of irregularities in shape (e.g., due to varied box sides and shapes), an initial layer or plural initial layers of expandable slit sheet paper can be applied at a reduced tensile load, and then one or more outer layer of expandable slit sheet paper can be applied at a higher tensile load. Towards that end, the interior layer(s) of expandable slit sheet paper at a reduced tensile load can provide a cushioning barrier that enables a higher tensile load to be borne by the outer layer(s). In some preferred embodiments, the above %'s of expandable slit sheet paper at or near the noted loads can relate to the outer layers rather than the inner layers that are applied to create a cushioning that enables application of such higher tensile loads in the outer layer(s).

In contrast to the preferred expandable slit sheet materials employed in embodiments of the present invention, prior expandable slit sheet materials simply could not sustain the tensile loads and irregularities in pallet assembly shapes and edges and would necessarily have led to failure of the product if applied as a pallet wrap.

In some embodiments, expandable slit sheet papers can be employed having slit patterns according to any of the various embodiments described herein. By way of example, in some embodiments, a slit sheet paper can be employed having 0.5 inch slit lengths, 0.1875 land lengths (i.e., the lengths between slits within the same row), and a row spacing of 0.125 inches (i.e., the distance between adjacent rows of slits), which is similar to some expandable slit sheet papers employed by the present inventor for wrapping of products that are contained within packaging, etc., rather than for wrapping of pallet assemblies.

In some preferred embodiments, the slit pattern employed in the expandable slit sheet paper used for pallet wrapping can be modified from the preceding example. For example, in some embodiments, the slit pattern can include a similar ratio of sizes (i.e., proportional size relationships between slit length, land lengths, and row spacings to that of the preceding example), but with a smaller slit pattern. Notably, a smaller slit pattern can produce a stronger tensile strength having advantageous utility in the context of pallet assembly wrapping.

In some preferred embodiments, a modified slit pattern can include same ratio to that of the preceding example, but reduced in size by 10% or more. In some preferred embodiments, a modified slit pattern can include same ratio to that of the preceding example, but reduced in size by 20% or more. In some more preferred embodiments, a modified slit pattern can include same ratio to that of the preceding example, but reduced in size by 25% or more. In some more preferred embodiments, a modified slit pattern can include same ratio to that of the preceding example, but reduced in size by 30% or more. In some more preferred embodiments, a modified slit pattern can include same ratio to that of the preceding example, but reduced in size by 35% or more. In some more preferred embodiments, a modified slit pattern can include same ratio to that of the preceding example, but reduced in size by 40% or more. In some more preferred embodiments, a modified slit pattern can include same ratio to that of the preceding example, but reduced in size by 45% or more. In some more preferred embodiments, a modified slit pattern can include same ratio to that of the preceding example, but reduced in size by 50% or more. In some more preferred embodiments, a modified slit pattern can include same ratio to that of the preceding example, but reduced in size by 55% or more. In some more preferred embodiments, a modified slit pattern can include same ratio to that of the preceding example, but reduced in size by 60% or even more. In one specific illustrative example, a slit pattern would include the same ratios as the first example, but reduced such as to be 49% smaller in all dimensions.

Among other things, having a reduced size can advantageously improve tensile qualities of the wrap material, and can also reduce the overall thickness added around the periphery of the wrapped pallet assembly, whereby valuable cargo space and transportation requirements can be further minimized.

In some embodiments, a smaller slit pattern can provide stronger tensile strengths due to increased number of legs per inch. Additionally, in some embodiments, stronger tensile strengths can be achieved by reducing the slit to land ratio. For example, in some embodiments, the slit to land ratio can be reduced by 5% or more, or in some embodiments by 10% or more, or in some embodiments by 15% or even more. In various embodiments, depending on the particular application (e.g., based on characteristics of the pallet assemblies being wrapped), appropriate ratio can be set for desired stretch/tension characteristics. For example, as increased stretch facilitates wrapping of uneven surfaces, in circumstances in which the pallet assembly contains more uneven or irregular surfaces, the slit patterns can be appropriately selected.

In some other preferred embodiments, an expandable slit sheet paper employed as a pallet assembly wrap can alternatively have a larger slit pattern that is similar to that of the foregoing example (i.e., of a 0.5 inch slit lengths, 0.1875 inch land lengths, and 0.125 inch row spaces) or even larger than such foregoing example. For example, in some contexts, such a use of a larger slit pattern can be provided to provide a better cushioning in some contexts, where desired. In some embodiments, a modified slit pattern can include same ratio to that of the above-noted foregoing example, but increased by 10% or more, or, even increased by 20% or more, or, in some examples, increased by 30% or more, or, in some examples, increased by 40% or more, or, in some examples, increased by 50% or even more.

In some other embodiments, a pallet wrap (e.g., 510, 510a) can be provided that includes plural types of expandable slit sheet paper materials that are employed. For example, in some embodiments, the plural types of expandable slit sheet material can include expandable slit sheet materials having different slit patterns. For example, in some embodiments, a first expandable slit sheet material can be provided having one of the above-noted smaller slit pattern sizes to provide increased tensile qualities, while a second expandable slit sheet material can be provided having one of the above-noted larger slit pattern sizes to provide increased cushioning qualities. In some preferred embodiments, the smaller slit pattern sizes can be employed as a layer underneath the larger slit pattern sizes. However, in some other embodiments, the smaller slit pattern sizes can be employed as a layer above the larger slit pattern sizes. However, in some other embodiments, the layers can be intermixed with the smaller slit pattern sizes being underneath some portions and above other portions of the larger pattern sizes.

In some examples, the supply unit (e.g., 200, 200a) can be modified to supply two (or more) different types of expandable slit sheet paper together in tandem as a double feed (or more), one on top of the other.

In some other examples, double or triple feeding (or more) of expandable slit sheet paper in tandem can also advantageously increase supply rate and, hence, reduce time for wrapping of the pallet assembly and pallet. Moreover, such double or triple feeding (or more) can also facilitate more securely wrapping of a pallet assembly and pallet. Accordingly, in some embodiments, even expandable slit sheet paper of the same type can be double or triple fed so as to achieve such timing and/or other advantages related to such an in-tandem feeding.

In some embodiments, in addition to the pallet wrap (e.g., 500, 500a), an additional accessory sheet can be provided that is supplied as a banner that is configured to be wrapped fully one time around the pallet assembly for providing of labels (e.g., load tags, bar codes and the like). For example, as shown in FIG. 10, in some embodiments a banner sheet 610 can be wrapped fully around the pallet and adhered together to be retained similarly to a ribbon around a wrapped present. In some embodiments, the banner 610 can be made with an accessory sheet of recyclable paper. In some illustrative and non-limiting examples, the banner can have a width of about 12 inches. Additionally, in some embodiments, such a banner can be used to additionally or alternatively to further stabilize the pallet assembly. In some embodiments, a plurality of banners 610 can be supplied, to even further stabilize the pallet assembly.

In some further embodiments, the supply unit (e.g., 200, 200a) can be modified to additionally attach a sheet to the periphery of the pallet assembly, wherein the sheet can be provided to provide load tag placement and/or other information such as, e.g., bar codes. In some embodiments, such a sheet can be a common 8½″×11″ sheet of paper. Alternatively, in other embodiments, the sheet of paper can have other sizes. In some embodiments, the supply unit can include a sheet dispenser that adheres the sheet to a portion of the unwinding roll (e.g., 210, 210a) of expandable slit sheet paper, just prior to stretching while the unexpanded paper is still on the roll itself. The sheet can include an adhesive such as to fixedly adhere to the expandable slit sheet paper. This placement would inhibit stretching of the expandable slit sheet paper within the region of the sheet. However, in this manner, such a sheet can be readily applied to the side of the pallet assembly. Moreover, the small region of unexpanded sheet would not significantly interfere with the operation of the device. In the preferred embodiments, a user can control placement of the sheet via the controller (e.g., 300), whereby the sheet can be programmed to be placed at a particular location on the periphery of the pallet assembly, taking into consideration the vertical position of the roll (e.g., 210, 210a) and the distance to the desired location alongside the pallet assembly. Additionally, in some embodiments, a plurality of such papers or sheets can be attached to one or more sides of the pallet assembly.

Although the embodiments shown in FIGS. 5 and 6 are configured to impart relative movement between the pallet assembly (e.g., 10, 10a) and the pallet wrap supplying rolls (e.g., 210, 210a, 220, 220b) by causing the pallet assembly to be rotated in relation to a fixedly located supply unit 200, in some alternative embodiments the pallet assembly can be fixedly located and not rotated, while the supplying rolls are configured to be moved relative to the fixedly located pallet assembly. In particular, various embodiments can be provided that establish different forms of relative movement between the supplying rolls and the periphery of the pallet assembly. For example, in the embodiment schematically shown in FIG. 11, a fixedly located pallet assembly 10b (which is supported on a fixedly located pallet (not shown) is provided, and a supply unit is provided that includes a conveyor member 200bT that is configured to support at least one roll of expandable slit sheet paper 210b that is reciprocated along at least one shaft 200bS1 and at least one support wrap roll 220b that is reciprocated along at least one shaft 200bS2 in a manner such that the roll(s) 210b and the roll(s) 220b are caused to follow a circular path around the periphery of the fixedly located pallet assembly 10b. Among other things, in this manner, an operator of the equipment can handle or manage the pallet and pallet assembly while the pallet and pallet assembly are in a fixed position. Although the embodiment shown in FIG. 11 shows a substantially circular track for the conveyor mechanism 200bT, whereby the roll(s) 210b and the roll(s) 220b are caused to follow a circular path around the periphery of the fixedly located pallet assembly 10b, in some alternative embodiments, the track 200bT can be configured to following a rectangular or square path, whereby the roll(s) 210b and the roll(s) 220b are caused to follow a rectangular or square path around the periphery of the fixedly located pallet assembly 10b, which path can, e.g., thus, maintain the roll(s) 210b and the roll(s) 220b at locations closer to the periphery of the pallet assembly 10b during operation. Moreover, in some embodiments, the roll(s) 210b can be supported in a manner so as to be independently movable relative to the roll(s) 220b, such that enhanced control can be achieved in relation to the relative wrapping rates and the like applied by the system.

### Illustrative Expandable Slit Sheet Materials Employed in Some Preferred Embodiments

As discussed above, in the preferred embodiments, a novel expandable slit sheet material product is preferable employed to wrap pallet assemblies. In the preferred embodiments, the present invention advantageously combines novel paper properties with novel slit patterns for improved features and characteristics.

In the preferred embodiments, an expandable paper is provided that employs an improved slit arrangement that was unviable with prior expanded slit paper products, including a compacted slit pattern with, e.g., reduced slit lengths and reduced row spacings, along with the use of a novel extensible paper.

In accordance with some embodiments of the invention, a novel slit pattern is capable of being created that provides more cells per square foot and achieves, e.g., a greater crush resistance and resiliency for cushioning.

In some preferred embodiments, the slit paper pattern of slits advantageously has slits in the range from 0.30 to 0.45 inches (i.e., in the lengthwise dimension of the slits) and spaces between rows in the range from 0.1125 to 0.1688 inches (i.e., the distance between adjacent rows of slits). Most preferably, these embodiments are made from an extensible paper.

In some preferred embodiments, the slit paper has slits wherein the slit width is 0.45 inches plus 5%, minus 33% (i.e., here the slit width refers to the lengthwise dimension of the slits). Most preferably, again, these embodiments are also made from an extensible paper.

In some preferred embodiments, the slit pattern advantageously produces an expandable slit paper having a number of legs per square foot that is at least 20% greater than slit paper having slit (cut) widths of 0.5 inches.

In some preferred embodiments, an expanded slit paper cushioning product of the present invention has a number of legs per square foot that is at least 15% greater than slit paper that has slit (cut) widths of 0.5 inches. In some preferred embodiments, an expanded slit paper cushioning product of the present invention has such a number of legs per square foot that is in the range from 20% to 50% greater than that of slit paper having slit (cut) widths of 0.5 inches, and, in some embodiments that is in a range of more than 50% greater than that of slit paper having slit (cut) widths of 0.5 inches.

With the present invention, expanded slit sheets can be created having greatly improved cushioning characteristics. In some embodiments of the present invention, the improvement in cushioning characteristics can be achieved due to one or more, or all, of the following:

a) In the preferred embodiments, the use of an extensible paper enables an “easier opening” structure, which enables the creation of smaller cells, whereby the smaller cells advantageously lead to the formation of increased cell density and, hence, improved cushioning characteristics.

b) In some preferred embodiments, the use of an extensible paper enables the achievement of a novel “alternating row expansion pattern” which has substantially improved cushioning characteristics over prior expansion patterns (see discussion regarding novel alternating row expansion pattern below in this document).

Additionally, with the present invention, novel and previously-unviable pallet wrapping products can be created.

### Illustrative Extensible Paper Employed in Some Preferred Embodiments

In some most preferred embodiments, extensible papers as set forth in the above-referenced U.S. Pat. No. 10,669,086 are employed. Towards that end, the following paragraphs (in quotations) under this section, quoted from the '086 patent, set forth details of extensible papers according to some preferred embodiments that can be employed in preferred embodiments of the present invention.

“For the purposes of the present invention, the term “extensible” as applied to paper sheets, means a paper sheet that is able to stretch in a longitudinal direction of the paper sheet upon applying a force in the longitudinal direction of the paper sheet. Illustrative extensible sheets are disclosed in U.S. Pat. No. 3,908,071, U.S. patent application Ser. No. 14/901,997 (U.S. Pat. No. 9,945,077), International Application No. WO 1984002936, U.S. Publication Nos. 2002/0060034, 2007/0240841 (U.S. Pat. No. 7,918,966), and U.S. Pat. Nos. 3,104,197, 3,220,116, 3,266,972, 3,269,393, 3,908,071, 6,024,832, 6,458,447, and 6,712,930, the entire disclosures of which are incorporated by reference herein, as though recited in full. It should be understood that the stretching of an extensible paper is measured in an unslit sheet of paper (i.e., the %'s of extensibility or ranges or extents of extensibility defined herein are based on unslit paper). As disclosed in U.S. Pat. No. 3,266,972, the test and characterization procedures employed in measuring elongation (extensibility) properties can be in accordance with standard TAPPI test Elongation T457. In addition, as disclosed in U.S. Pat. No. 3,266,972, the expression “extensible papers” means a paper having an increasable elongation in the machine direction as compared to standard, non-extensible Kraft paper.”

“In some preferred embodiments, extensible paper can be produced by varying the accumulation of paper fibers by essentially slowing the paper feeding process during the drying method to trap extra fibers that make the paper appear to have microscopically sized rows of paper that you would see if one were to pleat the paper. The difference is that extensible paper's microscopic rows are adhered to each other through the use of binders and other types of adhesives in conjunction with the drying process. Reference is made to patent U.S. Application No. 2007/0240841 (U.S. Pat. No. 7,918,966) where the purpose is to create a non-creped extensible paper that does not easily disconnect from itself. In addition, the surface of the extensible paper is still fairly flat.”

“In the preferred embodiments of the present invention, the extensible paper that is employed has low extensible properties as compared to other types of extensible papers. In this regard, an optimal extensible paper enables a smooth transition from an unexpanded to the expanded slit sheet by providing a small amount of stretching at the very start of expansion of the extensible slit sheet paper material.”

“In some exemplary constructions, during expansion of a slit sheet, the force required to initiate expansion is substantially higher than the force required to continue expansion. For example, once the paper initially starts to bend at the slits, the expansion continues more easily during continued bending at the slits. The force required to continue the expansion of the slit sheet during this continued bending is dramatically reduced beyond the above-noted initial expansion. In some preferred embodiments, the extensible slit sheet paper substantially reduces the force required to initiate expansion. On the other hand, in some preferred embodiments, during the above-noted continued expansion, the extensible paper does not substantially stretch simultaneously with the process of expanding the slit sheet paper; otherwise, the expanded sheet might not optimally be made into a cushioning wrap.”

“It should be noted that in this application, all theories related to functioning of the invention are provided to facilitate appreciation of concepts of the invention, rather than by way of limitation. Extensible paper, as designed, stretches as part of an increase in paper strength. In some embodiments, the functioning of the invention involves that the extensible slit sheet paper substantially utilizes the extensible property to ease the rotating the cells into the stretched shape and to resist tearing of the slit sheet during the expansion step. This means that at the initial point at which the cell rotates (i.e., initiating rotation between legs 38a and 38b on each side of the slit and land 20) the extensible slit sheet paper is substantially enhanced by the extensible paper's ability to stretch. In some embodiments, the functioning of the invention, thus, involves that extensible papers' properties are substantially utilized at this initial point and substantially finished as soon as the cell begins to rotate into its three-dimensional shape (i.e., after this initial point, the reliance on the extensible nature of the paper may be less substantial or even non-existent). After that initial point, the slit pattern properties, regardless of paper type, opens with greater ease to the point at which it forms a hexagon. Accordingly, in some embodiments, the extensible property substantially merely comes into play at the initial moment of expansion. In some other embodiments, while the extensible features of the paper comes into play most substantially at this initial point of rotation, the extensible features of the paper can have some affect during further expansion of the paper, whereby the initial point of expansion can be substantially facilitated due to extensibility and further expansion can also be, at least, somewhat facilitated due to extensibility.”

“In some of the preferred embodiments, preferable extensible papers that can be employed include extensible papers where the purpose of the extensible nature is to provide the type of stretching found for the use of multi-wall bags for heavy weight items like cement, or seed and the like. U.S. Patent Publication No. 2016/0355985 (U.S. application Ser. No. 14/901,997) and U.S. Pat. Nos. 3,104,197 and 3,266,972 teach the manufacture and properties of this form of extensible paper. Further teachings can be found in “Understanding sheet extensibility”, R. S. Seth, Pulp & Paper Canada T31, 106:2 (2005) III, pages 33-40 (T31-T38). The disclosures of the foregoing patents, patent publication, and printed publication are incorporated herein by reference, as though recited in full.”

“The prior expanded slit sheet art (See, e.g., U.S. Pat. Nos. 5,538,778, 5,667,871, 5,688,578, and 5,782,735) focused on paper strength to inhibit tearing during the expansion process and Kraft paper was satisfactory because the strength required coincided with the thickness required to make a satisfactory wrapping product. The increased strength of an expandable sheet does not contribute to or increase the value/performance of the expansion of the slit sheet material. It has now been found by the present inventor that an expandable slit sheet paper can be substantially improved by the use of an extensible sheet. In the preferred embodiments, this use of an extensible slit sheet paper advantageously provides a reduction in force required to open the slit sheet and therefore provides a faster and easier expanding process for the user of the expanded slit sheet. The unexpected benefit resulting from the reduction in force at the very start of the expansion of the slit sheet provides an unexpected improvement to the slit sheet packaging product and renders the employment of the extensible paper highly unique. Notably, the prior expanded slit sheet paper persisted in and was widely used in the marketplace for decades without the contemplation of the present invention or the potential advantages therefrom.”

“As set forth in this application, the present inventor has discovered that the force needed to expand an expandable slit sheet paper is far greater than the force required to expand an extensible slit sheet paper. By way of example, a 50 pound Kraft paper expandable slit sheet that is 15″ wide prior to expansion requires approximately 4-6 pounds or 0.4 pounds per inch, whereas the force required to expand an extensible slit sheet of the same paper weight is 0.15-0.22 pounds per inch. This is a marked difference between the papers. Kraft paper has the strength to provide an acceptable expandable slit sheet. However, unexpectedly, the extensible slit sheet imparts an ease of expansion that greatly reduces the force required to expand the slit sheet, not based on the main purpose for extensible paper which is to increase its tensile strength but, rather, its capability to stretch. Since extensible paper is higher in cost and Kraft paper was strong enough, it was not previously known that extensible paper could be of benefit for making slit paper sheets of the types found in, e.g., U.S. Pat. Nos. 5,538,778, 5,667,871, 5,688,578, and 5,782,735, and U.S. Non-Provisional application Ser. No. 15/428,144. For example, it was not appreciated that an extensible slit sheet could have provided an equivalent strength to light weight, thin papers that previously had no applicability as a wrapping product. Light weight Kraft paper tears more easily than heavier weights of Kraft paper. It has now been found that the extensible paper enables the use of the lighter weight expanded slit-sheet papers that also advantageously provide gentler cushioning required by fragile items when a slit sheet is expanded, in contrast to the more rigid cushioning provided by heavier weight expanded slit-sheet papers.”

“Reference is particularly made to the graph of Table 1 on page 5 of U.S. Patent Publication No. 2016/0355985 (now U.S. Pat. No. 9,945,077) as if recited in full, that describes paper strength based on certain manufacturing techniques. Within the graph is a column describing elongation at the point of paper break (or tearing of fibers) separated into two sub columns of the machine direction (MD) and cross direction (CD), also referred to as transverse direction. The elongation percentage of Table 1 ranges from 5.3% to 7.1% in the cross direction (CD) and 3.3% to 10.6% in the machine direction (MD).”

“Reference is also made to U.S. Pat. No. 3,266,972 within Table III of column 5 which references elongation in the percentage range from 3.7% to 4.6% in the CD or cross direction and 9.7% to 11.1% in the machine direction.”

“In both '985 and '972, the variations are based on the manufacturing process that places an emphasis on tensile strength and stretch in either the cross direction or machine direction accordingly.”

“The present inventor has discovered that for the purposes of expanding an extensible slit sheet paper for use as a packaging wrap and/or void fill, machine direction extensible ranges from 1%-9% provide an adequate extensibility, with 1% to 6% preferred, and 1% to 4% most highly preferred. The lower the extensibility coincides with lower costs of the paper per square foot. As indicated above, it should be understood that extensibility is measured on unslit paper.”

“In some alternative embodiments, machine direction extensibility ranges of the extendible slit sheet paper can have ranges of:
a) from 1.5%-9%, or more preferably from 1.5% to 6% preferred, or even more preferably from 1.5% to 4%; or
b) from 2%-9%, or more preferably from 2% to 6% preferred, or even more preferably from 2% to 4%; or
c) from 3%-9%, or more preferably from 3% to 6% preferred, or even more preferably from 3% to 4%.”

“For the purposes of expanding the slit sheet paper for use as a packaging wrap and/or void fill, it has been found that cross direction extensible ranges from 1%-5% provides an adequate extensibility with 1% to 4% preferred, and 1% to 3% most highly preferred.”

“In some alternative embodiments, cross direction extensibility ranges of the extendible slit sheet paper can have ranges of: a) from 1.5%-5%, or more preferably from 1.5% to 4%, or even more preferably from 1.5% to 3%; or b) from 2%-5%, or more preferably from 2% to 4%, or even more preferably from 2% to 3%.”

“In combination with the extensible paper, a smaller, lighter weight, and recyclable version of an expander can be employed (such as, e.g., made entirely or substantially entirely with recyclable cardboard in some illustrative embodiments). This expands the market to customers that use a very small amount of wrap as compared to the industrial market. It also provides for a less expensive expansion device to be employed for expanding the slit paper. Additionally, it enhances the ease of use by the packer by providing for less ripping during the wrapping process that occurs when the tension is not properly set. This occurs as the roll, during its continued use, becomes smaller and lighter in weight. As the roll of expanded slit sheet becomes lighter the tension required increases. Thus, there need for a varying tensioning method. With the use of the extensible paper, the tension required is significantly decreased and the strength of the paper is increased. Both benefit the person wrapping by making the tensioning required much less precise to the point at which, a single tension setting can be used with little or no adjustment. If the tension is set higher than necessary, the increase in strength from the extensible paper keeps the product from tearing and therefore makes it easier for the packer to use. Therefore, the packer can make fewer adjustments as the slit sheet roll becomes smaller and smaller.”

“The reduction in the force required to expand the slit paper enables a new product to be created using lighter weight papers. In the past, expanded slit sheet paper is primarily used as a wrapping product whereas its use as a void fill would be in limited circumstances due to void fill being typically the cheapest, that is, the lowest cost of all packaging products. The increased strength of the extensible sheet enables the use of a thinner and lighter weight slit sheet paper as a void fill product. If the expanded slit sheet is not being used as a wrap, then the thicker 0.005″, 50 pounds per 3,000 square feet paper and above is not required and a lighter weight 0.003-0.0045″ thick, 30-40 pounds per 3,000 square feet paper can be used as void fill. It can also be used to provide cushioning that other paper void fill products have not been able to provide. It has now been found that even though the extensible paper has a 10% higher price, the use of a thinner paper provides much more square footage per ton and more than compensates for the increased cost of the extensible paper as compared to Kraft paper.”

The following pages under this section describe other illustrative extensible slit sheet papers in the art from other publications and patents that can be employed within some embodiments of the present invention. Towards that end, it should be understood and appreciated that some embodiments of the present invention can employ expandable slit sheet paper as a pallet wrap using any-and-all of extensible papers as described in the following pages, including ranges of extensibility and other aspects.

“Detailed Descriptions of Technologies Employed in the Present Invention Quoted from Disclosures that are Incorporated by Reference”

“The Following are Citations from Clupak's paper patent (U.S. Pat. No. 9,945,077):”

### “Example 1:

Heavy-duty Clupak paper having a basis weight of 84.9 g/m² was made using a gap-former paper-making machine equipped with a Clupak system, at a paper-making speed of 480 m/min and using, as material, 100% unbleached softwood Kraft pulp that had been beaten at high concentration of 28%. The negative draw on the Clupak was set to −4.5%.”

### “Example 2:

Heavy-duty Clupak paper was made in the same manner as in Example 1, except that the paper had a basis weight of 76.1 g/m² and the negative draw on the Clupak was set to −6.0%.”

### “Example 3:

Heavy-duty Clupak paper was made in the same manner as in Example 1, except that the paper had a basis weight of 73.4 g/m² and the negative draw on the Clupak was set to −4.0%.”

### “Example 4:

Heavy-duty Clupak paper was made in the same manner as in Example 1, except that the paper had a basis weight of 85.0 g/m², the negative draw on the Clupak was set to −4.0%, and the pulp blend consisted of 90% unbleached softwood Kraft pulp and 10% unbleached hardwood Kraft pulp.”

### “Comparative Example 1:

Heavy-duty Clupak paper was made in the same manner as in Example 1, except that the paper had a basis weight of 71.9 g/m² and the negative draw on the Clupak was set to −10.0%.”

### “Comparative Example 2:

Heavy-duty Clupak paper was made in the same manner as in Example 1, except that the paper had a basis weight of 85.4 g/m² and the negative draw on the Clupak was set to −1.0%.”

### “Comparative Example 3:

Heavy-duty Kraft paper was made in the same manner as in Example 1, except that the paper had a basis weight of 76.0 g/m² and the Clupak process was not performed.”

TABLE 1

| | | | | | | | | | | | | | | | | | | Breaking |
|---|---|---|---|---|---|---|---|---|---|---|---|---|---|---|---|---|---|---|
| | | | | | | | | | | | | | Tensile | | | | | after |
| | | Clupak | | Paper | | Air | Tensile | | Elongation | | TEA | | stiffness | | Tear | | | processsed |
| | | negative | Basis | thick- | Den- | resis- | index | | at break | | index | | index | | index | | | into |
| | | draw | weight | ness | sity | tance | Nm/g | | % | | J/g | | kNm/g | | mN · m²/g | | Forma- | heavy- |
| | | % | g/m² | μm | g/cm³ | sec | MD | CD | MD | CD | MD | CD | MD | CD | MD | CD | tion | duty sack |
| Examples | 1 | −4.5 | 84.9 | 121 | 0.70 | 14 | 88.1 | 31.3 | 7.0 | 7.1 | 3.55 | 1.55 | 5.62 | 3.64 | 12.8 | 28.9 | ◯ | ◯ |
| | 2 | −6.0 | 76.1 | 118 | 0.65 | 12 | 69.5 | 33.0 | 8.1 | 5.8 | 3.22 | 1.47 | 4.18 | 3.07 | 19.7 | 25.8 | ◯ | ◯ |
| | 3 | −4.0 | 73.4 | 110 | 0.67 | 13 | 72.5 | 30.1 | 6.0 | 6.0 | 2.60 | 1.17 | 4.95 | 3.43 | 14.9 | 20.3 | ◯ | ◯ |
| | 4 | −4.0 | 85.0 | 129 | 0.66 | 13 | 83.3 | 39.4 | 7.4 | 6.3 | 3.47 | 1.51 | 5.33 | 3.44 | 13.1 | 25.5 | ⊚ | ◯ |
| Compar- | 1 | −10.0 | 71.9 | 112 | 0.64 | 12 | 52.0 | 28.0 | 10.6 | 5.3 | 3.47 | 1.02 | 3.09 | 3.14 | 19.7 | 27.1 | ◯ | X |
| ative | 2 | −1.0 | 85.4 | 130 | 0.66 | 15 | 85.0 | 32.1 | 3.7 | 6.7 | 1.99 | 1.49 | 7.12 | 3.70 | 16.3 | 20.4 | ◯ | X |
| Examples | 3 | Not | 76.0 | 119 | 0.64 | 18 | 92.1 | 35.5 | 3.3 | 5.4 | 1.89 | 1.49 | 8.92 | 3.85 | 19.1 | 24.9 | ◯ | ◯ |
| | | used | | | | | | | | | | | | | | | | |

“Evaluation Methods:
(Measurement of Tensile Energy Absorption Index)
Measured by the method specified in JIS P8113: 2006.
(Measurement of Breaking Elongation)
Measured by the method specified in JIS P8113: 2006.
(Measurement of Tear Index)
Measured by the method specified in JIS P8116: 2000.
(Measurement of Burst Index)
Measured by the method specified in JIS P8112: 2008.
(Measurement of Tensile Stiffness Index)
Measured by the method specified in ISO/DIS 1924-3.

(Measurement of Freeness after Disintegration)
Measured by the method specified in JIS P8220: 1998 and JIS P8121: 1995.”

“Looking at the properties of the Clupak papers in Examples 1 to 4 and Comparative Examples 1 and 2 as well as those of the Kraft paper in Comparative Example 3, as shown in Table 1, the Clupak papers described in Examples 1 to 4 exhibit a good balance of various strengths and elongation and have excellent strength overall; on the other hand, the Clupak papers described in Comparative Examples 1 and 2 and Kraft paper described in Comparative Example 3 exhibit a poor balance of various strengths and elongation and cannot be said to have excellent strength overall.”

“The following are Citations from “Understanding Sheet Extensibility”, R. S. Seth, (Pulp and Paper Research Institute of Canada 3800 Wesbrook Mall Vancouver, BC, Canada V6S 2L9) Pulp & Paper Canada T31, 106:2 (2005) III, pages 33-40 (T31-T38):

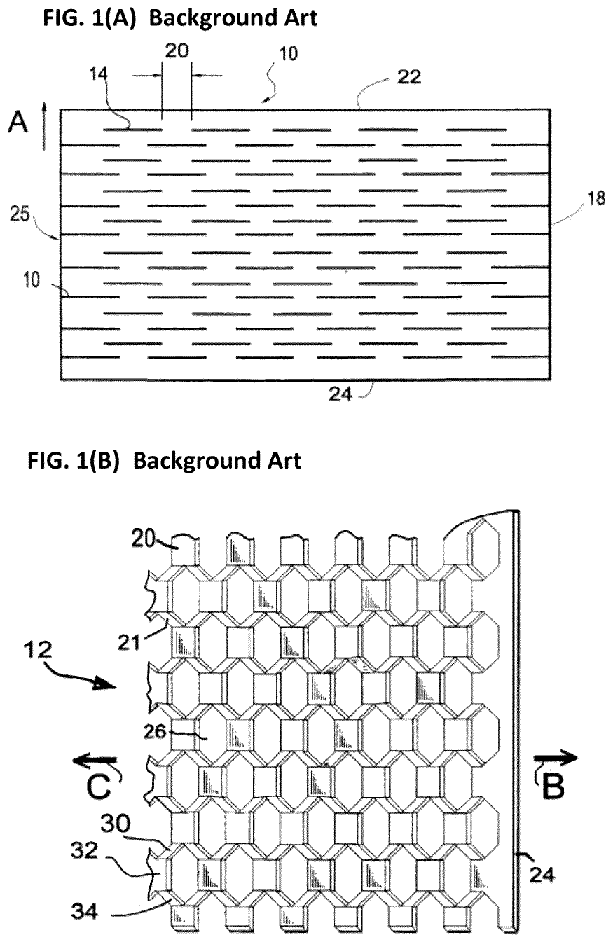

Tensile strength and extensibility or stretch are two important failure properties of paper. They are defined by the end-point of the sheet's load-elongation curve (FIG. 1). Individually and together, they are important for many product performance properties. For example, TEA, the tensile energy absorbed by the sheet before failure is proportional to the area under the load-elongation curve. Thus, it depends on both the tensile strength and extensibility of the sheet. A high TEA is desired in sack papers [1]. The bursting strength of paper has been shown to be proportional to the product of tensile strength and the square-root of stretch [2]. The fracture toughness of paper has been found to depend strongly on the sheet's tensile strength and stretch [3, 4]. Sheet stretch has also been regarded as important for paper runnability both at the paper machine's dry-end and in the pressroom [5-8]. Papers with high stretch also seem to have a somewhat higher tearing resistance [9], and folding endurance; they are found to be more dimensionally unstable as well [10]. The factors that control sheet tensile strength are fairly well understood [4]. The tensile strength is high if fibres are strong, long, fine and thin-walled. The fibres should be conformable and have a high fibre-fibre bond strength. The sheet tensile strength is also high if fibres are straight, free from deformations and the sheets are well formed. Otherwise, the stress is unevenly distributed when the sheet is strained, leading to premature failure.”

“This report deals with the factors that control sheet stretch.”

“Factors that Control Sheet Stretch:

A specimen under tensile load extends more, the longer it is. Therefore, extensibility or stretch or strain at failure as a material property, is expressed as a percentage of the original specimen length (FIG. 1).”

“Role of bonding:

Regardless of how bonding between the fibres is increased—by wet pressing, beating or refining, or additives, the sheet stretch of a furnish generally increases with increased fibre-fibre bonding. This is observed for almost all papermaking fibres—chemical, mechanical, wood, non-wood, or recycled. The reasons are as follows. Fibres have a certain “stretch-potential”. However, this potential is realized in paper only when fibres form a bonded network. If the bonding is weak, the network fails before the stretch-potential is realized; the sheet stretch is low. As bonding in the network is increased, the stretch-potential of fibres is increasingly realized, the sheet stretch increases. Since increased inter-fibre bonding also increases sheet tensile strength, an increase in stretch with tensile strength is often observed for handsheets (FIG. 2). The stronger the sheet, the more the fibres' stretch-potential is utilized. Because of this relationship between tensile strength and stretch, factors such as sheet grammage or formation that tend to affect tensile strength also affect sheet stretch [11]. A comparison of handsheet stretch values at similar tensile strengths provides a meaningful comparison of the stretch-potential of various furnishes.”

“The Following are Citations from Trani et al.'s Extensible Paper Patent (U.S. Pat. No. 7,918,966) [also, Published as U.S. Application No. 2007/0240841]:”

“Extensible paper is a known paper which, because of special treatment during its production, presents considerable extensibility both in the longitudinal direction (i.e. in the direction of its advancement along the production line) and in the transverse direction (i.e. in the direction perpendicular to the preceding). This treatment consists essentially of passing the paper web not yet formed and presenting a moisture content of about 35%/45% between two rollers rotating at different speeds. One of these rollers, generally the lower roller, is made of rubber and is rotated at lower speed, while the upper roller is made of steel and comprises in its cylindrical surface a continuous spiral-shaped groove. The different material nature and the different speed of the two rollers results in a sort of longitudinal accumulation of the paper forming material and prepares it for longitudinal extensibility, by an amount which can reach 15-20%. At the same time, the spiral groove performs a double function: on the one hand it causes a sort of transverse accumulation of the material forming the paper to prepare it for transverse extensibility. By an amount which can reach 10-15%. On the other band the spiral groove contributes to maintaining longitudinal advancement of the processed paper web along the machine.”

“The Following are Citations from Cabell et al.'s Extensible Paper Web Patent (U.S. Pat. No. 6,458,447):”

### “Tensile and Percent Stretch Test:

The tensile test is used for measuring force versus percent elongation properties. The tests are performed on a Thwing Albert Intellect II-STD Model No. 1451-24PGB, available from the Thwing-Albert Co. of Philadelphia, Pa.”

“The samples used for this test are 1″ wide×6″ long with the long axis of the sample cut parallel to the direction of maximum extensibility of the sample. The sample should be cut With a sharp Exacto knife or some suitably sharp cutting device design to cut a precise 1″ wide sample. (If there is more than one direction of extensibility of the material, samples should be taken parallel to representative direction of elongation). The sample should be cut so that an area representative of the symmetry of the overall pattern of the deformed region is represented. There will be cases (due to variations in either the size of the deformed portion or the relative geometries of regions 1 and 2) in which it will be necessary to cut either larger or smaller samples than is suggested herein. In this case, it is very important to note (along with any data reported) the size of the sample, which area of the deformed region it was taken from and preferably include a schematic of the representative area used for the sample. Three samples of a given material are tested.”

“The Following are Citations from Cramer et al.'s Extensible Paper Patent (U.S. Pat. No. 3,266,972):”

### “Test and Characterization Procedures:

The test and characterization procedures employed in measuring various properties reported herein are listed in Table I below. Unless otherwise indicated the code letter numerals indicate standard TAPPI tests.”

### “Elongation T457:

By the expression “extensible papers” is meant a paper having an increased elongation (generally a minimum of about 6%) in the machine direction.

In runs IA and IB of this example, rosin size (0.3% by weight based on the weight of pI up) is added at the beater and the pH is adjusted to 4.5 with alum. The stock, having a consistency of 3.6% is dropped to the beater chest and is then pumped to a second chest, passed through a Jordan and continuously diluted with “white water” at the Fourdrinier headbox to a consistency of 0.3%. Properties measured on the various papers is reported in Table III. Each paper has a basis weight of from 49.4 to 50.3 pounds per ream.”

TABLE III

| Property | | 1A | 1B | 1C | 1D |
|---|---|---|---|---|---|
| Tensile (lbs./in.) - - - | MD | 15.6 | 16.0 | 18.2 | 22.4 |
| | CD | 12.6 | 13.0 | 14.3 | 15.4 |
| Elongation (percent) - - - | MD | 10.1 | 11.2 | 9.9 | 9.7 |
| | CD | 3.7 | 4.3 | 4.4 | 4.6 |
| Work-to-break | MD | 1.01 | 1.05 | 1.14 | 1.34 |
| (in.-lbs./in.²) - - - | CD | 0.34 | 0.41 | 0.47 | 0.50 |
| MIT Fold - - - | MD | 380 | 398 | 496 | 1,021 |
| | CD | 106 | 94 | 132 | 167 |
| CSI Abrasion | MD | 14 | | 20 | 25 |
| (cycles) - - - | CD | 7 | | 37 | 64 |

“The Following are Citations from Trani et al.'s Multilayer Paper Material Patent (U.S. Pat. No. 8,518,522):”

“These and other objects which will be apparent from the ensuing description are attained according to the invention by a multilayer papery material comprising at least one first three dimensional structure sheet exhibiting reliefs having maximum sizes which are lower than the width of the original sheet, said reliefs being obtained through localized stretching of said first sheet which has an original degree of extensibility of not less than 5% in all the directions, and at least one second sheet made of papery material coupled to said first structure sheet and defining empty spaces with the reliefs thereof.”

“As it can be seen from the figures, in the embodiment shown in FIG. 1 the multilayer material of the invention consists of two layers 2, 4 of paper presenting extensibility characteristics of not less than 5% both in a longitudinal and in a transverse direction, and preferably not less than 15%.”

U.S. Pat. No. 10,669,086:

Further details related to extensible papers that can be employed in some preferred embodiments are also quoted in the '086 patent as follows.

“The following is a direct quote of the paragraph on column 1, lines 4-19, of U.S. Pat. No. 3,908,071 incorporated by reference in the preceding paragraph: “Extensible (compacted) paper produced, for example, in accordance with the apparatus and process disclosed in U.S. Pat. No. 2,624,245 has certain well recognized advantages and commercial uses. Such paper is subjected, while in a partially moistened condition, to compressive compaction in the direction of web movement (machine direction or MD) between a pressure nip, thus compacting and forcing the fibers together to produce an inherent stretchability without creping. Compacted paper has improved tensile energy absorption (TEA) burst and tear characteristics which are highly desirable for such end uses as the manufacture of paper sacks.” In addition, the following is a direct quote of the Abstract of U.S. Pat. No. 6,024,832 incorporated by reference in the preceding paragraph: “A method for producing extensible paper, comprising the following stages: feeding a mix of vegetable fibres to a kneader member, mixing the mix with water in the kneader, beating the fibres to obtain a pulp, transferring the beaten pulp into a flow chest, feeding the beaten pulp from the flow chest onto a paper web formation cloth with consequent reduction of the water percentage by gravity and vacuum, pressing the web, with consequent further reduction of its water content, initial drying of the paper web to a substantially constant moisture content of between 15% and 65%, compacting, final drying to a moisture content of between 15% and 4%, preferably 10%-8%, glazing, wherein: the beating stage is carried out by rubbing the fibres in a multistage unit to obtain a pulp having a degree of beating of at least 30.degree. SR, the compacting stage is carried out between at least a pair of rollers of which one is of hard material comprising circumferential surface ribs and driven at greater speed, and the other is of soft material with a smooth surface and driven at lesser speed.” In addition, the following is a direct quote of the 2^{nd} paragraph of the Background section of U.S. Pat. No. 9,945,077 incorporated by reference in the preceding paragraph: “On the other hand, Clupak refers to equipment that inserts a paper web between a roll and an endless rubber blanket to compress the paper web with a nip bar and the rubber blanket, while at the same time the pre-stretched blanket shrinks to cause the paper web to also shrink and thereby increase its breaking elongation, and this equipment is used to provide increased breaking elongation to kraft paper used in heavy packaging applications as mentioned above.” In addition, the following is a direct quote of the paragraph on column 2, lines 41-56 of U.S. Pat. No. 3,104,197 incorporated by reference in the preceding paragraph: “The use of rubber or rubberous material in conjunction with a hard surface in the manner described is known in the treatment of paper as well as fabrics but only in a general way and the present invention includes the use of rubber considerably softer and more elastic than previously used. Also of great importance in the production of an extensible paper by creping it in this manner is the differential in speeds at which the rolls are driven. If the proper combination of hard and soft surfaces is provided, a semi-dry paper web passing through the nip of the rolls will be carried by the contracting rubber against the direction of web travel toward the nip and over the surface of the hard roll. This creates a uniformly compressed crepe in the paper web giving toughness, pliability and extensibility.”

“The following are direct quotes of paragraphs and of U.S. Patent Publication No. 2016/0355985 incorporated by reference in the preceding paragraph: (1) “[0003] On the other hand, Clupak refers to equipment that inserts a paper web between a roll and an endless rubber blanket to compress the paper web with a nip bar and the rubber blanket, while at the same time the pre-stretched blanket shrinks to cause the paper web to also shrink and thereby increase its breaking elongation, and this equipment is used to provide increased breaking elongation to kraft paper used in heavy packaging applications as mentioned above;” and “[0028] The manufacturing method using this Clupak system is such that a paper web is inserted between a roll and an endless rubber blanket to compress the paper web with a nip bar and the rubber blanket, while at the same time the pre-stretched blanket shrinks to cause the paper web to also shrink and thereby increase its breaking elongation. The Clupak system allows for adjustment of the breaking elongation of kraft paper in the longitudinal direction according to the ratio of the manufacturing speed on the inlet side of the Clupak system and manufacturing speed on the outlet side of the Clupak system, and also according to the pressurization force applied by the nip bar.”

In some embodiments, extensible paper employed can involve one or more of the following Example features, as set forth in the '086 patent.

Example 1: An extensible slit sheet paper cushioning product, comprising: a roll of slit sheet paper having a slit pattern including a plurality of slits extending in a cross direction that forms a plurality of open cells upon expansion in a machine direction, said roll resisting pulling of a length of slit sheet paper along the machine direction to enable expansion of the length of slit sheet paper in the machine direction, said slit sheet paper being formed from a paper that is extensible in the machine direction and the cross direction prior to providing said slit pattern, said extensible paper having an extensible range of 3 to 20% in the machine direction prior to providing said slit pattern.

Example 2: The extensible slit sheet paper cushioning product of example 1, wherein said extensible range is not less than 5% in both the machine direction and cross direction.

Example 3: The extensible slit sheet paper cushioning product of example 1, wherein said extensible range is 3-15% in the machine direction; or, in some embodiments, wherein said extensible range is 3-9% in the machine direction.

Example 4: The extensible slit sheet paper cushioning product of example 1, wherein said slit sheet paper is configured such that expansion is performed by applying an expansion force of 0.15 to 0.22 pounds per inch to form said open cells.

Example 5: The extensible slit sheet paper cushioning product of example 2, wherein said slit sheet paper is configured such that expansion is performed by applying an expansion force of 0.15 to 0.22 pounds per inch to form said open cells.

Example 6: The extensible slit sheet paper cushioning product of example 5, wherein said slit sheet paper has a weight, prior to expansion, from about 30 to 50 pounds per 3,000 sq. ft.

Example 7: The extensible slit sheet paper cushioning product of example 1, wherein said slit sheet paper has a weight, prior to expansion, from about 30 to 50 pounds per 3,000 sq. ft.

Example 8: A shipping package comprising: a wrapped object, said wrapped object being wrapped in at least two layers of an expanded slit sheet paper wrap having interlocking hexagonal cells, said slit sheet paper having a slit pattern including a plurality of slits extending in a cross direction that forms a plurality of hexagonal cells upon expansion in a machine direction and being expanded by applying an expansion force and wrapped to form said at least two layers of expanded slit sheet paper wrap having interlocking hexagonal cells, said slit sheet paper being formed from a paper that is extensible in the machine direction and the cross direction prior to providing said slit pattern, said extensible paper having an extensible range of 3 to 20% in the machine direction prior to providing said slit pattern.

Example 9: The shipping package of example 8, wherein said extensible range is not less than 5% in both the machine direction and cross direction.

Example 10: The shipping package of claim 8, wherein said extensible range is 3-15% in the machine direction.

Example 11: The shipping package of example 8, wherein said slit sheet paper is configured such that expansion is performed by applying an expansion force of 0.15 to 0.22 pounds per inch to form said hexagonal cells.

Example 12: The shipping package of example 11, wherein said slit sheet paper has a weight, prior to expansion, from about 30 to 50 pounds per 3,000 sq. ft.

Example 13: The shipping package of example 8, wherein said slit sheet paper has a weight, prior to expansion, from about 30 to 50 pounds per 3,000 sq. ft.

Example 14: A method of expanding and wrapping a slit sheet paper that upon expansion and wrapping forms two or more layers of interlocking hexagonal cells, comprising the steps of: providing said slit sheet paper having a slit pattern including a plurality of slits extending in a cross direction that forms a plurality of hexagonal cells upon expansion in a machine direction, wherein said slit sheet paper being formed from a paper that is extensible in the machine direction and the cross direction prior to providing said slit pattern, said extensible paper having an extensible range of 3 to 20% in the machine direction prior to providing said slit pattern, expanding said slit sheet paper, and wrapping said expanded slit sheet paper to form adjacent layers, said adjacent layers being in interlocking contact, whereby expanded layers resist contraction and tearing.

Example 15: The method of example 14, wherein said extensible range is not less than 5% in both the machine direction and cross direction.

Example 16: The method of example 14, wherein said extensible range is 3-15% in the machine direction.

Example 17: The method of example 14, wherein said step of expanding comprises applying an expansion force of 0.15 to 0.22 pounds per inch to form said hexagonal cells.

Example 18: The method of example 17, wherein said slit sheet paper has a weight, prior to expansion, from about 30 to 50 pounds per 3,000 sq. ft.

Example 19: The method of example 14, wherein said slit sheet paper has a weight, prior to expansion, from about 30 to 50 pounds per 3,000 sq. ft.

Example 20: The method of example 14, wherein the step of wrapping said slit sheet paper to form said adjacent layers, comprises: wrapping the expanded slit sheet paper around an object and forming said two or more layers of overlying interlocking hexagonal cells around said object, said overlying interlocking hexagonal cells being in direct contact substantially across the width of the layers.

Example 21: The method of example 20, wherein said extensible range is 3-15% in the machine direction and not less than 5% in the cross direction.

Example 22: The method of example 20, wherein said extensible range is 3-9% in the machine direction and not less than 5% in the cross direction.

Example 23: The method of example 20, wherein said step of expanding comprises applying an expansion force of 0.15 to 0.22 pounds per inch to form said hexagonal cells.

Example 24: The method of example 21, wherein said step of expanding comprises applying an expansion force of 0.15 to 0.22 pounds per inch to form said hexagonal cells.

Example 26: The method of above examples, wherein said extensible range is 3-15% in the machine direction and not less than 5% in the cross direction.

Example 27: The method of above examples, wherein said extensible range is 3-9% in the machine direction and not less than 5% in the cross direction.

Example 28: The method of above examples, wherein said step of expanding a length of said expandable sheet material comprises applying an expansion force of 0.15 to 0.22 pounds per inch.

Example 29: The method of example 26, wherein said step of expanding a length of said expandable sheet material comprises applying an expansion force of 0.15 to 0.22 pounds per inch.

Example 30: The method of above examples, wherein the slit extensible paper has a weight, prior to expansion, from about 30 to 50 pounds per 3,000 sq. ft.

Example 31: The method of example 28, wherein the slit extensible paper has a weight, prior to expansion, from about 30 to 50 pounds per 3,000 sq. ft.

Example 32: The extensible slit sheet paper cushioning product of example 1, wherein said extensible range is 3-11.1% in the machine direction.

Example 33: The shipping package of example 8, wherein said extensible range is 3-11.1% in the machine direction.

Example 34: The method of example 14, wherein said extensible range is 3-11.1% in the machine direction.

Example: 35: The method of above examples, wherein said extensible range is 3-11.1% in the machine direction.

Example 36: The extensible slit sheet paper cushioning product of example 1, wherein said extensible range is 3.3-10.6% in the machine direction.

Example 37: The shipping package of example 8, wherein said extensible range is 3.3-10.6% in the machine direction.

Example 38: The method of example 14, wherein said extensible range is 3.3-10.6% in the machine direction.

Example 39: The method of above examples, wherein said extensible range is 3.3-10.6% in the machine direction.

Example 40: The extensible slit sheet paper cushioning product of example 1, wherein said extensible range is 9.7-11.1% in the machine direction.

Example 41: The shipping package of example 8, wherein said extensible range is 9.7-11.1% in the machine direction.

Example 42: The method of example 14, wherein said extensible range is 9.7-11.1% in the machine direction.

Example 43: The method of above examples, wherein said extensible range is 9.7-11.1% in the machine direction.

Example 44: The extensible slit sheet paper cushioning product of example 1, wherein said extensible paper is formed by imparting a treatment prior to providing the slit pattern comprising inserting said paper between a roll and an endless pre-stretched blanket to compress the paper with a nip bar and the blanket (or otherwise compressing the paper between two different (e.g., differently moving) surfaces, such as between two different rollers).

Example 45: The shipping package of example 8, wherein said extensible paper is formed by imparting a treatment prior to providing the slit pattern comprising inserting said paper between a roll and an endless pre-stretched blanket to compress the paper with a nip bar and the blanket (or otherwise compressing the paper between two different (e.g., differently moving) surfaces, such as between two different rollers).

Example 46: The method of example 14, wherein said extensible paper is formed by imparting a treatment prior to providing the slit pattern comprising inserting said paper between a roll and an endless pre-stretched blanket to compress the paper with a nip bar and the blanket (or otherwise compressing the paper between two different (e.g., differently moving) surfaces, such as between two different rollers).

Example 47: The method of example 25, wherein said extensible paper is formed by imparting a treatment prior to providing the slits comprising inserting said paper between a roll and an endless pre-stretched blanket to compress the paper with a nip bar and the blanket (or otherwise compressing the paper between two different (e.g., differently moving) surfaces, such as between two different rollers).

Example 51: The extensible slit sheet paper cushioning product of example 1, wherein said extensible paper is a nonwoven fibrous material with fibre-to-fibre bonding that resists tearing upon 3-15% expansion in the machine direction as measured prior to providing the slit pattern.

Example 52: The shipping package of example 8, wherein said extensible paper is a nonwoven fibrous material with fibre-to-fibre bonding that resists tearing upon 3-15% expansion in the machine direction as measured prior to providing the slit pattern.

Example 53: The method of example 14, wherein said extensible paper is a nonwoven fibrous material with fibre-to-fibre bonding that resists tearing upon 3-15% expansion in the machine direction as measured prior to providing the slit pattern.

Example 54: The method of above examples, wherein said nonwoven fibrous material comprises fibre-to-fibre bonding that resists tearing upon 3-15% expansion in the machine direction as measured prior to providing the slits.

Example 55: The extensible slit sheet paper cushioning product of example 1, wherein said roll of slit sheet paper is wound on a cylindrical core, and said length of slit sheet paper extends from said roll of slit sheet paper.

Example 56: The extensible slit sheet paper cushioning product of example 1, wherein said extensible range is 5-15% in a cross-direction.

Example 57: The extensible slit sheet paper cushioning product of example 1, wherein said extensible range is 7.1-15% in a cross-direction.

Example 58: An extensible slit sheet paper cushioning product, comprising: a length of slit sheet paper having a slit pattern including a plurality of slits extending in a cross direction that forms a plurality of open cells upon expansion in a machine direction, said slit sheet paper being formed from a paper that is extensible in the machine direction and the cross direction prior to providing the slit pattern, said extensible paper having an extensible range of 3 to 20% in the machine direction prior to providing the slit pattern.

Example 59: The extensible slit sheet paper cushioning product of example 58, further including a resister that resists pulling of the length of slit sheet paper along the machine direction to enable expansion of the length of slit sheet paper in the machine direction.

Example 60: The extensible slit sheet paper cushioning product of example 59, wherein said resister is a roll of slit sheet paper from which said length of slit sheet paper extends.

Example 61: The extensible slit sheet paper cushioning product of example 58, wherein said extensible range is not less than 5% in both the machine direction and cross direction.

Example 62: The extensible slit sheet paper cushioning product of example 58, wherein said extensible range is 3-15% in the machine direction.

Example 63: The extensible slit sheet paper cushioning product of example 58, wherein said slit sheet paper is configured such that expansion is performed by applying an expansion force of 0.15 to 0.22 pounds per inch to form said open cells.

Example 64: The extensible slit sheet paper cushioning product of example 58, wherein said slit sheet paper has a weight, prior to expansion, from about 30 to 50 pounds per 3,000 sq. ft.

Example 69: The extensible slit sheet paper cushioning product of example 1, wherein said a slit pattern is configured to form a plurality of hexagonal cells upon expansion in a machine direction.

Example 70: The extensible slit sheet paper cushioning product of example 69, wherein said hexagonal cells are three-dimensional hexagonal cells with substantially rectangular land portions situated at an inclined angle transverse to an original plane of the slit sheet paper, and leg portions connecting the land portions.

Example 71: The extensible slit sheet paper cushioning product of example 58, wherein said a slit pattern is configured to form a plurality of hexagonal cells upon expansion in a machine direction.

Example 72: The extensible slit sheet paper cushioning product of example 71, wherein said hexagonal cells are three-dimensional hexagonal cells with substantially rectangular land portions situated at an inclined angle transverse to an original plane of the slit sheet paper, and leg portions connecting the land portions.

### Novel Expansion Pattern in Some Illustrative Embodiments

For reference, FIG. 2(A) shows a top plan view of a sample expanded slit sheet paper employing Kraft paper, which opens in a manner substantially similar to that shown in FIG. 1(B), discussed above. In particular, this paper includes, in an unexpanded state, an array of rows similar to that shown in FIG. 1(A), and, when expanded, the paper assumes the expansion pattern as shown in FIG. 2(A). As shown in FIG. 2(A), the expansion pattern includes the formation of substantially flat land portions 20 which tilt at an angle, and which extend across a width of the expanded sheet, along with leg portions 21, with each land portion having four respective leg portions 21 extending therefrom.

For further reference, FIG. 2(B) shows a top view of the same expanded slit sheet paper shown in FIG. 2(A) taken at an angle to the plane of the expanded paper, such as to look directly into the expanded cells of the paper (i.e., taken at an angle substantially parallel to the angle of tilt of the land portions 20. As shown, at this angle, the expansion pattern forms substantially hexagonal cells. For further reference, FIG. 2(C) shows a top view of the same expanded slit sheet paper shown in FIGS. 2(A) and 2(B), but taken at an angle to the plane of the expanded paper opposite to that of the angle shown in FIG. 2(B), such that the cell openings are obstructed from view by the broad sides of the land portions 20 and the leg portions 21.

For even further reference, FIG. 2(D), shows a top view of the same expanded slit sheet paper shown in FIGS. 2(A)-2(C), but taken from an angle to the plane of the expanded paper from a position lower to the plane of the paper proximate the lower end of FIG. 2(D). This view helps to demonstrate how the land portions 20 extend at a consistent angle, with the left edge of each land portion being at a lowest position and the right edge of each land portion being at a highest position, such as to extend upward at an inclination from left to right sides of the land portion as shown in FIG. 2(D). As shown in FIG. 2(D), this expansion pattern creates an array of open cell openings 26, each having a high side HS at a left side of the open cell and a low side LS at a right of the open cell as shown in FIG. 2(D).

In some embodiments of the present invention which employ a novel slit pattern as described herein, an expansion pattern similar to that shown in FIGS. 2(A)-2(D) can be employed. For example, in some embodiments with smaller slit lengths, such as, e.g., with some implementations of the embodiments of Examples A to Example I in Table A below, the slit sheet paper can be configured to assume an expansion pattern similar to that shown in FIGS. 2(A)-2(D), referred to herein as a “normal expansion pattern.”

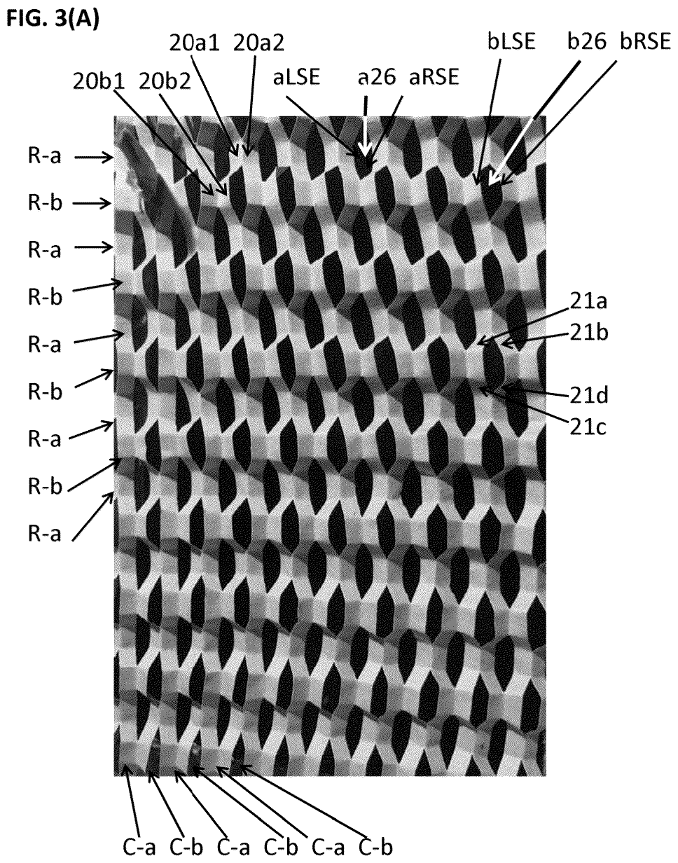

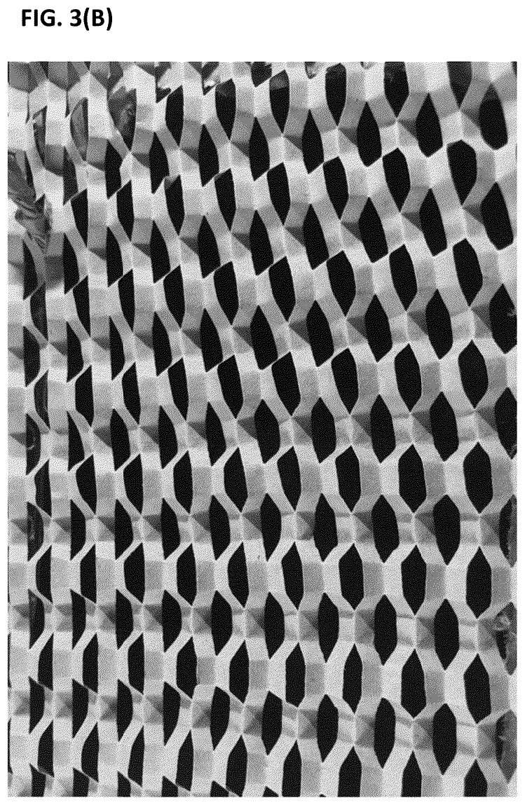

However, in some embodiments of the present invention, an expansion pattern similar to that shown in FIG. 3(A) can be employed. FIG. 3(A) shows a novel expansion pattern according to some preferred embodiments of the present invention, referred to herein as an “alternating row expansion pattern.” Although some of the preferred embodiments of the present invention will include such a novel “alternating row expansion pattern,” this type of expansion pattern is not required to be employed in all embodiments of the invention.

Moreover, while the alternating row expansion pattern can be employed in some preferred embodiments of the invention that include novel reduced-sized slit patterns described herein, this alternating row expansion pattern provides a new and advantageous inventive feature that can be implemented in the context of any desired slit size patterns, such as, e.g., slit size patterns with 0.5 inch slit lengths or even larger in some preferred embodiments.

Notably, the present inventor has discovered that this type of previously unknown alternating row expansion pattern can be achieved by employing an extensible slit sheet paper from an extensible paper that has sufficient extensibility characteristics. Towards that end, the extensibility preferably is adjusted to have sufficient extensibility in both the machine direction and the cross direction to achieve such an alternating row expansion pattern. For example, with a slit sheet paper having 0.5 inch slit lengths, 0.1875 land lengths (between slits within the same row), and row spacing of 0.125 inches, this type of alternating row expansion pattern has been achieved by employing extensible paper having an extensibility of both i) 8.8% in the machine direction and ii) 8.8% in the cross direction. In some examples, this expansion pattern can be achieved employing 30#, 40#, 50#, 60#, 70# extensible paper sheets having such a slit arrangement.

In some other embodiments, with such a slit sheet paper having these 0.5 inch slit lengths, extensibility of at least about 6% in both the machine direction and the cross direction can advantageously achieve such an alternating row expansion pattern.

In some preferred embodiments, such an alternating row expansion pattern can be achieved with slit patterns employing extensible paper that is extensible in a machine direction in a range of at least 5% and in a cross direction in a range of at least 5%, or, in some more preferred embodiments, that is extensible in a machine direction in a range of at least 6% and in a cross direction in a range of at least 6%, or, in some more preferred embodiments, that is extensible in a machine direction in a range of at least 7% and in a cross direction in a range of at least 7%, or, in some more preferred embodiments, that is extensible in a machine direction in a range of at least 8% and in a cross direction in a range of at least 8%.

Notably, the present inventor discovered that this novel alternating row expansion pattern can be created by implementation of extensible paper even with the same original slit pattern of an unexpanded sheet. In particular, even when the same slit pattern arrangement is provided on an unexpanded paper (including slit lengths, spacing between slits in the same rows of slits, and spacings between adjacent rows of slits), the present inventor discovered that the expansion pattern can be adjusted so as to achieve an alternating row expansion pattern by, e.g., modifying the paper to comprise an extensible paper as discussed above.

As illustrated in FIG. 3(A), the alternating row expansion pattern includes alternating rows (rows R-a and rows R-b) with bottom-side cell openings a26 and top-side cell openings b26. In particular, as shown, the cell openings a26 in the rows R-a are situated on the bottom side of the expanded paper sheet (i.e., on the opposite side or the far side from the point of view of FIG. 3(A), or, downward into the page view), and the cell openings b26 in the rows R-b are situated on the top side of the expanded paper sheet (i.e., on the near or close side to the point of view of FIG. 3(A)).

As also illustrated in FIG. 3(A), the land portions that are formed at the regions between the ends of the slits in the same row of slits are formed differently than the land portions 20 of the embodiment describe in relation to, e.g., FIG. 2(A). Notably, rather than assuming an angle that extends consistently upward or downward like the lands 20 of FIG. 2(A), the land portions of FIG. 3(A) include upward and downward facing portions. That is, each land portion includes a portion that extends upward, and a portion that extends downward. Moreover, each land portion in FIG. 3(A) includes a creased or angled portion aligned in between adjacent slits within the same row of slits around which the angles of incline between the two portions of the land portion changes. For example, as shown in FIG. 3(A), the land portions in rows R-a include a first portion 20a1 that extends from an edge of an open cell a26 at a left side of the land portion upwardly to the creased or angled portion at the center of the land portion, and a second portion 20a2 that extends from the creased or angled portion at the center of the land portion downwardly to an edge of an open cell a26 at a right side of the land portion. As shown in FIG. 3(A), all of the land portions within the row R-a include a similar up-and-down configuration as shown in the figure, in which the creased or angle portion at the center of the land portion forms an apex or top ridge of the land portion that is at a highest point of the land portion in a direction towards the top side of the expanded paper sheet (i.e., closest to the close side to the point of view of FIG. 3(A)).

Similarly, as also shown in FIG. 3(A), all of the land portions within the row R-b include an opposite “down-and-up” configuration as shown in the figure, in which a creased or angle portion at the center of the land portion forms a bottom ridge of the land portion that is at a lowest point of the land portion in a direction towards the bottom side of the expanded paper sheet (i.e., farthest from the close side to the point of view of FIG. 3(A)). In particular, as shown in FIG. 3(A), the land portions in rows R-b include a first portion 20b1 that extends from an edge of an open cell b26 at a left side of the land portion downwardly to the creased or angled portion at the center of the land portion, and a second portion 20b2 that extends from the creased or angled portion at the center of the land portion upwardly to an edge of an open cell b26 at a right side of the land portion. As shown in FIG. 3(A), all of the land portions within the row R-b include a similar down-and-up configuration as shown in the figure.

Furthermore, in the expansion pattern of FIG. 2(A), the leg portions extending from a first side of the land portion extend in different directions. In particular, this includes first legs extending from a top edge of the land portion extending upwards towards a close side of the expanded paper (e.g., in a direction towards the top left of FIG. 2(A), and second legs extending from that top edge of the land portion extending downwards towards a far side of the expanded paper (e.g., in a direction towards the top right of FIG. 2(A)). In addition, this also includes third legs extending from a bottom edge of the land portion extending upwards towards a close side of the expanded paper (e.g., in a direction towards the bottom left of FIG. 2(A), and forth legs extending from that bottom edge of the land portion extending downwards towards a far side of the expanded paper (e.g., in a direction towards the lower right of FIG. 2(A)).

However, in contrast to the embodiment shown in FIG. 2(A), in the alternating row expansion pattern shown in FIG. 3(A), the leg portions extending from a first side of the land portion extend in similar directions. In particular, the leg portions extend in a manner to create the alternating rows R-a and R-b, wherein these alternating rows R-a and R-b are located at opposing sides of the expanded slit sheet in a width direction of the sheet—that is, with the rows R-a being at a far side of the expanded slit sheet in the width direction as viewed in FIG. 3(A) and with the rows R-b being at a close side of the expanded slit sheet in the width direction of the sheet.

In particular, as shown in FIG. 3(A), the legs include: a) first legs 21a extending from a top edge of a land portion 20b2 downwardly to a land portion 20a1; b) second legs 20b extending from a top edge of a land portion 20b1 downwardly to a land portion 20a2; c) third legs 21c extending from a bottom edge of a land portion 20b2 downwardly to another land portion 20a1; and d) fourth legs 20d extending from a bottom edge of a land portion 20b1 downwardly to another land portion 20a2.

The present inventor has also discovered that this alternating row expansion pattern has a number of substantial advantages and benefits over the expansion pattern shown in FIG. 2(A). First, the alternating row expansion pattern has substantial aesthetic benefits and is more aesthetically appealing and interesting. Second, the alternating row expansion pattern creates an expansion pattern that is more visually obstructive at a variety of angles. Second, the alternating row expansion pattern creates an expansion pattern that has improved cushioning and operational characteristics.

While the open cells 26 of the example shown in FIG. 2(A) creates cells having a high side HS at a close side of the expanded paper and a low side LS at a far side of the expanded paper (as shown in FIG. 2(A)), the open cells a26 and b26 shown in FIG. 3(A) create cells having both sides at similar heights (i.e., either at a high side such as, e.g., cells b26 or at a low side such as, e.g., cells a26). Among other things, forces applied to the periphery of the open cells a26 and b26 are, thus, generally applied more evenly on opposite sides of the open cells, rather than being applied at a single side of the open cells of the opens cells 26 shown in FIG. 2(A).

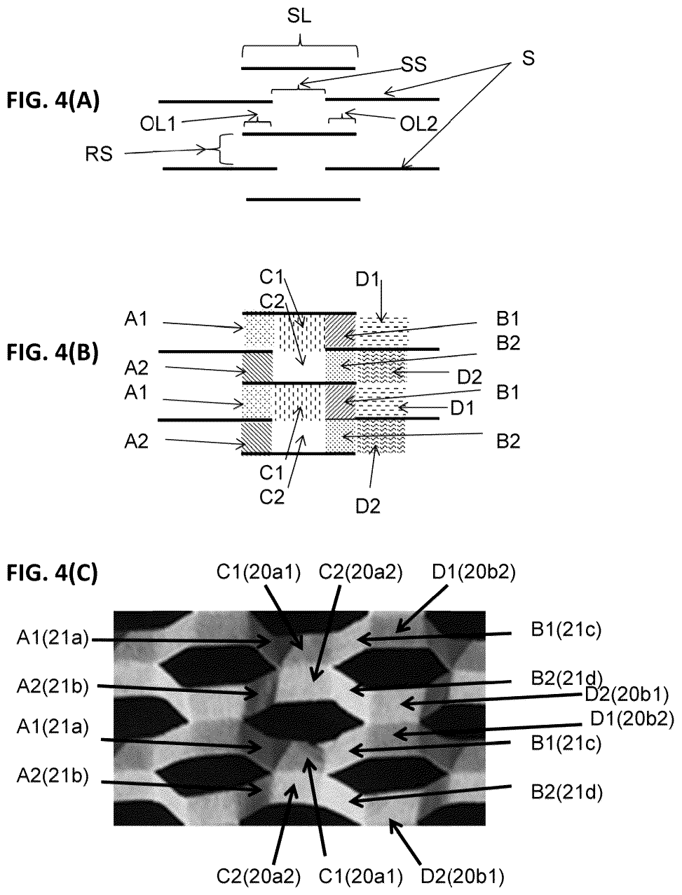

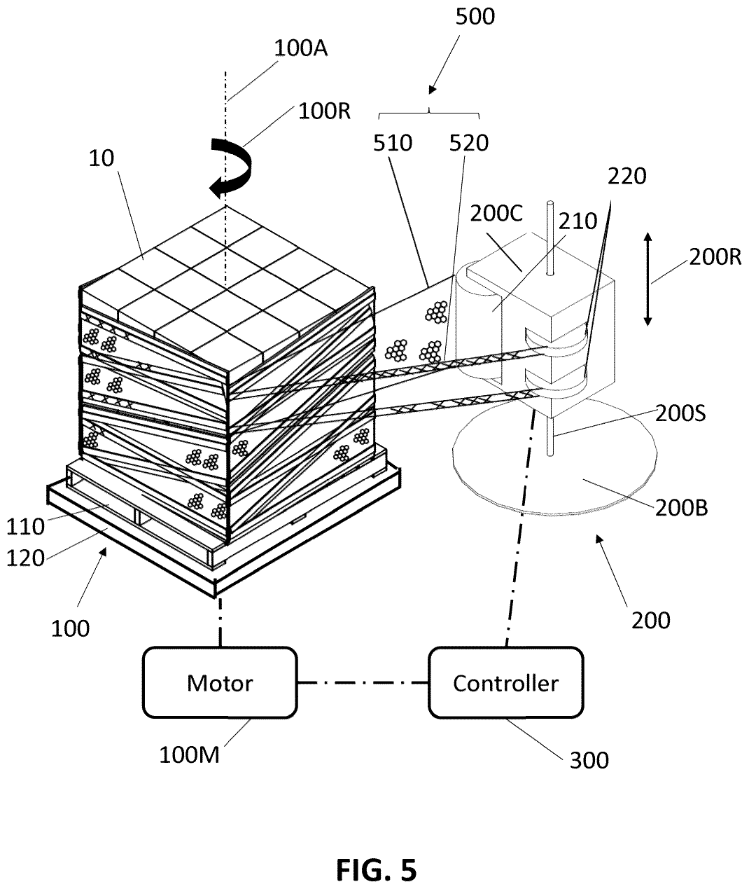

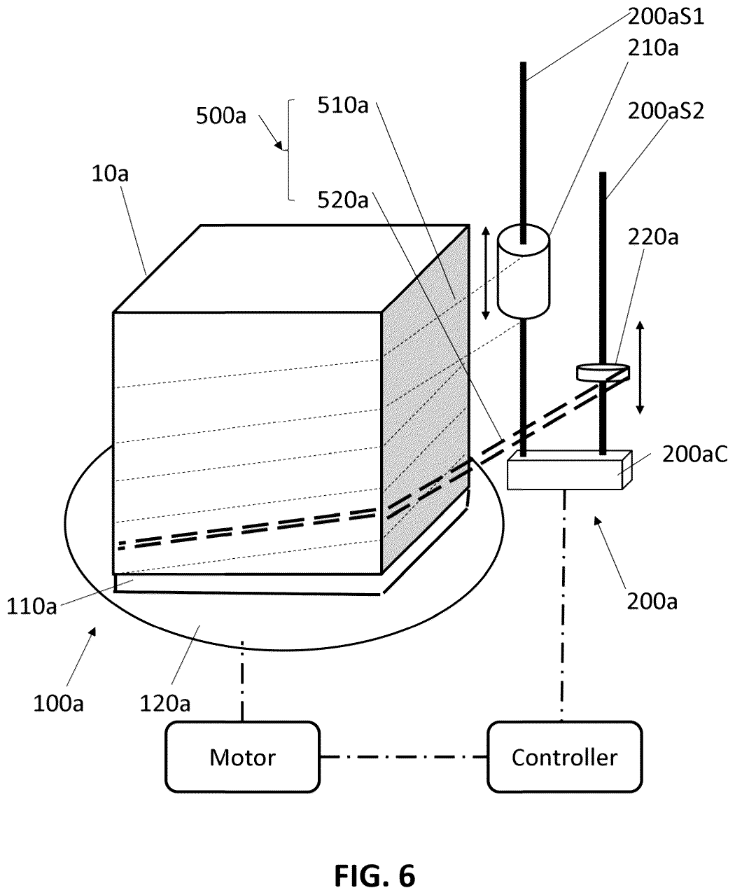

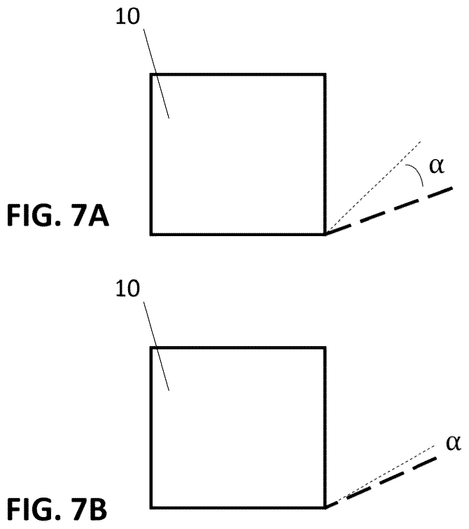

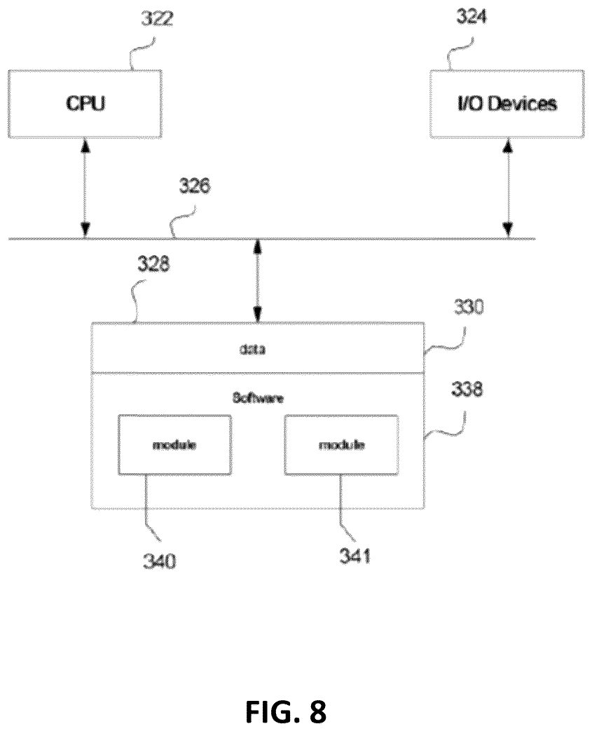

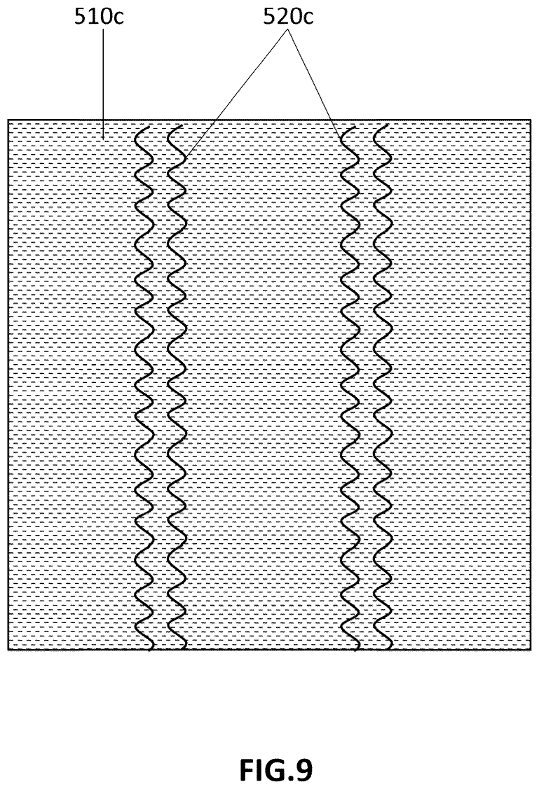

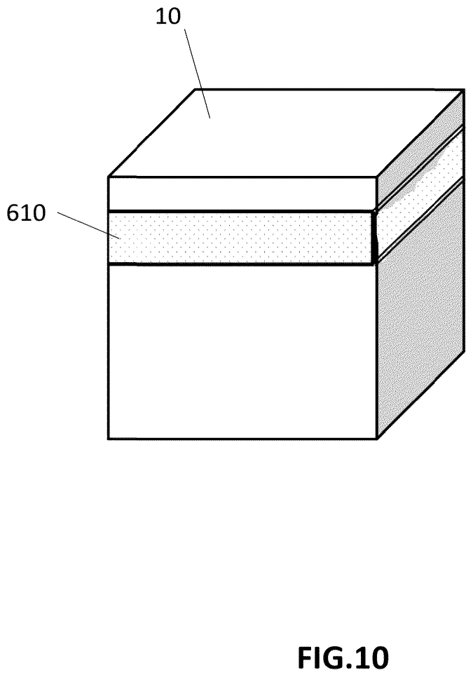

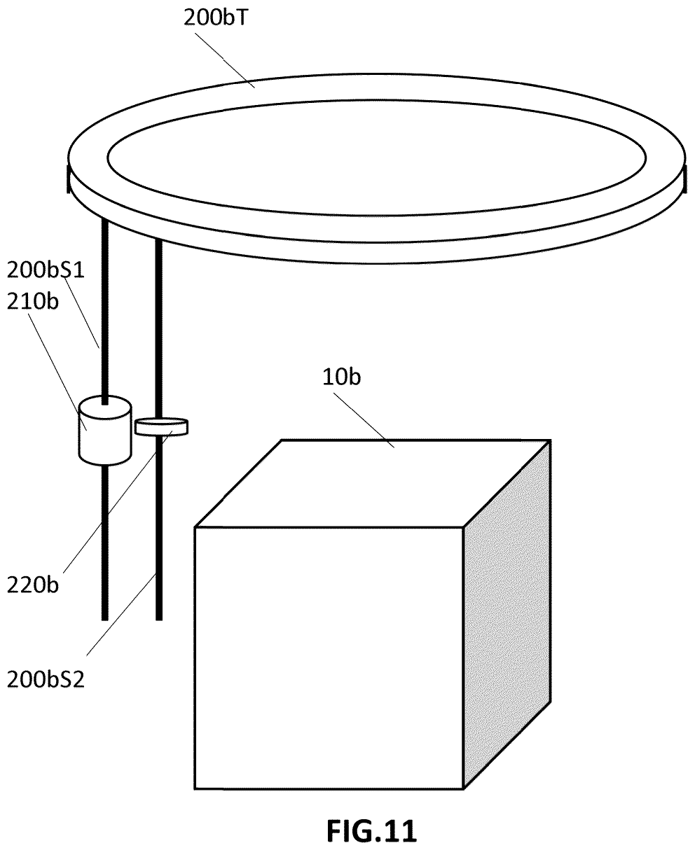

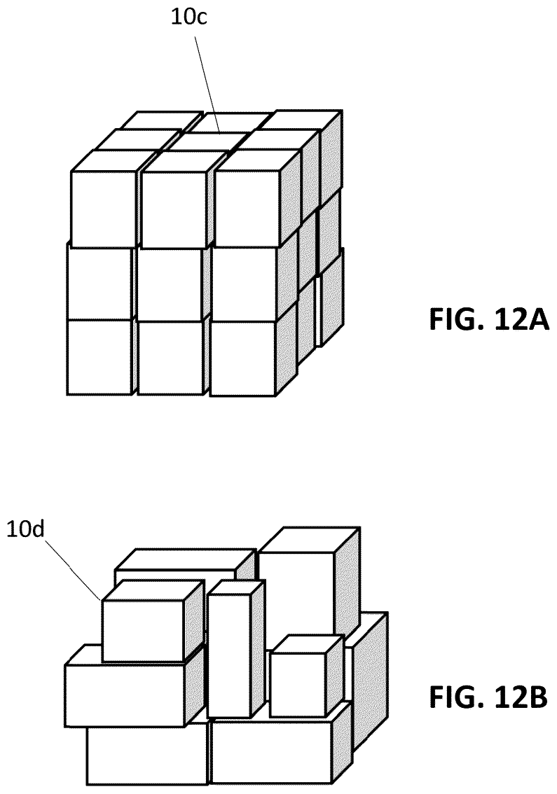

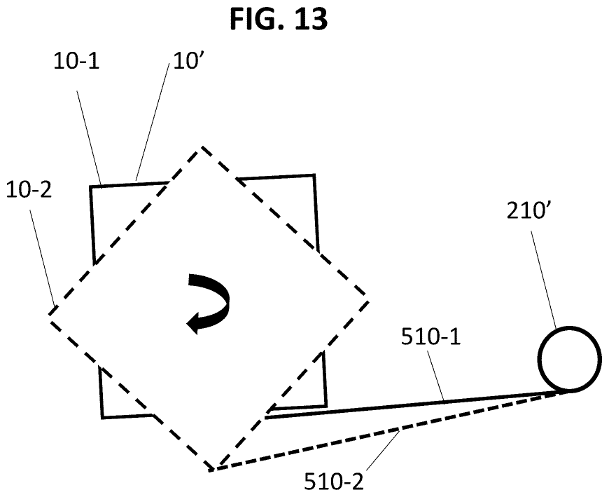

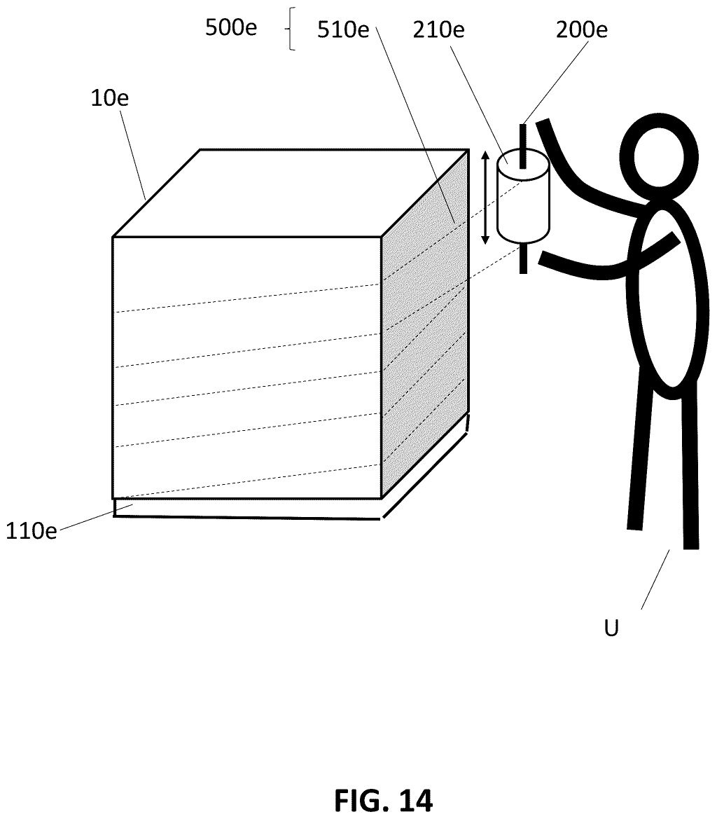

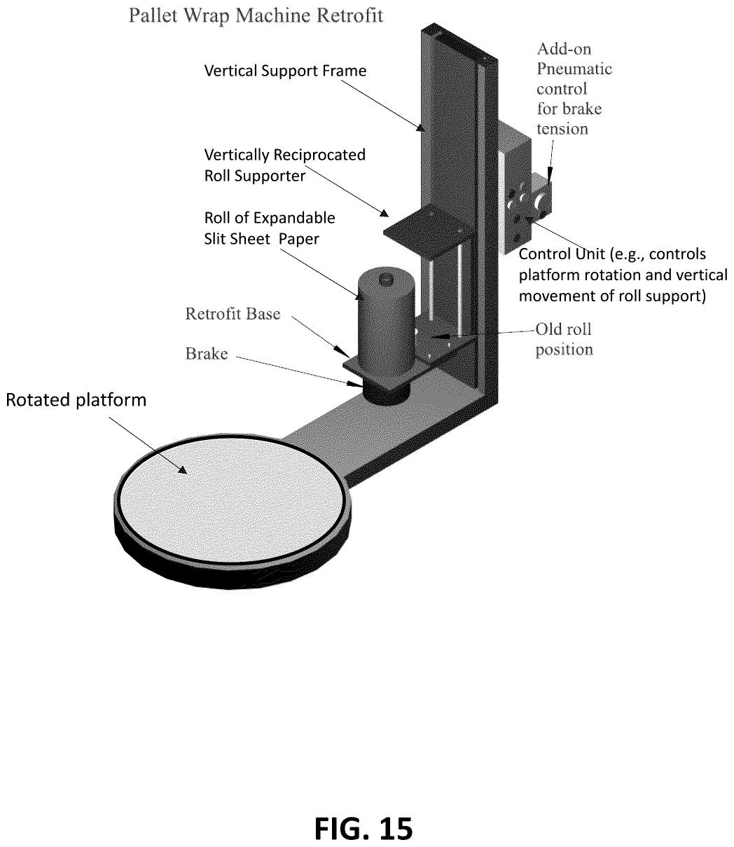

For further reference, FIGS. 4(A) to 4(C) provide an explanatory diagram demonstrating the formation of the alternating row expansion pattern according to the preferred embodiments of the invention. First, FIG. 4(A) shows an illustrative slit pattern formed within a sheet of paper. In some embodiments, the slit pattern is generally similar to that shown in FIG. 5(A), discussed above. However, as discussed below, in the most preferred embodiments of the present invention, the slit pattern has novel and advantageous slit and slit pattern dimensions and relationships as discussed further below.

As shown in FIG. 4(A), the slits include a plurality of rows of slits extending substantially horizontally across the page of view of the figure. Although only 7 slits S are depicted (for explanatory purposes), it should be appreciated that in preferred embodiments the product would include rows of slits extending entirely or substantially entirely across the paper sheet. As shown, the slits preferably have a common slit length SL (i.e., all slits preferably have a like slit length), a common slit spacing SS between ends of the slits in the same row of slits (i.e., all slit spacings preferably have a like length), and a common row spacing RS between adjacent rows of slits (i.e., all spacings between rows preferably have a like distance). Additionally, as also shown, the extent of overlap between slits of adjacent rows preferably includes equal sized spacings OL1 and OL2 (i.e., the slits in adjacent rows are preferably symmetrically aligned such as to create symmetrical cells upon expansion).

FIG. 4(B) shows the slit pattern of FIG. 4(A) with regions of the paper prior to expansion highlighted for reference. Towards that end, the regions A1, A2, B1, B2, C1, C2, D1 and D2 are shaded in the figure to facilitate reference. However, it should be appreciated that in this unexpanded state shown in FIG. 4(B), these regions are, e.g., all flat or planar regions along the plane of the original unexpanded sheet of paper.

As shown in FIG. 4(C), upon expansion, the slits S are caused to open and create open cells a26 and b26. Additionally, as depicted in FIG. 4(C), the regions A1 are caused to assume the orientations of legs 21a discussed above, the regions A2 are caused to assume the orientations of legs 21b discussed above, the regions B1 are caused to assume the orientations of legs 21c discussed above, the regions B2 are caused to assume the orientations of claim 21d discussed above, the regions C1 are caused to assume the orientations of land portions 20a1 discussed above, the regions C2 are caused to assume the orientations of land portions 20a2 discussed above, the regions D1 are caused to assume the orientations of land portions 20b2 discussed above, and the regions D2 are caused to assume the orientations of land portions 20b1 discussed above.

In the embodiment shown in, e.g., FIG. 3(A) employing an alternating row expansion pattern, the open cells a26 and b26, form substantially hexagonal peripheries that are “bent” at a central region such as to not form a regular hexagon (i.e., both equilateral and equiangular), but, rather, to form, e.g., a substantially hexagonal shape in which the opposing land portions 20b2 and 20b1 are closer to one another. In contrast, as best shown in, e.g., FIG. 2(B), the prior expansion pattern leads to substantially regular hexagons. Notably, the hexagonal open cells a26 and b26 include a first half that extends along substantially a first plane with edges along one of the land portions and two of the leg portions and a second half that extends along substantially a second plane with edges along another of the land portions and two of the leg portions. For example, an open cell b26 includes a first half along a first plane delineated by an edge of the leg 21c, an edge of the land portion 20b2, and an edge of the leg 21a, and a second half along a second plane delineated by an edge of the leg 21d, an edge of the land portion 20b1, and an edge of the leg 21b. In this application, such a substantially hexagon shape that is bent between two planes is referred to as a “bent hexagon.” With reference to FIGS. 3(A) and 4(C), the bent hexagons of the cells b26 are formed so as to open upwardly (i.e., such that the angle between both of the planes opens upwardly) while the bent hexagons of the cells a26 are formed so as to open downwardly (i.e., such that the angle between both of the planes opens downwardly and oppositely to that of the angle of the bent hexagons of the cells b26).

Further Discussion of Further Illustrative Embodiments In order to expand an expandable slit sheet paper, an expansion force is required to pull the paper to cause the paper to expand and to open the cells. Existing expandable slit sheet paper can be somewhat difficult to expand and requires a substantially higher force for expansion. Additionally, existing expandable slit sheet paper requires a larger slit length in order to enable opening of the cells. Varying slit patterns with expanded slit sheet material require varying force to stretch. The present slit pattern used in the market requires approximately 6 pounds of pulling force for slit material that is 15 inches wide utilizing 50# Kraft paper. However, the present inventor has discovered that extensible paper reduces the force required for the same slit pattern and paper weight to, e.g., 2 pounds.

The present inventor has also discovered that this decrease enables further slit pattern opportunities that can provide greater resiliency and a reduced thickness, as desired, while, in the past, such would have been too difficult to stretch manually and provide a burden to the automated expanding equipment. In general terms, the present inventor has discovered that, by way of example, a 10% reduction in slit, land, and row size increases the number of supporting legs by 23.7%-a more than doubling of the strength of the material. This provides cushioning solutions where greater resiliency of the same or smaller leg height can be accomplished.

Additionally, and well known in paper die cutting art, leg height impacts stiffness. As the leg height is reduced, the leg becomes stiffer. This is due to the fiber length that becomes more difficult to bow or flex as the height becomes shorter. According to preferred embodiments of the present invention, the leg height, the number of legs per square foot, and the paper weight is balanced to provide optimal cushioning while providing the least amount of pulling strength to open.

The automated equipment is also impacted with a heavy pulling strength as it requires more maintenance changes, in some examples, to the hook rollers due to their wearing out proportionally to the pulling force required. With the advent of the present inventor's discovery of the unique and unexpected advantages of extensible paper employed in expandable slit sheet products, these limitations based on pulling force are greatly diminished and enable greater market opportunities where greater strength is required.

Presently there is a move towards environmentally friendly packaging products that includes the use of non-powered equipment eliminating the need for electricity.

Presently, the crush strength for the current commercial pattern using a 0.5″ slit is 2.2 pounds per square inch of strength.

According to some preferred embodiments of the present invention, a preferred reduced slit pattern utilizing 50# Kraft paper with a slit pattern of 0.45″ slit (i.e., length of slit), 0.1688″ land (i.e., distance between adjacent slits in a lengthwise direction of the slits), 0.1125″ row width (i.e., distance between adjacent rows of slits) is provided. In some embodiments, such a configuration yields 2.72-2.92 pounds of per inch of crush strength, which yields a 27% increase in strength with a 10% decrease in thickness from 0.1875″ to 0.16875″. In the most preferred implementations of this slit pattern, the paper employed is an extensible paper.

According to some other embodiments of the present invention, another preferred slit pattern is 0.40″ slit, 0.15″ land, 0.1125″ row width. In some embodiments, this latter configuration yields 3.1-3.3 pounds per inch crush strength, which yields a 40% increase in crush strength with a 10% decrease in thickness from 0.1875″ to 0.16875.″ In the most preferred implementations of this slit pattern, the paper employed is an extensible paper.

According to the preferred embodiments, this increase in strength can advantageously be used to allow for a reduced thickness of the expanded slit sheet paper, which can, thus, provide, e.g., an equivalent crush strength while providing for a reduction in overall height. For example, in the above illustrative embodiments employing a 50# paper, the use of 40# paper would reduce the leg stiffness, but would reduce the cost of the paper.

According to some other preferred embodiments, an expandable slit paper sheet includes a pattern of slits having slit lengths in the range from 0.30 to 0.45 inches and spaces between rows of slits in the range from 0.1125 to 0.1688. In the most preferred implementations of this slit pattern, the paper employed is an extensible paper.

According to some other preferred embodiments, an expandable slit paper sheet includes a pattern of slits having slit lengths in the range of 0.45 inches plus 5% (e.g., 0.4725 inches) to 0.45 inches minus 33% (e.g., 0.30 inches). In the most preferred implementations of this slit pattern, the paper employed is an extensible paper.

According to some other preferred embodiments, an expandable slit paper sheet includes a pattern of slits that upon expansion produces an expandable slit paper having a number of legs per square foot that is at least 20% greater than a slit paper sheet with slit lengths of 0.5 inches which is configured to create hexagonal cells (e.g., with equilateral hexagons).

According to some other preferred embodiments, an expandable slit paper sheet includes a pattern of slits that upon expansion produces an expandable slit paper having a number of legs per square foot that is at least 15% greater than a slit paper sheet with slit lengths of 0.5 inches which is configured to create hexagonal cells (e.g., with equilateral hexagons), and, more preferably, in the range from 20% to 50% greater than such slit paper with slit lengths of 0.5 inches which is configured to create hexagonal cells (e.g., with equilateral hexagons), and, in some embodiments more than 50% greater than such slit paper with slit lengths of 0.5 inches which is configured to create hexagonal cells (e.g., with equilateral hexagons).

In the most preferred embodiments, the paper employed is an extensible paper as described herein-above. The use of such extensible paper highly advantageously enables a reduced slit pattern size in comparison to prior slit patterns. Notably, non-extensible paper has limitations in relation to the viable sizes and dimensions of the slits, and such non-extensible paper does not enable reduction in sizes to that of preferred embodiments described herein because such prior papers would be inoperable and would not adequately or properly expand if such small sizes were attempted to be employed.

Additionally, while the present inventor has discovered novel means to improve cushioning characteristics of expandable slit sheet paper, which involves “reducing” the slit pattern dimensions, it is notable that this reduction of slit pattern dimensions is “not only” unviable with prior expandable slit sheet paper (i.e., which could not achieve such small sizes), but is also “counter-intuitive” to the existing understanding of cushioning properties afforded by such expandable slit sheet papers. Notably, the cushioning of expandable slit sheet papers is directly related to the “width” of the expandable slit sheet paper in an expanded state. Accordingly, for enhancing cushioning, those in the art have sought to actually “increase” this width of the expanded slit sheet paper. However, the present inventor discovered means by which smaller slit patterns can be achieved (e.g., via the use of the extensible paper) and that such smaller slit patterns with such extensible papers can, in fact, provide enhance cushioning despite the losses in cushioning due to the reduced “width” of the expandable slit sheet paper. Additionally, the present inventor also discovered other desirable applications and uses of such novel expandable slit sheet paper.

Notably, non-extensible expanded slit paper sheets cannot operate appropriately with slit lengths of less than about 0.5 inches. Accordingly, for expandable slit paper sheets of smaller slit sizes according to the present invention, an extensible paper according to the present invention is advantageously employed.

According to some exemplary more preferred embodiments of the invention, a slit pattern is provided which includes slit lengths of 0.35″ slits (i.e., the lengths of the slits), 0.13125″ lands (i.e., the distances between adjacent slits in the same row of slits in a lengthwise direction of the slits), and 0.0875″ row width (i.e., the distances between adjacent rows of slits). In this regard, such a slit pattern is preferably implemented within a pattern of slits similar to that shown in, e.g., FIG. 4(A), in which all of the slits of the expandable slit sheet have the same lengths, the distances between adjacent rows is consistently the same, in which the distance between slits in the same row is consistently the same, and in which the locations of the slits in adjacent rows is arranged with equal overlap to form symmetrical cells. For these embodiments, an extensible slit sheet paper is preferably employed; notably, a non-extensible paper cannot be used to viably operationally function with such a slit pattern.

While, preferably, all of the expanded slit sheet paper would include a same slit pattern throughout the sheet, in some embodiments such a pattern can be employed within a portion or region of the paper and/or some regions of the paper may potentially include some differences in the pattern. Additionally, although the slit lengths and dimensions are preferably consistently the same as indicated above, in some embodiments, there can be some variations in sizes, positions of the slits as long as operation of the product is not impeded.

In some embodiments, a slit pattern having 0.35″ slits, 0.13125″ lands, and 0.0875″ row width can yield 3.52-3.82 pounds per inch crush strength which yields a 60% increase in crush strength with a 30% decrease in thickness from 0.1875″ to 0.1125.”

In some preferred implementations of all of the embodiments of the invention described above, the lands distance (i.e., the distance SS shown in FIG. 4(A) between the slits) is approximately ⅓ the length of the slits (i.e., the distance SL shown in FIG. 4(A)). When the distance SS is about ⅓ the length of the slits, the lengths of the perimeter sides of the created cell openings a26 and b26 are substantially equal. However, in some preferred embodiments, the distance of the lands (i.e., SS) is preferably slightly greater than ⅓ the length of the slits. For example, in the lattermost embodiments above employing a 0.35″ slit length, with 0.13125″ land length, the ratio is approximately 0.375. Accordingly, in this example, the length of the lands are approximate 12.5% larger than ⅓ the length of the slits.

In some preferred embodiments, the lengths of the lands would be about ⅓ the length of the slits plus or minus about 25%. In some other preferred embodiments, the lengths of the lands would be about ⅓ the length of the slits plus or minus about 20%. In some preferred embodiments, the lengths of the lands would be about ⅓ the length of the slits plus or minus about 15%. In some other preferred embodiments, the lengths of the lands would be about ⅓ the length of the slits plus or minus about 10%.

In some other preferred embodiments, the lengths of the lands would be between about ⅓ the length of the slits to 25% greater than ⅓ the length of the slits. In some other preferred embodiments, the lengths of the lands would be between about ⅓ the length of the slits to 20% greater than ⅓ the length of the slits. In some other preferred embodiments, the lengths of the lands would be between about ⅓ the length of the slits to 15% greater than ⅓ the length of the slits. In some other preferred embodiments, the lengths of the lands would be between about ⅓ the length of the slits to 10% greater than ⅓ the length of the slits.

In some other preferred embodiments, the lengths of the lands would be between about 5% greater than ⅓ the length of the slits to about 25% greater than ⅓ the length of the slits. In some other preferred embodiments, the lengths of the lands would be between about 10% greater than ⅓ the length of the slits to about 20% greater than ⅓ the length of the slits. In some other preferred embodiments, the lengths of the lands would be between about 10% greater than ⅓ the length of the slits to about 15% greater than ⅓ the length of the slits. In some other preferred embodiments, the lengths of the lands are such that the slit length SL is approximately set in relation to the split spacing SS as follows: SL=2.6667×SS.

In some preferred embodiments, the dimensions of the expandable slit sheet paper are proportionally reduced from an expandable slit sheet paper having a 0.5″ slit length, a ⅛″ (0.125 inch) spacing between rows, and a spacing between slits within the same row (i.e., land length) of 3/16″ (0.1875 inch) as follows: a) the row spacing is proportionally reduced by a ratio SL (new)/0.5 and b) the slit spacing is set at SL (new) divided by 2.6667. For example, some preferred embodiments include dimensions as set forth below Table A:

| | Slit Length (SL) | Slit Spacing (SS) | Row Spacing (RS) |
|---|---|---|---|
| Example A | 0.45 inches | 0.1687 inches | 0.1125 inches |
| Example B | 0.425 inches | 0.1594 inches | 0.1063 inches |
| Example C | 0.40 inches | 0.1500 inches | 0.1000 inches |
| Example D | 0.375 inches | 0.1406 inches | 0.09375 inches |
| Example E | 0.35 inches | 0.13125 inches | 0.0875 inches |
| Example F | 0.325 inches | 0.1219 inches | 0.0813 inches |
| Example G | 0.30 inches | 0.1125 inches | 0.0750 inches |
| Example H | 0.275 inches | 0.1031 inches | 0.0688 inches |
| Example I | 0.25 inches | 0.09375 inches | 0.0625 inches |
| Example J | 0.225 inches | 0.08438 inches | 0.0563 inches |
| Example K | 0.20 inches | 0.07500 inches | 0.05 inches |
| Example L | 0.175 inches | 0.06562 inches | 0.04375 inches |

In some preferred embodiments, the corresponding row spacings of the Examples A to L in the above Table A are substantially as shown in Table A. In some preferred embodiments, the row spacings of Examples A to L can be substantially as shown in Table A plus or minus 20%, or, more preferably, substantially as shown in Table A plus or minus 15%, or, more preferably, substantially as shown in Table A plus or minus 10%, or, more preferably, substantially as shown in Table A plus or minus 5%.

Furthermore, in some preferred embodiments, the corresponding row spacings of the Examples A to L in the above Table A are, more preferably, within a range that is the same or lower than the row spacings shown in Table A for the respective slit lengths; notably, with reduced slit length, there can be increased difficulty to open the cells, which difficulty is increased with larger row spacings. Accordingly, as the slit lengths are decreased, in some preferred embodiments, the row spacing decreases an extent that is proportionally the same or more than the proportional decrease in the slit length. Notably, while the present inventor discovered that slit lengths can be viably decreased by the use of extensible papers as described herein, the present inventor also noted that even with extensible papers reduction in slit lengths can increase difficulty to open cells in the event that row spacings are proportionally too large.

Although the preceding Table A shows row spacings that are substantially reduced well below the ⅛″ (0.125 inch) row spacing of the background art, in some alternative embodiments, the row spacings for various embodiments of the invention (including that of, e.g., Examples A to L in the preceding Table) can still be larger. That is, while the present invention very advantageously enables such a reduced row spacing due to the greatly improved cushioning characteristics that enable the row spacing to be reduced (e.g., the reduction in cushioning resultant from reduced row spacing can be offset by the improved cushioning characteristics of the present invention), such a substantial reduction is not necessarily required, as long as the cell structure can be opened for expansion.

For example, in some alternative embodiments, any of the embodiments of the invention having slit lengths within a range of 0.40 to 0.25 can employ row spacings that are less than that of the existing art, such as, e.g., less than 0.125 inches, or, more preferably, less than 0.12 inches, or, more preferably, less than 0.115 inches, or, more preferably, less than 0.1125 inches, or, more preferably, less than 0.0875 inches, or, in some embodiments more preferably, less than 0.08 inches.

In some other alternative embodiments, the various embodiments of the invention shown in the preceding Table A can be modified such that:
a) the slit spacing (which is shown in Table A as approximately based on the formula SL=2.6667×SS), can be adapted to be based on the formula SL=K×SS, where K is a value between 2.4 and 3.3, or, more preferably, where K is a value between 2.5 and 3, or, more preferably, where K is a value between 2.6 and 2.8); and/or
b) the row spacing (which is shown in Table A as approximately based on the row spacing being proportionally reduced by a ratio SL (new)/0.5, such as to be based on the formula RS (new)=0.125/0.5×SL (new) or RS (new)=0.25×SL (new)), can be adapted to be based on the formula RS (new)=Y×SL (new), where Y is a value between 0.2 to 0.4, or, more preferably, where Y is a value between 0.22 and 0.3, or, more preferably, where Y is a value between 0.23 and 0.27.

In some preferred embodiments, the slit paper pattern of slits advantageously has slits in the range from 0.2 to 0.3 inches (i.e., in the lengthwise dimension of the slits) and spaces between rows in the range from 0.05 to 0.075 inches (i.e., the distance between adjacent rows of slits). Preferably, the slit paper pattern of slits advantageously has slits of about 0.25 inches (i.e., in the lengthwise dimension of the slits) and spaces between rows of about 0.06 to about 0.065 inches (i.e., the distance between adjacent rows of slits) and most preferably spaces between rows of about 0.0625 inches.

In some preferred embodiments, the space between the slits of each row is preferably in the range from about 0.1 to about 0.09 inches and most preferably, the space between the slits of each row is about 0.094 inches.

In some embodiments, the foregoing dimensions can produce a slit pattern that creates more cells per square foot, provides crush resistance and resiliency for cushioning, and provides substantially improved tensile strength.

In the preferred embodiments of the present invention, the paper is, most preferably, an extensible paper. In various embodiments, the extensible paper is an extensible paper according to any of the embodiments or examples of extensible paper disclosed herein. For example, in various embodiments, any of the various extensible papers described herein in relation to the various patents and documents described herein can be employed.

In various embodiments, the extendable paper can employ extensibility according to any of the embodiments described herein, including, e.g., any of the Example 1 to Example 72 described above. Moreover, the extendable paper can include features of any of the extensible papers described herein in relation to, e.g., opening forces required, paper weight or type, etc. However, as described herein, in embodiments that are to employ an alternating row expansion pattern, it is noted that the extensibility is adapted to achieve the alternating row expansion pattern as described herein.

In some illustrative examples, in some embodiments, an extensible paper is employed having an extensible range of 3 to 20% in the machine direction, or, in some embodiments, 3 to 9% in the machine direction. In some illustrative examples, in some embodiments, an extensible paper is employed having an extensible range of 3 to 20% in the cross direction, or, in some embodiments, 3 to 9% in the cross direction. In some illustrative examples, in some embodiments, an extensible paper is employed having an extensible range of 3 to 15% in the machine direction. In some illustrative examples, in some embodiments, an extensible paper is employed having an extensible range of 3 to 15% in the cross direction. In some illustrative examples, in some embodiments, an extensible paper is employed having an extensible range of 7 to 15% in the machine direction. In some illustrative examples, in some embodiments, an extensible paper is employed having an extensible range of 7 to 15% in the cross direction. In some illustrative examples, the extensible range is not less than 5% in both the machine direction and cross direction.

Moreover, in some illustrative examples, the slit sheet paper is an extensible slit sheet configured such that expansion is performed by applying an expansion force of 0.10 to 0.40 pounds per inch, or, preferably, of 0.125 to 0.33 pounds per inch, or, in some embodiments, of 0.15 to 0.22 pounds per inch, to form said open cells.

Moreover, in some illustrative examples, the slit sheet paper is an extensible slit sheet, wherein said slit sheet paper has a weight, prior to expansion, from about 30 to 70 pounds per 3,000 sq. ft. Notably, all of the embodiments of the invention described herein (e.g., the various slit patterns, including slit lengths, slit spacings, row spacings, etc.) can be employed in various implementations of papers with weights within this range in some embodiments, such as, e.g., on 30# paper, 40# paper, 50# paper, 60# paper, 65# paper, and on any papers within this range. Moreover, in other embodiments, papers can be employed lower than this range of 30# to 70#, such as, e.g., 20# or less, or larger than this range, such as, e.g., 60# or more. In this application, where paper is referred to by weight in pounds (e.g., #), it should be understood that such weight in pounds indicates the listed number of pounds as per 3,000 square feet (e.g., sq. ft.). Accordingly, e.g., a 50# paper should be understood as corresponding to 50 pounds per 3,000 square feet.

### Expandable Slit Sheet Paper Pallet Wrap w/o Support Wrap

As indicated above, while some preferred embodiments include a support wrap that provides enhanced support along with an expandable slit sheet paper, in some of the more preferred embodiments, a support wrap is not required. Thus, some of the preferred embodiments provide an expandable slit sheet material that is specially and uniquely configured to operate as a pallet wrap without a required support wrap. Although a support wrap (e.g., any of the types of support wraps described herein) can be included (if desired) in the context of such novel expandable slit sheet material that does not require a support wrap, such support wraps can be advantageously omitted in some preferred embodiments.

Additionally, although any of the embodiments of the expandable slit sheet material described herein can be employed without the use of a support wrap in some embodiments for the wrapping pallets, due to the high load requirements in the context of wrapping of many common pallets, in some of the most preferred embodiments, a specially configured and designed expandable slit sheet paper is created for implementation as a pallet wrap without a required support wrap (for example, employing paper with substantial extensibility and/or smaller slit lengths, etc., according to various embodiments described herein).

According to some of the most preferred embodiments, an expandable slit sheet paper is provided that has a substantially reduced slit pattern in comparison to expandable slit sheet papers that are commonly employed for wrapping of products placed within shipping packages or the like (such as, e.g., hand-wrapped products). For example, in the background art, expandable slit sheet papers have been created having slit lengths of generally about 0.5 inches long for the purposes of hand-wrapping of individual products that are stored in shipping packages. In that context, the existing expandable slit sheet papers are relatively easily expanded and relatively easily torn. These qualities of easy expansion and easy tearing, while desirable in the context of hand-wrapping of individual products, precludes the realistic application of such existing expandable slit sheet papers in the context of pallet wrapping. In fact, none of the prior known expandable slit sheet paper products came anywhere near the properties necessary for realistic contemplation as a pallet wrap for common pallet environments.

The present inventor, however, has developed novel and advantageous expandable slit sheet papers having properties and characteristics previously unattainable by existing expandable slit sheet papers, and previously not even recognized as possible.

Towards that end, as described in preceding section, in some of the preferred embodiments, the present inventor has created novel and advantageous expandable slit sheet papers having reduced slit pattern sizes. For example, as described in Table A (above), in some embodiments, expandable slit sheet paper can be made with slit lengths SL of significantly less than 0.5 inches, including, for example, embodiments of Examples A-L in Table A. For example, as shown in Table A, the present inventor has been able to achieve expandable slit sheet paper with slit lengths of substantially less than 0.5 inches, including, by way of example, Example I having 0.25 inch slit lengths. Towards that end, the present inventor has discovered that by employing paper with sufficient extensibility, an expandable slit sheet paper with substantially reduced slit pattern sizes can be achieved, while previously expandable slit paper could not be made with smaller slit pattern sizes, as, for example, the forces required to expand the prior expandable slit paper would be too great in comparison to the tensile strength of the expandable slit paper if such smaller slit pattern sizes were employed.

Additionally, the present inventor discovered that by providing expandable slit sheet paper with substantially reduced slit pattern sizes, the tensile forces achievable by the expandable slit sheet paper can be greatly increased. As a result, as discovered by the present inventor, an expandable slit sheet paper can be achieved that provides sufficient tensile forces to operate as a pallet wrap without any required support wrap surrounding the expandable slit sheet paper.

By way of example, in some examples, an expandable slit sheet paper having 0.5 inch slit lengths can require a force of about 2-3 lbs to open the cells (i.e., to expand the cells to an open state) and a force of about 6-8 lbs to tear the expandable slit sheet paper, while a similar expandable slit sheet paper having 0.25 slit lengths can require a force of about 6-8 lbs to open the cells (i.e., to expand the cells to an open state) and a force of about 16-20 lbs to tear the expandable slit sheet paper. Thus, the present inventor discovered that an expandable slit sheet paper can be created that has vastly superior tensile strength (e.g., enabling the supporting of substantially increased tensile loads prior to tearing) by reduction of the slit pattern sizes, which the present inventor discovered as being possible by the employment of paper having sufficient extensibility. Moreover, the present inventor further discovered that expandable slit sheet paper can, thus, be created that advantageously operates as a pallet wrap in common pallet wrap environments.

Additionally, the present inventor also discovered that expandable slit sheet papers having reduced slit pattern sizes also achieved other novel and advantageous features having particular utility and advantages in the context of pallet wrapping.

Firstly, by the reduction of the slit pattern sizes, the expansion thickness of the expanded slit sheet paper is substantially reduced. As a result, in wrapping of pallets with such expandable slit sheet paper, the overall diameter of the wrapped pallet is more minimally increased due to the added layering of the expandable slit sheet paper surrounding the pallet. For example, with Example I in Table A having 0.25 inch long slits, the row spacing of 0.0625 inches (i.e., 1/16 inch), leads to an expansion width of approximately 1/16 inch, which is significantly narrower than that of an existing 0.5 inch long slit pattern. Towards that end, as pallets are employed within shipping and/or storage contexts, minimizing increase in dimensions of a wrapped pallet can greatly facilitate sizing, storage, handling and management of wrapped pallets, which are often required to be maintained within limited and/or very particularly sized spaces and environments. By way of example, in some illustrative examples, pallets have common dimensions with a supporting surface area of about 3 foot by 3 foot or greater, such as, e.g., in some examples, approximately 40 inches×48 inches, or in some examples of approximately 42 inches by 48 inches. Additionally, in some embodiments, pallet assemblies are stacked at a height of about 3 foot or greater, such as, e.g., being stacked at a maximum height of about 40 inches high, or, in some examples, at a maximum of about 50 inches high, or, in some examples, at a maximum of about 70 inches high. Accordingly, minimization of the added thickness caused by wrapping of expanded slit sheet paper can facilitate meeting and maintaining appropriate sizes requirements.

Secondly, the present inventor also discovered that expandable slit sheet papers having reduced slit pattern sizes can achieve unique expansion characteristics having advantages in the context of wrapping pallets.

First, the present inventor discovered that the reduced sized slit patterns enables the expandable slit sheet paper to hyper expand, such that the overall length of expansion can be significantly increased. For example, while an existing expandable slit sheet paper having a pattern of 0.5 inch long slits generally increases in length by about 67% to full expansion, expandable slit sheet papers having reduced slit pattern sizes can be hyper expanded beyond such 67% expansion. For example, the present inventor discovered that expandable slit sheet papers having reduced pattern sizes can be created that can be hyper expanded by at least 10% more than the 67% expansion of existing expandable slit sheet paper. Moreover, the present inventor discovered that expandable slit sheet papers having reduced pattern sizes can be created that can be hyper expanded by at least 15% more than the 67% expansion of existing expandable slit sheet paper. Moreover, the present inventor discovered that expandable slit sheet papers having reduced pattern sizes can be created that can be hyper expanded by at least 20% more than the 67% expansion of existing expandable slit sheet paper. Moreover, the present inventor discovered that expandable slit sheet papers having reduced pattern sizes can be created that can be hyper expanded by at least 25% more than the 67% expansion of existing expandable slit sheet paper.

Furthermore, the present inventor also discovered that such additional expansion is highly advantageous in the context of wrapping of pallets. Among other things, the present inventor discovered that when pallets having substantially rectangular configurations are relatively rotated, as schematically shown in FIG. 13, the perimeter of the rectangular pallet rotates between positions 10-1 of the pallet 10′ and positions 10-2 of the pallet 10′, wherein the expandable slit sheet paper 510′ fed from the roll 210′ similarly oscillates between angular positions 510-1 and 510-2. In that manner, such rotation can lead to increased expansion of the expandable slit sheet paper as it wraps around the pallet (e.g., due to the increased lateral distance of the lower corner of the pallet in position 10-2). Accordingly, the present inventor's novel expandable slit sheet paper's enhanced ability to expand and to hyper expand is highly advantageous in the context of pallet wrapping.

Second, the present inventor discovered that the reduced sized slit patterns enable the expandable slit sheet paper to hyper expand to an expansion state in which the expandable slit sheet paper does not retract or minimally retracts from an expanded state. Towards that end, with existing expandable slit sheet paper, when an expandable slit sheet paper is expanded from an initially unexpanded state to a fully expanded state with cells of the expandable slit sheet paper in an open position, the expanded paper exerts a retractive force seeking to cause the expanded slit sheet paper to retract from the fully expanded state. Among other things, due to the expansion of the reduced sized slit patterns to such a novel state in which the expandable slit sheet paper does not retract or minimally retracts from an expanded state, the cushioning afforded by the expandable slit sheet paper wrap around the pallet can be well maintained even in the even tensile forces are alleviated along a region of the wrapped expandable slit sheet paper around the pallet (such as, e.g., due to shifting of the wrapped items, such as, e.g., boxes, on the pallet).

In some most preferred embodiments, a pallet wrap system similar to that shown in FIG. 5 or 6 can be employed to wrap an expanded slit sheet paper without a mechanism for wrapping a support wrap 520. That is, in the embodiments shown in FIGS. 5 and 6, the systems can omit the support wraps 520, 520a and the corresponding rolls 220, 220a, such that the systems are configured to wrap the pallet wrap 510, 510a without any required support wrap.

Moreover, in some embodiments, systems and methods for wrapping pallets with stretch wrap film can be retrofitted to replace stretch wrap film applied with such systems with expandable slit sheet paper according to embodiments of the present invention. For example, in some embodiments, systems and methods described in the patents and publications incorporated herein by reference above can be retrofitted to replace the shrink wrap rolls of plastics or elastomeric materials with expandable slit sheet material according to be embodiments of the present invention. In some embodiments, in order to facilitate full expansion of the expandable slit sheet paper from an existing pallet wrap device that is configured for wrapping of plastic or elastomeric materials, a resistance breaking mechanism can be added to adjust a breaking or resistance to rotation of the roll (e.g., similar to the below-described breaking mechanism in the pallet wrap device 200e shown in FIG. 14) to facilitate expansion. Additionally, in some embodiments in order to facilitate feeding or expanding of expandable slit sheet material from a roll, one or more guiding rollers can be added to facilitate feeding or expanding of the expandable slit sheet paper material.

Thus, in some embodiments, by providing an expandable slit sheet paper material that can be used as a pallet wrap without a required additional support wrap, existing pallet wrap systems can readily be retrofitted by replacing the prior plastic or elastomeric material rolls with embodiments of the novel expandable slit sheet paper rolls of the present invention.

For example, FIG. 15 is a schematic perspective view showing an illustrative embodiment of retrofitting an existing pallet wrap machine that does not dispense expandable slit sheet paper to become a pallet wrap machine that dispenses expandable slit sheet paper according to an embodiment of the present invention. As shown, an existing automated pallet wrap machine, which includes a rotated platform for rotatably supporting a pallet assembly, a vertical support frame that supports a vertically reciprocated roll supporter (e.g., movable up and down along a vertical track or shaft), can be retrofitted to support a roll of expandable slit sheet paper and to include enhanced controls to facilitate dispensing and expansion of the roll of expandable slit sheet paper. For example, as shown, the control unit can be upgraded to include an add on control for a brake (e.g., a pneumatic or other type of control), which brake can be employed to enhance the control of the braking or rotation resistance of the roll of expandable slit sheet paper, such that the paper can be pulled under sufficient tensile force to ensure expansion of the expandable slit sheet paper as it is fed to the periphery of the pallet assembly, while limiting the tensile forces to below the tearing strength of the expandable slit sheet paper. Thus, the control for the brake should apply a tension that is in between the force required to open the cells of the expandable slit sheet paper and the force at which the expandable slit sheet paper would tear. Exemplary forces of some illustrative embodiments are described within this disclosure. As also described in this disclosure, in contrast to prior expandable slit sheet papers, in some preferred embodiments, expandable slit sheet papers are created that have substantially greater tensile strengths than that of prior expandable slit sheet papers, enabling the ability to retrofit pallet wrap machines for the dispensing of expandable slit sheet paper as a pallet wrap in some advantageous embodiments.

Accordingly, by retrofitting of existing pallet wrap machines and devices that do not dispense expandable slit sheet paper, not only can environmentally safe and beneficial pallet wrap according to embodiments of the present invention be employed, but existing machines and devices can be retained rather than creating waste due to obsolete/discarded machinery. Additionally, substantial cost savings can be achieved in upgrading to healthier and more environmentally friendly systems and methods, which can greatly facilitate and incentivize conversion to new environmentally safe and beneficial pallet wrap systems and methods according to embodiments of the present invention.

In some other embodiments, while FIGS. 5 and 6 depict automated pallet wrapping equipment, in some embodiments pallet wrap materials of the present invention can be implemented with manually operated pallet wrapping devices. For example, as shown in FIG. 14, in some embodiments, a manually operated pallet wrap device 200e can be provided that supports a roll 210e of expandable slit sheet paper according to embodiments of the present invention. In some embodiments, such a manually operated pallet wrap device 200e can essentially have two handles on opposite ends of the roll 210e (as shown), and the device can include an internal breaking mechanism that resists rotation of the of the roll 210e such that upon manually pulling of the expandable slit sheet material 510e, the cells of the expandable slit sheet material are caused to expand into an open state. In this manner, as shown in FIG. 14, a user U can manually wrap a pallet assembly 10e on a pallet 110e as shown. In some embodiments, the pallet 110e can be stationary upon a floor or support. Alternatively, in some embodiments, the pallet 110e can be rotated via a rotational device or mechanism similar to that shown in FIG. 5 or 6.

As with the automated embodiments described above, in some embodiments, existing manually operated pallet wrapping devices which are known in the art for wrapping of shrink wrap rolls of plastics or elastomeric materials can be retrofitted with expandable slit sheet paper according to be embodiments of the present invention. In some embodiments, in order to facilitate full expansion of the expandable slit sheet paper from an existing pallet wrap device that is configured for wrapping of plastic or elastomeric materials, a resistance breaking mechanism can be added to adjust a breaking or resistance to rotation of the roll to facilitate expansion. By way of example, in some embodiments, one or more of the systems and methods (e.g., hand-held dispensers) as set forth in the following patents and publications can be retrofitted to dispense expandable slit sheet paper according to embodiments of the present invention described herein-above: U.S. Patent Publication No. 2015/0183542 (Hand Dispenser for Stretch Wrap); U.S. Pat. No. 4,477,037 (Stretch-Wrap Film Dispenser); U.S. Pat. No. 7,937,915 (Hand Dispenser for Stretch Wrap); U.S. Pat. No. 7,357,349 (Stretch Film Dispenser with Auxiliary Stand Device); U.S. Pat. No. 4,630,786 (Apparatus for Dispensing Plastics Stretch Film); U.S. Pat. No. 4,484,717 (Stretch-Wrap Film Dispenser with Single Digit Tension Control), the entire disclosures of each of which preceding patents and publications are all incorporated by reference herein as if recited herein in full.

### Illustrative Non-Slit Pallet Wrap Embodiments

Although the most-preferred embodiments of the present invention employ an expandable slit-sheet material as described herein-above, in some embodiments and pallet wrap can be provided from a sheet of non-slit material. For example, in some embodiments, a sheet of extensible paper can be employed that does not include an array of slits that open into expanded cells. In some embodiments, the sheet of extensible paper can have extensibility values (i.e., % extensibility values) similar to any of the exemplary embodiments described herein. In some embodiments, the sheet of extensible paper has a high level of extensibility, such that a level of extensibility of embodiments described herein with a greater extensibility can be employed in some embodiments. For example, in some embodiments, the extensibility can be greater than 6% in a machine direction, and, in some embodiments, the extensibility can be greater than 7% in a machine direction, and, in some embodiments, the extensibility can be greater than 8% in a machine direction, and, in some embodiments, the extensibility can be greater than 9% in a machine direction, and, in some embodiments, the extensibility can be greater than 10% in a machine direction, and, in some embodiments, the extensibility can be greater than 11% in a machine direction, and, in some embodiments, the extensibility can be greater than 12% in a machine direction, and, in some embodiments, the extensibility can be greater than 13% in a machine direction, and, in some embodiments, the extensibility can be greater than 14% in a machine direction, and, in some embodiments, the extensibility can be greater than 15% in a machine direction.

In some embodiments in which a pallet wrap is provided from a sheet of non-slit material, a support wrap according to one of more of the embodiments herein can also be provided; by way of example, in some embodiments, supporting fibers or filaments similar to the support filaments 520c shown in FIG. 9 can be employed.

However, as described herein-above, in the most preferred embodiments, a slit-sheet material is advantageously employed for the structure of the pallet wrap.

### Additional Illustrative Extensible Papers and Sheet Materials

As set forth above under the section entitled “Illustrative Extensible Paper Employed in Some Preferred Embodiments” and other sections above, various embodiments of the present invention can employ any of the various extensible papers and methods for manufacture thereof described herein-above and in the numerous patents and publications incorporated herein-above by reference. Additionally, various embodiments of the present invention can employ any of the various extensible papers and methods for manufacture thereof described in the following additional patents and publications, which are all incorporated herein by reference in their entireties:
1. U.S. Pat. No. 3,523,865, entitled Method of Producing Extensible Paper;
2. U.S. Pat. No. Re. 25,335, entitled Extensible Paper Product and Process;
3. U.S. Pat. No. 3,329,562, entitled Apparatus for Producing Uncreped Extensible Paper;
4. U.S. Pat. No. 3,447,453, entitled Paper Machinery;
5. U.S. Pat. No. 8,603,597, entitled Sack Paper with Vapour Barrier;
6. U.S. Pat. No. 2,996,425, entitled Extensible Paper Product and Process;
7. U.S. Patent Pub. No. 2021/0102337, entitled High Stretch Paper and Method of Producing the Same;
8 Zeng, X., Vishtal, A., Retulainen, E., Sivonen, E., and Fu, S., “The elongation potential of paper—How should fibres be deformed to make paper extensible?” BioRes. 8 (1), 472-486 (2013).
9. Ulla Lainio, “Natural and Synthetic Fibres Improving Tensile Strength and Elongation of Paper Products,” (https://urn.fi/URN: NBN: fi-fe201008112300) (2010).
10. Kouko, J., Turpeinen, T., Kulachenko, A., Hirn, U. and Retulainen, E., “Understanding extensibility of paper: Role of fiber elongation and fiber bonding.” Tappi J, 19 (3), pp. 125-135 (2020).
11. Strand, A., Kouko, J., Oksanen, A., Salminen, K., Ketola, A., Retulainen, E. and Sundberg, A., “Boosting the elongation potential of paper by mechanical refining and additives,” In Paper Conference and Trade Show, PaperCon, (pp. 761-770), TAPPI Press (2018).
12. Alexey Vishal, et al., “Boosting the Extensibility Potential of Fibre Networks: A Review,” Bioresources 9 (4), DOI: 10.15376/biores.9.4.7951-8001 (September 2014).
13. Franz J. Schmied, et al., “A Method for Preparing Extensible Paper on the Laboratory Scale,” Nordic Pulp and Paper Research Journal Vol. 29 no (2) (pp. 317-321) (June 2014).

In various embodiments, extensibility can be determined employing various methods well known in the paper industry. As described herein-above, in some embodiments, extensibility % values can be determined according to Technical Association of the Pulp and Paper Industry (TAPPI) standards. With respect to the above-noted TAPPI T-457 standard, it should be appreciated that TAPPI 457 has since been combined into TAPPI T-404 by TAPPI. In some embodiments, extensibility %'s correspond to elongation % at rupture. For reference, tensile breaking strength is determined to be the maximum value of stress that occurs when the paper ruptures or tears. Elongation at rupture is the measure of the maximum percentage of stretch, or the maximum strain, that the paper can achieve before failure. Tensile strength can be described by stress-strain graphs and measured by TAPPI tests T-404 and T-494. Stress-strain curves provide a fundamental engineering description of the mechanical behavior of paper when subjected to tensile stress. TAPPI method T-404 measures tensile breaking strength end elongation of paper and paperboard using a pendulum-type tester, and T-494 measures tensile breaking properties of paper and paperboard using constant rate of elongation apparatus. TAPPI tensile strength tests of paper. TAPPI tests T-404 and T-494 are useful in evaluating the tensile properties of paper. TAPPI T-494 enables the simultaneous evaluation of three properties for the same test specimen: tensile breaking strength, stretch or elongation at break, and TEA (tensile energy absorption).

In some embodiments, extensibility can be determined according to ISO 1924 of the International Organization for Standardization (www.iso.org), which specifies a method for measuring the tensile strength, strain at break and tensile energy absorption of paper and board, using a testing machine operating at a constant rate of elongation (20 mm/min). This part of ISO 1924 also specifies equations for calculating the tensile index, the tensile energy absorption index and the modulus of elasticity.

According to some embodiments, the %'s of extensibility in various embodiments described herein correspond to extensibility values as determined under one or more of the TAPPI tests. According to some embodiments, the %'s of extensibility in various embodiments described herein correspond to extensibility values as determined under one or more of the ISO tests.

Although a variety of paper materials can be employed in various embodiments, in some embodiments, an extensible paper is provided that is formed with or from hemp in view of hemp's natural extensibility. Hemp paper can be made exclusively or with a significant amount of pulp obtained from fibers of industrial hemp. Hemp fibers can be substantially longer than wood pulp fibers, and have a higher tear resistance and tensile strength. See Wikipedia, Hemp Paper. Additionally, hemp fibers have significant resistance to decomposition, are highly recyclable, and is advantageously a fast crop to yield.

In some embodiments, extensible papers can be made with virgin fibers, such as, e.g., virgin wood fibers, such as, e.g., virgin fibers from Pine and/or Spruce or other woods. In some embodiments, extensible papers can be made with recycled fibers.

In some embodiments, an extensible paper can be a single layer or a multi-layer paper, such as, e.g., with 2, 3 or 4 layers, or even more layers.

In some embodiments, an extensible paper can be made from unbleached softwood kraft pulp. In some examples, during manufacture a stock preparation system and paper machine are adapted such that the stock preparation system includes a high consistency refining system and the paper machine includes a Clupak unit. In some illustrative implementations, pulp from an unbleached high-density storage tower is set to the paper machine where it is thickened (e.g., from around 6% consistency to about 32-35% in some examples). This can be done in a press (such as, e.g., a twin-wire, screw press, roll press, etc.). After the press, the fiber is sent to the high consistency refiner. The refiner applies energy into the paper, without relevant changes in the fiber length, but adding many curls, kinds, and compressions in the fiber anatomy (such as, e.g., applying about 280-300 kWh/ton of energy to the paper in some examples). The structural changes in the fiber make them stronger and more flexible. At the paper machine, there is a unit, the Clupak unit, responsible to create micro-compressions in the paper to develop the stretch ability (e.g., extensibility). In some embodiments, the Clupak unit includes a chromium plated dryer cylinder heated by steam to enable slipping of the paper, an endless rubber blanket with a circuit of guide and stretch rolls, a non-rotating nip bar with an approaching and separating pneumatic system and a blanket rectifier.

In some embodiments, extensible papers employed in the packaging industry as extensible sack paper can be employed. By way of example, various extensible sack papers in the market related to one or more of the following companies can be employed in some illustrative embodiments: Segezha Group, Stora Poland S.A., Starkraft, KapStone Paper and Packaging Corporation, BillerudKorsnas, Swedpaper, Natron-Hayat d.o.o. Maglaj, WestRock, Nordicpaper, Horizon Pulp and Paper Ltd., Primo Tedesco.

Additionally, in some illustrative and non-limiting examples, extensible papers provided by Mondi (see www.mondigroup.com) and Canadian Kraft Paper (see www.canadiankraftpaper.com) have been employed by the present inventor for manufacture of pallet wrap according to some illustrative embodiments of the present invention, in which such papers have been adapted by the present inventor to include slit patterns as described herein. In some illustrative examples, the paper products set forth in the following tables of Examples A, B and C below have been adapted by the present inventor to include slit patterns to form expandable slit sheet papers for pallet wrapping. While the following paper products can be employed in the manufacture of some illustrative exemplary embodiments of the present invention, it should be appreciated that various other embodiments of the invention can be created with various other paper products in accordance with the present disclosure.

Example A:
Paper Product Name (Company): Advantage MF SpringPack Plus ™ (Mondi)
Materials: Produced from pure, unbleached long-fibre pulp.

| | | | | | | | | | Test |
|---|---|---|---|---|---|---|---|---|---|
| Properties | Units | | | | | | | | Method |
| Basis Weight | g/m² | | 110 | 120 | 130 | 140 | 150 | 160 | ISO 536 |
| Thickness | μm | | 150 | 165 | 180 | 190 | 210 | 220 | ISO 534 |
| Bending | mN | MD | 115 | 140 | 155 | 200 | 240 | 270 | ISO 2493 |
| Resistance | | CD | 110 | 130 | 145 | 170 | 200 | 250 | |
| Tensile | kN/m | MD | 13.7 | 15.1 | 16.2 | 17.2 | 18.7 | 19.5 | ISO 1924-3 |
| Strength | | CD | 5.5 | 5.9 | 6.5 | 6.9 | 7.5 | 8.0 | |
| Stretch | % | MD | 12.5 | 12.5 | 12.5 | 12.5 | 12.5 | 12.5 | ISO 1924-3 |
| (extensibility) | | CD | 9.4 | 9.4 | 9.4 | 9.4 | 9.4 | 9.4 | |
| TEA | J/m² | MD | 750 | 820 | 890 | 960 | 1020 | 1080 | ISO 1924-3 |
| | | CD | 340 | 370 | 400 | 430 | 465 | 490 | |
| Tear | mN | MD | 1300 | 1350 | 1600 | 1800 | 1950 | 2050 | ISO 1974 |
| Strength | | CD | 2050 | 2250 | 2600 | 2900 | 3000 | 3350 | |
| Burst | kPa | | 740 | 770 | 830 | 840 | 880 | 920 | ISO 2758 |
| Strength | | | | | | | | | |
| Cobb₆₀ | g/m² | | 28 | 28 | 28 | 28 | 28 | 28 | ISO 535 |
| Roughness | ml/min | Ts | 3000 | 4700 | 4900 | 5000 | 5100 | 5200 | ISO 2494 |
| Bendtsen | | Ws | 1700 | 2100 | 2400 | 2600 | 3000 | 3300 | |

| | | | | | | | | |
|---|---|---|---|---|---|---|---|---|
| Moisture | % | 8.0 | 8.0 | 8.0 | 8.0 | 8.0 | 8.0 | ISO 287 |

MD = Machine Direction.
CD = Cross Direction.
Test Conditions: ISO 554-1976 (Temp. = 23 +/− 1° C. Relative Humidity = 50% +/− 2%).

Example B:
Paper Product Name (Company): SPX ™ (Canadian Kraft Paper)
Materials: Produced from unbleached kraft pulp, and includes
100% Northern Canadian virgin fibre.

| | | | | | | | | Test |
|---|---|---|---|---|---|---|---|---|
| Properties | Units | | | | | | | Method |
| Basis Weight | lbs/3000 ft² | | 43 | 50 | 52 | 55 | 58 | ISO 536 |
| Tensile | lbs/in. | MD | 35.4 | 40.5 | 43.4 | 45.7 | 48.5 | ISO 1924-3 |
| | | CD | 25.7 | 29.1 | 30.8 | 33.1 | 34.3 | |
| Tensile | Nm/g | MD | 89 | 89 | 89 | 89 | 89 | ISO 1924-3 |
| Index | | CD | 64 | 64 | 64 | 64 | 64 | |
| Stretch | % | MD | 6.8 | 6.8 | 6.8 | 6.8 | 6.8 | ISO 1924-3 |
| (extensibility) | | CD | 8.9 | 8.9 | 8.9 | 8.9 | 8.9 | |
| TEA | ft lb/ft² | MD | 15.1 | 17.1 | 18.2 | 19.2 | 20.2 | ISO 1924-3 |
| | | CD | 16.8 | 18.8 | 19.9 | 20.9 | 21.9 | |
| TEA Index | J/g | MD | 3.1 | 3.1 | 3.1 | 3.1 | 3.1 | ISO 1924-3 |
| | | CD | 3.4 | 3.4 | 3.4 | 3.4 | 3.4 | |
| Tear | G | MD | 85 | 90 | 100 | 110 | 120 | ISO 1974 |
| | | CD | 95 | 100 | 105 | 120 | 130 | |
| Air | sec/100 cc | | 15 | 15 | 15 | 15 | 15 | ISO 5636-5 |
| Resistance | g/m²/min | | 30 | 30 | 30 | 30 | 30 | ISO 535 |
| Cobb | % | | 7.5 | 7.5 | 7.5 | 7.5 | 7.5 | ISO 287 |
| Moisture | | | | | | | | |

MD = Machine Direction.
CD = Cross Direction.
Paper Test Conditions: Temperature = 73.4 +/− 1.8° F. Relative Humidity = 50% +/− 2%.

Example C:
Paper Product Name (Company): SPX-Velocity Premier ™ (Canadian Kraft Paper)
Materials: Produced from unbleached kraft pulp, and includes
100% Northern Canadian virgin fibre.

| | | | | | | | Test |
|---|---|---|---|---|---|---|---|
| Properties | Units | | | | | | Method |
| Basis Weight | lbs/3000 ft² | | 43 | 50 | 52 | 55 | ISO 536 |
| Tensile | lbs/in. | MD | 32.5 | 36.5 | 39.4 | 41.1 | ISO 1924-3 |
| | | CD | 26.8 | 30.8 | 33.7 | 35.4 | |
| Tensile | Nm/g | MD | 80 | 80 | 80 | 80 | ISO 1924-3 |
| Index | | CD | 68 | 68 | 68 | 68 | |
| Stretch | % | MD | 8.0 | 8.1 | 8.1 | 8.1 | ISO 1924-3 |
| (extensibility) | | CD | 8.6 | 8.6 | 8.6 | 8.6 | |
| TEA | ft lb/ft² | MD | 16.1 | 18.5 | 19.5 | 20.9 | ISO 1924-3 |
| | | CD | 16.4 | 18.8 | 19.9 | 20.9 | |
| TEA Index | J/g | MD | 3.4 | 3.4 | 3.4 | 3.4 | ISO 1924-3 |
| | | CD | 3.4 | 3.4 | 3.4 | 3.4 | |
| Tear | G | MD | 95 | 105 | 115 | 120 | ISO 1974 |
| | | CD | 100 | 110 | 120 | 125 | |
| Air | sec/100 cc | 15 | 15 | 15 | 15 | 15 | ISO 5636-5 |
| Resistance | g/m²/min | 30 | 30 | 30 | 30 | 30 | ISO 535 |
| Cobb | % | 7.5 | 7.5 | 7.5 | 7.5 | 7.5 | ISO 287 |
| Moisture | | | | | | | |

MD = Machine Direction.
CD = Cross Direction.
Paper Test Conditions: Temperature = 73.4 +/− 1.8° F. Relative Humidiy = 50% +/− 2%.

With respect to the properties set forth in the illustrative tables of the above Examples A, B and C, while such properties are applicable to some illustrative embodiments employing the extensible paper products shown in such tables, it should be appreciated that various other embodiments can have various properties in accordance with the foregoing disclosure. By way of example, in some other embodiments, extensible papers can be employed having properties similar to that shown in any of Examples A-C above + or −10% from the values shown in the tables, or, in some embodiments, + or −25% from the values shown in the tables, or, in some embodiments, + or −50% from the values shown in the tables. Additionally, in some other illustrative embodiments, extensible papers can be employed having properties that are the same or greater than the values shown in the tables of any of Examples A-C above.

Preferred Embodiments with Expandable Slit-Sheet Paper Surrounded by Paper Support Wrap

In the above disclosure, some embodiments of the present invention are described that include, e.g., wraps for pallets assemblies and the like that include a) an inner expandable slit-sheet paper that is surrounded by b) an outer paper support wrap.

For example, as explained above, “in some embodiments, the support wrap can comprise a heavy weight paper having sufficient strength to provide a sufficient support wrap under certain circumstances (i.e., a non-slit heavy paper can be employed in some embodiments). For example, in some embodiments, a support wrap (e.g., 520, 520a) can be provided by a paper having a weight of 40# or larger. For example, in some embodiments, a support wrap (e.g., 520, 520a) can be provided by a paper having a weight of 45# or larger. For example, in some embodiments, a support wrap (e.g., 520, 520a) can be provided by a paper having a weight of 50# or larger. For example, in some embodiments, a support wrap (e.g., 520, 520a) can be provided by a paper having a weight of 55# or larger. For example, in some embodiments, a support wrap (e.g., 520, 520a) can be provided by a paper having a weight of 60# or larger. For example, in some embodiments, a support wrap (e.g., 520, 520a) can be provided by a paper having a weight of 65# or larger.”

As further explained above, “[i]n some preferred embodiments, when such a heavy unslit paper is employed as the support wrap, the support wrap has a width that is substantially narrower than the width of the expandable slit sheet paper. In some embodiments, the width of such a heavy unslit paper type support wrap can be similar to that of any of the embodiments of support wrap widths described herein-above (i.e., excluding embodiments related to support wraps without paper, tape or the like, such as, e.g., some filament-only embodiments).”

As further explained above, “[i] n the preferred embodiments, the expandable slit sheet paper layer advantageously tightens everything up and provides a cushioned barrier for the outer support wrap . . . to hold everything together without bursting the support wrap . . . . In particular, in some implementations, the support wrap . . . would burst if there wasn't the flexibility underneath it provided by the expandable slit sheet material to accommodate vibrations and/or slight load shifts of the pallet assembly.”

As further explained above, “[i] n some preferred embodiments, a plurality of support wraps are provided across the widthwise direction of the expandable slit sheet. . . . . Alternatively, in some embodiments, a single support wrap can be provided across the widthwise direction of the expandable sheet. Moreover, in some embodiments, on average, less than one support wrap can be applied per across the widthwise direction of the expandable sheet (such as, e.g., in some variations of the embodiment in FIG. 6 in which the support wrap can be spread out more widely around the periphery of the pallet assembly).”

As further explained above, “[i]n some of the more preferred embodiments, a support wrap is used which substantially enhances the tensile load that can be sustained by the pallet wrap of the present invention. Notably, once a layer of expanded slit sheet paper is applied around the pallet assembly, the cushioning provided by the expanded slit sheet paper will provide a cushioning barrier that enables a higher tension to be applied. Notably, a pallet assembly often has irregularities in shape (such as, e.g., related to variations in box sizes and shapes within the pallet assembly on the pallet) and configuration that can lead to tearing of the pallet wrap. However, the expandable slit sheet paper can advantageously provide a barrier cushion that enables the pallet wrap to sustain a greater tensile load without breakage. In some embodiments, with, for example, a pallet assembly having higher degrees of irregularities in shape (e.g., due to varied box sides and shapes), an initial layer or plural initial layers of expandable slit sheet paper can be applied at a reduced tensile load, and then one or more outer layer of expandable slit sheet paper can be applied at a higher tensile load. Towards that end, the interior layer(s) of expandable slit sheet paper at a reduced tensile load can provide a cushioning barrier that enables a higher tensile load to be borne by the outer layer(s). In some preferred embodiments, the above %'s of expandable slit sheet paper at or near the noted loads can relate to the outer layers rather than the inner layers that are applied to create a cushioning that enables application of such higher tensile loads in the outer layer(s).”

As also explained above, “[i] n some embodiments, the expandable slit sheet paper 510 can be initially applied around a portion or all of the pallet assembly 10a prior to wrapping of the support wrap 520.”

In some preferred implementations of embodiments in which an outer paper support wrap is provided around an interior expandable slit sheet paper, the outer paper support wrap can include an extensible paper. In some of the preferred embodiments, the extensible paper employed for the outer paper support wrap can include any of the extensible papers described herein-above (e.g., in some embodiments, any of the extensible papers employed for making expandable slit sheet paper can be employed as the outer support wrap).

In some illustrative embodiments, a support wrap of non-slit extensible paper preferably has a relatively higher level of extensibility. For example, in some embodiments, the extensibility can be greater than 6% in a machine direction, and, in some embodiments, the extensibility can be greater than 7% in a machine direction, and, in some embodiments, the extensibility can be greater than 8% in a machine direction, and, in some embodiments, the extensibility can be greater than 9% in a machine direction, and, in some embodiments, the extensibility can be greater than 10% in a machine direction, and, in some embodiments, the extensibility can be greater than 11% in a machine direction, and, in some embodiments, the extensibility can be greater than 12% in a machine direction, and, in some embodiments, the extensibility can be greater than 13% in a machine direction, and, in some embodiments, the extensibility can be greater than 14% in a machine direction, and, in some embodiments, the extensibility can be greater than 15% in a machine direction. For example, in some embodiments, the extensibility can be between 6%-20% in a machine direction, and, in some embodiments, the extensibility can be between 7%-20% in a machine direction, and, in some embodiments, the extensibility can be between 8%-20% in a machine direction, and, in some embodiments, the extensibility can be between 9%-20% in a machine direction, and, in some embodiments, the extensibility can be between 10%-20% in a machine direction, and, in some embodiments, the extensibility can be between 11%-20% in a machine direction, and, in some embodiments, the extensibility can be between 12%-20% in a machine direction, and, in some embodiments, the extensibility can be between 13%-20% in a machine direction, and, in some embodiments, the extensibility can be between 14%-20% in a machine direction, and, in some embodiments, the extensibility can be between 15%-20% in a machine direction. In the most preferred embodiments, the extensibility of the paper support wrap is greater than 8% in the machine direction, and, more preferably, greater than 10% in the machine direction.

As with various embodiments of the expandable slit sheet paper discussed above, in some illustrative examples, a support wrap can be provided that is an extensible paper (e.g., any of the extensible papers described herein), wherein said extensible paper has a weight from about 30 to 70 pounds per 3,000 sq. ft. And, notably, all of the embodiments of the invention described herein can be employed in various implementations of papers with weights within this range in some embodiments, such as, e.g., on 30# paper, 40# paper, 50# paper, 60# paper, 65# paper, and on any papers within this range. Moreover, as with various embodiments of the expandable slit sheet paper discussed above, in other embodiments, papers for support wrap can be employed lower than this range of 30# to 70#, such as, e.g., 20# or less, or larger than this range, such as, e.g., 60# or more. As also explained above, in this application, where paper is referred to by weight in pounds (e.g., #), it should be understood that such weight in pounds indicates the listed number of pounds as per 3,000 square feet (e.g., sq. ft.). Accordingly, e.g., a 50# paper should be understood as corresponding to 50 pounds per 3,000 square feet.

In some illustrative and non-limiting embodiments, a support wrap is provided that includes any of the papers described in Canadian Patent Application No. 3195677, filed Mar. 24, 2023, which is a national stage entry of PCT Application No. PCT/AT2021/060327, filed Sep. 15, 2021, to Mondi AG, which claims priority to Austria Application No. AT50785/2020, filed Sep. 16, 2020, the entire disclosures of which applications are incorporated herein by reference as if recited herein in full. In some embodiments, the support wrap is made with a pallet outer packaging paper as taught in the preceding patent applications of Mondi AG having an extensibility in the machine direction of 8% to 15% in accordance with ISO 1924-3:2005, and, in some embodiments, the support wrap is made with a pallet outer packaging paper as taught in the preceding patent applications of Mondi AG having an extensibility in the transverse or cross direction of 8% to 15% in accordance with ISO 1924-3:2005.

In some preferred embodiments, a pallet wrap is provided that includes at least one expandable slit sheet paper interior layer(s) that surrounds a perimeter of a pallet and that includes at least one paper support wrap exterior layer(s) that surrounds the expandable slit sheet paper, and, most preferably, wherein the expandable slit sheet paper interior layer(s) is made with an extensible paper and wherein the paper support wrap exterior layer(s) is made with an extensible paper (as set forth above).

In some preferred embodiments, the provision of layers of both such expandable slit sheet paper interior layer(s) and such paper support wrap exterior layer(s) achieves advantageous results not independently achievable with each such individual layer(s) by themselves. For example, an unslit extensible paper, such as that described in the above patent applications of Mondi AG can achieve a significant tensile strength due, e.g., to the lack of slits extending through the unslit extensible paper. However, such an unslit extensible paper is unable to sufficiently adapt to the contour of irregular, sharp, and/or pointed surfaces of boxes or the like within a pallet assembly, whereby when such an unslit extensible paper is employed by itself, there is an increased risk that the unslit extensible paper will tear and, thus, fail to properly support a pallet assembly. On the other hand, an expandable slit sheet extensible paper can advantageously adapt to the contour of irregular, sharp, and/or pointed surfaces of boxes or the like within a pallet assembly, but an expandable slit sheet extensible paper may not have as substantial tensile strength as an unslit extensible paper.

For example, in some embodiments in which a pallet wrap is implemented that employs only an expandable slit sheet paper, it may be desirable to wrap additional layers of extensible slit sheet paper around the perimeter of the pallet assembly to increase the tensile forces sustained by the pallet wrap (e.g., which can lead to increase paper usage and, hence, increased costs). On the other hand, in some embodiments that employ an interior layer or layers of extensible slit sheet paper and an exterior layer or layers of unslit extensible paper, the overall paper usage can be reduced, while concurrently improving the overall functionality and utility of the pallet wrap by a) reducing the potential that the pallet wrap may tear due to contact with the contour of irregular, sharp, and/or pointed surfaces of boxes or the like within a pallet assembly (e.g., by employing the interior layer(s) of extensible slit sheet paper) and by b) providing a pallet wrap with increased tensile strength and improved load-bearing qualities (e.g., by employing the exterior layer(s) of unslit extensible paper).

Although, in the foregoing embodiments, a pallet wrap is provided having at least one expandable slit sheet paper interior layer that surrounds a perimeter of a pallet and having at least one paper support wrap exterior layer that surrounds the expandable slit sheet paper, wherein the expandable slit sheet paper interior layer(s) is most preferably made with an extensible paper and wherein the paper support wrap exterior layer(s) is most preferably made with an extensible paper, in some less preferred embodiments, either a) the expandable slit sheet paper interior layer(s) can be made with a non-extensible paper and the paper support layer(s) can be made with an extensible paper or b) the expandable slit sheet paper interior layer(s) can be made with an extensible paper and the paper support layer(s) can be made with a non-extensible paper.

In some of the most preferred embodiments, the pallet wrap will include both a) the at least one expandable slit sheet paper interior layer wrapped around the entire or substantially the entire peripheral side surfaces of the pallet and b) the at least one paper support wrap exterior layer wrapped around the entire or substantially the entire peripheral side surfaces of the pallet, whereby both the expandable slit sheet paper interior layer(s) and the paper support exterior layer(s) surround the entire or substantially the entire peripheral side surfaces of the pallet. In some embodiments, the expandable slit sheet paper interior layer(s) and the paper support wrap exterior layer(s) extend over the top side of the pallet assembly at least around the periphery adjacent the peripheral side surfaces of the pallet.

In some preferred embodiments, in the wrapping of a pallet assembly with the at least one expandable slit sheet paper layer and with the at least one paper support wrap layer, some regions around the periphery of the pallet assembly will not include one or more of the layers (e.g., some regions around the periphery of the pallet assembly can include both layers, including at least one expandable slit sheet paper layer and at least one paper support wrap layer, while some regions can including only a single layer comprising either only the at least one expandable slit sheet paper layer or the at least one paper support wrap layer). For example, in some embodiments, an expandable slit sheet paper layer can be wrapped around the periphery of the pallet assembly with particular positioning of the expandable slit sheet paper around peripheral regions of the pallet assembly having contours of irregular, sharp, and/or pointed surfaces of boxes or the like (such as, e.g., around top corners or otherwise exposed corners of boxes or the like), while omitting the expandable slit sheet paper around some regions of the pallet assembly that are free of such contours of irregular, sharp, and/or pointed surfaces, while the paper support wrap can be wrapped around the entire or substantially the entire periphery of the pallet assembly or, e.g., around the entire or substantially the entire peripheral sides of the pallet assembly.

In various embodiments of the invention, features as set forth in one or more of the following numbered paragraphs can be provided:

1. In some embodiments, a pallet wrap can be provided, comprising:
an expandable slit sheet paper having a slit pattern including a plurality of slits extending in a cross direction that forms a plurality of open cells upon expansion in a machine direction, and
a non-slit paper support wrap,
wherein said expandable slit sheet paper is configured to be wrapped around a pallet assembly and said paper support wrap is configured to surround at least a portion of said expandable slit sheet paper wrapped around said pallet assembly.

2. In some embodiments, the pallet wrap of paragraph 2 can further include wherein said expandable slit sheet paper is made with an extensible paper.

3. In some embodiments, the pallet wrap of paragraphs 1 or 2 can further include wherein said paper support wrap is made with an extensible paper.

4. In some embodiments, a combination can be provided including:
a) the pallet wrap of any of the preceding numbered paragraphs; and
b) a pallet assembly, with said pallet wrap being wrapped around said pallet assembly with said expandable slit sheet paper wrapped around the periphery of the pallet assembly and the support wrap surrounding at least a portion of said expandable slit sheet paper wrapped around said pallet assembly.

5. In some embodiments, a method can be performed comprising:
a) providing the pallet wrap of any of paragraphs 1-3; and
b) wrapping said pallet wrap around a pallet assembly with said expandable slit sheet paper wrapped around the pallet assembly and said paper support wrap surrounding said expandable slit sheet paper wrapped around said pallet assembly.

6. In some embodiments, the method of paragraph 5 can further include wherein said expandable slit sheet paper surrounds substantially the entire perimeter of said pallet assembly.

7. In some embodiments, the method of any of paragraphs 5 or 6 can further include wherein said paper support wrap surrounds substantially the entire perimeter of said pallet assembly.

8. In some embodiments, the method of any of paragraphs 5 to 7 can further include wherein said wrapping said pallet wrap around the pallet assembly includes relatively moving a roll of said expandable slit sheet paper with respect to a periphery of said pallet assembly and/or relatively moving a roll of paper support wrap with respect to the periphery of said pallet assembly.

9. In some embodiments, the method of paragraph 8 can further include wherein said relatively moving includes rotating said pallet assembly.

10. In some embodiments, the method of paragraph 8 can further include wherein said relatively moving includes moving said roll of said expandable slit sheet paper around the periphery of said pallet assembly.

11. In some embodiments, the method of any of paragraphs 8 or 10 include wherein said relatively moving includes moving said roll of said paper support wrap around the periphery of said pallet assembly.

12. In some embodiments, the method of paragraph 11 further includes wherein said relatively moving includes manually relatively moving said roll of said expandable slit sheet paper and/or said paper support wrap with respect to the periphery of said pallet assembly.

13. In some embodiments, the method of paragraph 11 further includes wherein said relatively moving includes automatedly relatively moving said roll of said expandable slit sheet paper and/or said paper support wrap with respect to the periphery of said pallet assembly.

14. In some embodiments, illustrative embodiments according to any of the preceding numbered paragraphs further include wherein said expandable slit sheet paper flexibly contours around corners of boxes or containers within said pallet assembly by expansion of said open cells and/or lateral twisting enabled by said open cells.

15. In some embodiments, illustrative embodiments according to any of the preceding numbered paragraphs further include wherein said paper support wrap adds tensile strength to the pallet wrap beyond the tensile strength of the expandable slit sheet paper.

16. In some embodiments, illustrative embodiments according to any of the preceding numbered paragraphs further include wherein said paper support wrap includes an extensible non-slit paper having an extensibility of the paper in a machine direction of between 5% to 20%, and, in some embodiments, of between 6% to 20%, and, in some embodiments, of between 7% to 20%, and, in some embodiments, of between 8% to 20%, and, in some embodiments, of between 9% to 20%, and, in some embodiments, of between 10% to 20%, and, in some embodiments, of between 11% to 20%, and, in some embodiments, of between 12% to 20%, and, in some embodiments, of between 12% to 20%, and, in some embodiments, of between 13% to 20%, and, in some embodiments, of between 14% to 20%, and, in some embodiments, of between 15% to 20%.

17. In some embodiments, illustrative embodiments according to any of the preceding numbered paragraphs further include wherein said paper support wrap includes an extensible non-slit paper having an extensibility of the paper in a cross direction of between 5% to 20%, and, in some embodiments, of between 6% to 20%, and, in some embodiments, of between 7% to 20%, and, in some embodiments, of between 8% to 20%, and, in some embodiments, of between 9% to 20%, and, in some embodiments, of between 10% to 20%, and, in some embodiments, of between 11% to 20%, and, in some embodiments, of between 12% to 20%, and, in some embodiments, of between 12% to 20%, and, in some embodiments, of between 13% to 20%, and, in some embodiments, of between 14% to 20%, and, in some embodiments, of between 15% to 20%.

18. In some embodiments, illustrative embodiments according to any of the preceding numbered paragraphs further include wherein said paper support wrap is a paper having a weight of at least 30#, and, in some embodiments, wherein said paper support wrap is a paper having a weight of at least 35#, and, in some embodiments, wherein said paper support wrap is a paper having a weight of at least 40#, and in some embodiments, wherein said paper support wrap is a paper having a weight of greater than 45#, and, in some embodiments, wherein said paper support wrap is a paper having a weight of greater than 50#, and, in some embodiments, wherein said paper support wrap is a paper having a weight of greater than 55#, and, in some embodiments, wherein said paper support wrap is a paper having a weight of greater than 60#.

19. In some embodiments, illustrative embodiments according to any of the preceding numbered paragraphs further include wherein said paper support wrap is a paper having a weight of between 30# to 70#, and, in some embodiments, wherein said paper support wrap is a paper having a weight of between 40# to 70#, and, in some embodiments, wherein said paper support wrap is a paper having a weight of between 45# to 70#, and, in some embodiments, wherein said paper support wrap is a paper having a weight of between 40# to 60#, and, in some embodiments, wherein said paper support wrap is a paper having a weight of between 45# to 60#.

20. In some embodiments, illustrative embodiments according to any of the preceding numbered paragraphs further include wherein said expandable slit sheet paper is made from an extensible paper having an extensibility in a machine direction, in an unslit state, of between 5% to 20%, and, in some embodiments, of between 6% to 20%, and, in some embodiments, of between 7% to 20%, and, in some embodiments, of between 8% to 20%, and, in some embodiments, of between 9% to 20%, and, in some embodiments, of between 10% to 20%, and, in some embodiments, of between 11% to 20%, and, in some embodiments, of between 12% to 20%, and, in some embodiments, of between 12% to 20%, and, in some embodiments, of between 13% to 20%, and, in some embodiments, of between 14% to 20%, and, in some embodiments, of between 15% to 20%.

21. In some embodiments, illustrative embodiments according to any of the preceding numbered paragraphs further include wherein said expandable slit sheet paper is made from an extensible paper having an extensibility in a cross direction, in an unslit state, of between 5% to 20%, and, in some embodiments, of between 6% to 20%, and, in some embodiments, of between 7% to 20%, and, in some embodiments, of between 8% to 20%, and, in some embodiments, of between 9% to 20%, and, in some embodiments, of between 10% to 20%, and, in some embodiments, of between 11% to 20%, and, in some embodiments, of between 12% to 20%, and, in some embodiments, of between 12% to 20%, and, in some embodiments, of between 13% to 20%, and, in some embodiments, of between 14% to 20%, and, in some embodiments, of between 15% to 20%.

22. In some embodiments, illustrative embodiments according to any of the preceding numbered paragraphs further include wherein said expandable slit sheet paper is a paper having a weight of at least 30#, and, in some embodiments, wherein said expandable slit sheet paper is a paper having a weight of at least 35#, and, in some embodiments, wherein said expandable slit sheet paper is a paper having a weight of at least 40#, and in some embodiments, wherein said expandable slit sheet paper is a paper having a weight of greater than 45#, and, in some embodiments, wherein said expandable slit sheet paper is a paper having a weight of greater than 50#, and, in some embodiments, wherein said expandable slit sheet paper is a paper having a weight of greater than 55#, and, in some embodiments, wherein said expandable slit sheet paper is a paper having a weight of greater than 60#.

23. In some embodiments, illustrative embodiments according to any of the preceding numbered paragraphs further include wherein said expandable slit sheet paper is a paper having a weight of between 30# to 70#, and, in some embodiments, wherein said expandable slit sheet paper is a paper having a weight of between 40# to 70#, and, in some embodiments, wherein said expandable slit sheet paper is a paper having a weight of between 45# to 70#, and, in some embodiments, wherein said expandable slit sheet paper is a paper having a weight of between 40# to 60#, and, in some embodiments, wherein said expandable slit sheet paper is a paper having a weight of between 45# to 60#.

24. In some embodiments, illustrative embodiments according to any of the preceding numbered paragraphs further include wherein:
said expandable slit sheet paper has slits with a slit length of between 0.15 inches to 0.45 inches.

25. In some embodiments, illustrative embodiments according to any of the preceding numbered paragraphs further include wherein:
said expandable slit sheet paper is configured to be wrapped concurrently with said paper support wrap.

26. In some embodiments, illustrative embodiments according to any of the preceding numbered paragraphs further include wherein:
said expandable slit sheet paper is configured to be wrapped concurrently with said paper support wrap, with said paper support wrap overlapping said expandable slit sheet paper.

27. In some embodiments, illustrative embodiments according to any of the preceding numbered paragraphs further include wherein:
said expandable slit sheet paper is configured to be wrapped independently with respect to said paper support wrap.

28. In some embodiments, illustrative embodiments according to any of the preceding numbered paragraphs further include wherein:
said expandable slit sheet paper is configured to be wrapped independently with respect to said support wrap, including at least one of:
a) said expandable slit sheet paper being supplied from a supply unit that independently raises and lowers said expandable slit sheet material from a support and that independently raises and lowers said paper support wrap with respect to said pallet assembly;
b) said expandable slit sheet paper being supplied from a supply unit that supplies said expandable slit sheet paper and said paper support wrap concurrently around said pallet assembly but at different vertical positions along the pallet assembly; and/or
c) said expandable slit sheet paper being supplied from a supply unit that supplies said expandable slit sheet paper and said paper support wrap at at least some different wrapping time sequences from one another.

29. In some embodiments, illustrative embodiments according to any of the preceding numbered paragraphs further include wherein:
said pallet assembly has a pallet with a supporting surface area of at least 3 feet by 3 feet (i.e., 36 inches by 36 inches).

30. In some embodiments, illustrative embodiments according to any of the preceding numbered paragraphs further include wherein:
said pallet assembly includes stacked items, boxes or containers extending to a height of at least 3 feet (i.e., 36 inches).

31. In some embodiments, illustrative embodiments according to any of the preceding numbered paragraphs further include wherein:
said expandable slit sheet paper is provided in a roll of expandable slit sheet paper (or other supply of expandable slit sheet paper) in an unexpanded state having a width in an unexpanded state of between about 6.0 inches and 36 inches, or, preferably, between about 7.5 inches and 30 inches, or, preferably, between about 10 inches and 25 inches, or, preferably, between about 12.5 inches and 22.5 inches.

32. In some embodiments, illustrative embodiments according to any of the preceding numbered paragraphs further include wherein:
said paper support wrap is provided in a roll of paper (or other supply of paper) having a width of between about 6.0 inches and 36 inches, or, preferably, between about 7.5 inches and 30 inches, or, preferably, between about 10 inches and 25 inches, or, preferably, between about 12.5 inches and 22.5 inches.

33. In some embodiments, illustrative embodiments according to any of the preceding numbered claims, further including a method, comprising:
firstly, said expandable slit sheet paper is wrapped around a pallet assembly such as to create at least one interior layer of said expandable slit sheet paper wrapped around at least a portion of said pallet assembly, and
secondly, said paper support wrap is then wrapped around the pallet assembly such as to create at least one exterior layer of said paper support wrap around said pallet assembly,
wherein at least a portion of said at least one exterior layer of said paper support wrap extends around at least a portion of said at least one interior layer of said expandable slit sheet paper.

### BROAD SCOPE OF THE INVENTION

While illustrative embodiments of the invention have been described herein, the present invention is not limited to the various preferred embodiments described herein, but includes any-and-all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

The use of individual numerical values is stated as approximations as though the values were preceded by the word “about”, “substantially”, or “approximately.” Similarly, the numerical values in the various ranges specified in this application, unless expressly indicated otherwise, are stated as approximations as though the minimum and maximum values within the stated ranges were both preceded by the word “about”, “substantially”, or “approximately.” In this manner, variations above and below the stated ranges can be used to achieve substantially the same results as values within the ranges. As used herein, the terms “about”, “substantially”, and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about”, “substantially”, or “approximately” will serve to broaden a particular numerical value or range. Thus, as a general matter, “about”, “substantially”, or “approximately” broaden the numerical value. Also, the disclosure of ranges is intended as a continuous range including every value between the minimum and maximum values plus the broadening of the range afforded by the use of the term “about”, “substantially”, or “approximately”. Thus, recitation of ranges of values herein are merely intended to serve as a shorthand method of referring individually to each separate value falling within the range, unless otherwise indicated herein, and each separate value is incorporated into the specification as if it were individually recited herein. To the extent that determining a given amount of variation of some the factors such as the criticality of the slit patterns, paper width differential pre- and post-expansion, paper weights and type, as well as other considerations known to those of skill in the art to which the disclosed subject matter is most closely related or the art relevant to the range or element at issue will have on the performance of the claimed subject matter, is not considered to be within the ability of one of ordinary skill in the art, or is not explicitly stated in the claims, then the terms “about”, “substantially”, and “approximately” should be understood to mean the numerical value, plus or minus 15%.

It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

What is claimed is:

1. A pallet wrap, comprising:
an expandable slit sheet paper having a slit pattern including a plurality of slits extending in a cross direction that forms a plurality of open cells upon expansion in a machine direction, and
a non-slit paper support wrap,
wherein said expandable slit sheet paper is configured to be wrapped around a pallet assembly and said paper support wrap is configured to surround at least a portion of said expandable slit sheet paper wrapped around said pallet assembly.

2. The pallet wrap of claim 2, wherein said expandable slit sheet paper is made with an extensible paper.

3. The pallet wrap of claim 1 or 2, wherein said paper support wrap is made with an extensible paper.

4. In combination:
a) the pallet wrap of any of the preceding claims; and
b) a pallet assembly, with said pallet wrap being wrapped around said pallet assembly with said expandable slit sheet paper wrapped around the periphery of the pallet assembly and the support wrap surrounding at least a portion of said expandable slit sheet paper wrapped around said pallet assembly.

5. A method, comprising:
a) providing the pallet wrap of any of claims 1-3; and
b) wrapping said pallet wrap around a pallet assembly with said expandable slit sheet paper wrapped around the pallet assembly and said paper support wrap surrounding said expandable slit sheet paper wrapped around said pallet assembly.

6. The method of claim 5, wherein said expandable slit sheet paper surrounds substantially the entire perimeter of said pallet assembly.

7. The method of any of claim 5 or 6, wherein said paper support wrap surrounds substantially the entire perimeter of said pallet assembly.

8. The method of any of claims 5 to 7, wherein said wrapping said pallet wrap around the pallet assembly includes relatively moving a roll of said expandable slit sheet paper with respect to a periphery of said pallet assembly and/or relatively moving a roll of paper support wrap with respect to the periphery of said pallet assembly.

9. The method of claim 8, wherein said relatively moving includes rotating said pallet assembly.

10. The method of claim 8, wherein said relatively moving includes moving said roll of said expandable slit sheet paper around the periphery of said pallet assembly.

11. The method of any of claim 8 or 10, wherein said relatively moving includes moving said roll of said paper support wrap around the periphery of said pallet assembly.

12. The method of claim 11, wherein said relatively moving includes manually relatively moving said roll of said expandable slit sheet paper and/or said paper support wrap with respect to the periphery of said pallet assembly.

13. The method of claim 11, wherein said relatively moving includes automatedly relatively moving said roll of said expandable slit sheet paper and/or said paper support wrap with respect to the periphery of said pallet assembly.

14. Any of the preceding claims, wherein said expandable slit sheet paper flexibly contours around corners of boxes or containers within said pallet assembly by expansion of said open cells and/or lateral twisting enabled by said open cells.

15. Any of the preceding claims, wherein said paper support wrap adds tensile strength to the pallet wrap beyond the tensile strength of the expandable slit sheet paper.

16. Any of the preceding claims, wherein said paper support wrap includes an extensible non-slit paper having an extensibility of the paper in a machine direction of between 5% to 20%, and, in some embodiments, of between 6% to 20%, and, in some embodiments, of between 7% to 20%, and, in some embodiments, of between 8% to 20%, and, in some embodiments, of between 9% to 20%, and, in some embodiments, of between 10% to 20%, and, in some embodiments, of between 11% to 20%, and, in some embodiments, of between 12% to 20%, and, in some embodiments, of between 12% to 20%, and, in some embodiments, of between 13% to 20%, and, in some embodiments, of between 14% to 20%, and, in some embodiments, of between 15% to 20%.

17. Any of the preceding claims, wherein said paper support wrap includes an extensible non-slit paper having an extensibility of the paper in a cross direction of between 5% to 20%, and, in some embodiments, of between 6% to 20%, and, in some embodiments, of between 7% to 20%, and, in some embodiments, of between 8% to 20%, and, in some embodiments, of between 9% to 20%, and, in some embodiments, of between 10% to 20%, and, in some embodiments, of between 11% to 20%, and, in some embodiments, of between 12% to 20%, and, in some embodiments, of between 12% to 20%, and, in some embodiments, of between 13% to 20%, and, in some embodiments, of between 14% to 20%, and, in some embodiments, of between 15% to 20%.

18. Any of the preceding claims, wherein said paper support wrap is a paper having a weight of at least 30#, and, in some embodiments, wherein said paper support wrap is a paper having a weight of at least 35#, and, in some embodiments, wherein said paper support wrap is a paper having a weight of at least 40#, and in some embodiments, wherein said paper support wrap is a paper having a weight of greater than 45#, and, in some embodiments, wherein said paper support wrap is a paper having a weight of greater than 50#, and, in some embodiments, wherein said paper support wrap is a paper having a weight of greater than 55#, and, in some embodiments, wherein said paper support wrap is a paper having a weight of greater than 60#.

19. Any of the preceding claims, wherein said paper support wrap is a paper having a weight of between 30# to 70#, and, in some embodiments, wherein said paper support wrap is a paper having a weight of between 40# to 70#, and, in some embodiments, wherein said paper support wrap is a paper having a weight of between 45# to 70#, and, in some embodiments, wherein said paper support wrap is a paper having a weight of between 40# to 60#, and, in some embodiments, wherein said paper support wrap is a paper having a weight of between 45# to 60#.

20. Any of the preceding claims, wherein said expandable slit sheet paper is made from an extensible paper having an extensibility in a machine direction, in an unslit state, of between 5% to 20%, and, in some embodiments, of between 6% to 20%, and, in some embodiments, of between 7% to 20%, and, in some embodiments, of between 8% to 20%, and, in some embodiments, of between 9% to 20%, and, in some embodiments, of between 10% to 20%, and, in some embodiments, of between 11% to 20%, and, in some embodiments, of between 12% to 20%, and, in some embodiments, of between 12% to 20%, and, in some embodiments, of between 13% to 20%, and, in some embodiments, of between 14% to 20%, and, in some embodiments, of between 15% to 20%.

21. Any of the preceding claims, wherein said expandable slit sheet paper is made from an extensible paper having an extensibility in a cross direction, in an unslit state, of between 5% to 20%, and, in some embodiments, of between 6% to 20%, and, in some embodiments, of between 7% to 20%, and, in some embodiments, of between 8% to 20%, and, in some embodiments, of between 9% to 20%, and, in some embodiments, of between 10% to 20%, and, in some embodiments, of between 11% to 20%, and, in some embodiments, of between 12% to 20%, and, in some embodiments, of between 12% to 20%, and, in some embodiments, of between 13% to 20%, and, in some embodiments, of between 14% to 20%, and, in some embodiments, of between 15% to 20%.

22. Any of the preceding claims, wherein said expandable slit sheet paper is a paper having a weight of at least 30#, and, in some embodiments, wherein said expandable slit sheet paper is a paper having a weight of at least 35#, and, in some embodiments, wherein said expandable slit sheet paper is a paper having a weight of at least 40#, and in some embodiments, wherein said expandable slit sheet paper is a paper having a weight of greater than 45#, and, in some embodiments, wherein said expandable slit sheet paper is a paper having a weight of greater than 50#, and, in some embodiments, wherein said expandable slit sheet paper is a paper having a weight of greater than 55#, and, in some embodiments, wherein said expandable slit sheet paper is a paper having a weight of greater than 60#.

23. Any of the preceding claims, wherein said expandable slit sheet paper is a paper having a weight of between 30# to 70#, and, in some embodiments, wherein said expandable slit sheet paper is a paper having a weight of between 40# to 70#, and, in some embodiments, wherein said expandable slit sheet paper is a paper having a weight of between 45# to 70#, and, in some embodiments, wherein said expandable slit sheet paper is a paper having a weight of between 40# to 60#, and, in some embodiments, wherein said expandable slit sheet paper is a paper having a weight of between 45# to 60#.

24. Any of the preceding claims, wherein:
said expandable slit sheet paper has slits with a slit length of between 0.15 inches to 0.45 inches.

25. Any of the preceding claims, wherein:
said expandable slit sheet paper is configured to be wrapped concurrently with said paper support wrap.

26. Any of the preceding claims, wherein:
said expandable slit sheet paper is configured to be wrapped concurrently with said paper support wrap, with said paper support wrap overlapping said expandable slit sheet paper.

27. Any of the preceding claims, wherein:
said expandable slit sheet paper is configured to be wrapped independently with respect to said paper support wrap.

28. Any of the preceding claims, wherein:
said expandable slit sheet paper is configured to be wrapped independently with respect to said support wrap, including at least one of:
d) said expandable slit sheet paper being supplied from a supply unit that independently raises and lowers said expandable slit sheet material from a support and that independently raises and lowers said paper support wrap with respect to said pallet assembly;
e) said expandable slit sheet paper being supplied from a supply unit that supplies said expandable slit sheet paper and said paper support wrap concurrently around said pallet assembly but at different vertical positions along the pallet assembly; and/or
f) said expandable slit sheet paper being supplied from a supply unit that supplies said expandable slit sheet paper and said paper support wrap at at least some different wrapping time sequences from one another.

29. Any of the preceding claims, wherein:
said pallet assembly has a pallet with a supporting surface area of at least 3 feet by 3 feet (i.e., 36 inches by 36 inches).

30. Any of the preceding claims, wherein:
said pallet assembly includes stacked items, boxes or containers extending to a height of at least 3 feet (i.e., 36 inches).

31. Any of the preceding claims, wherein:
said expandable slit sheet paper is provided in a roll of expandable slit sheet paper (or other supply of expandable slit sheet paper) in an unexpanded state having a width in an unexpanded state of between about 6.0 inches and 36 inches, or, preferably, between about 7.5 inches and 30 inches, or, preferably, between about 10 inches and 25 inches, or, preferably, between about 12.5 inches and 22.5 inches.

32. Any of the preceding claims, wherein:
said paper support wrap is provided in a roll of paper (or other supply of paper) having a width of between about 6.0 inches and 36 inches, or, preferably, between about 7.5 inches and 30 inches, or, preferably, between about 10 inches and 25 inches, or, preferably, between about 12.5 inches and 22.5 inches.

33. Any of the preceding claims, further including a method, comprising:
firstly, said expandable slit sheet paper is wrapped around a pallet assembly such as to create at least one interior layer of said expandable slit sheet paper wrapped around at least a portion of said pallet assembly, and
secondly, said paper support wrap is then wrapped around the pallet assembly such as to create at least one exterior layer of said paper support wrap around said pallet assembly,
wherein at least a portion of said at least one exterior layer of said paper support wrap extends around at least a portion of said at least one interior layer of said expandable slit sheet paper.
